(19) United States
(12) Patent Application Publication
(10) Pub. No.: US 2008/0106523 A1
(43) Pub. Date: May 8, 2008

(54) Ergonomic lift-clicking method and apparatus for actuating home switches on computer input devices

(76) Inventor: Richard H. Conrad, Waianae, HI (US)

Correspondence Address: RICHARD H. CONRAD, 84-1330 MAUNA'OLU ST., WAIANAE, HI, 96792, US

(21) Appl. No.: 11/983,160

(22) Filed: Nov. 6, 2007

Related U.S. Application Data
(60) Provisional application No. 60/858,431, filed on Nov. 7, 2006.

(51) Int. Cl. G06F 3/041

(52) U.S. Cl. 345/173

(57) ABSTRACT

This invention introduces lift-clicking, a gentle method of clicking that utilizes light touch home sensors on the mouse and other computer input devices. It can be used either to replace the prior art depression-type mouse button with a home touch surface and a light touch or proximity sensor, or to add a touch/proximity sensor to an existing mouse button, providing three or more additional functions for each finger. It is a very ergonomic method that uses less force than the weight of the relaxed resting finger. It employs a finger lift, or a finger lift followed by a gentle drop, and utilizes unique combinations of windows, timing, hand presence reference, and logic sequences carefully designed to automatically prevent the production of unwanted clicks when the finger first arrives on or leaves the home sensor as the hand arrives or departs the input device. The initial condition is a finger resting on a touch switch/proximity sensor surface at a home resting position. A function is triggered either by lifting (or sliding) the finger away from its home touch surface (lift-delay-reference mode) or by dropping the finger back to the surface soon after the lift (lift-drop mode). Unwanted clicks do not occur because the function is triggered either by a lift after a very short delay with a requirement for hand presence reference, or by a drop within a time window opened by the previous lift. The gentle lift of the finger followed by a passive drop eliminates the push-down muscle twitch of prior art depression clicking, without any sacrifice of speed. Optionally included are click-inhibiting means so that unwanted clicks are not produced when a finger leaves a home sensor to actuate a non-home switch or scroll device. Momentary lifted modes can be used to enable scrolling with mouse motion, a fine cursor control feature, or to ignore all XY data so that the mouse can be repositioned without lifting it off the desktop and without moving the cursor (disengage clutch feature). Dragging can be accomplished with either the finger held lifted or with the finger resting at home. A single lift-click sensor can be used to trigger two different functions, the function chosen depending on the amount of time between the lift and the drop. The lift-click sensor can be piggybacked together with a prior art mouse button to provide lift-clicking while still allowing depression clicking, greatly increasing the number of triggerable functions. A lift-click sensor can be of a fixed type with no moving parts, (a zero button mouse) allowing the manufacture of pointing devices that are completely solid state, low in cost and sealed from the environment. The lift-click method makes it possible to replace the click buttons on a horizontal mouse with a programmable multi-point XY(Z) multi-functional touchpad which can be used to provide not only lift-clicks, but by toggling to new function sets, can also offer arrow/nudge key functions, page navigation, fine cursor control, and gesturing. Lift-clicking can greatly improve versatility and ease of use in most types of pointing devices.

### FIELD OF THE INVENTION

This invention relates to computers, particularly to pointing devices and keyboards.

### PRIOR ART

Using the traditional mouse is uncomfortable for millions of people, with the prior art method of clicking being a major part of the problem. Most computer mouse-type pointing devices have click buttons that are switches requiring an active depression, with more force required than the weight of the resting finger. This has been necessary in prior art because the click button is a “home key” for the finger that actuates it, that is, the finger normally rests passively on the button until actuation is desired. Since the button is on a moving device, if the force required to actuate were to be any less, either inadvertent clicks would occur, or the stress of preventing inadvertent clicks would accrue over time. The depression stroke is and must be a short stroke, because if it was of greater displacement the clicking would be slower and more prone to causing unwanted movement of the pointing device. The short stroke eliminates the possibility of a natural follow-through for the finger, and instead tends to encourage a quick muscle spasm for actuation. The click button is depressed repetitively by the same finger, often many times per minute and easily thousands of times in one work session. The same hand must insure that the pointing device does not move during clicking, and also has the task of moving the pointing device itself.

All together this results in many different kinds of discomfort, strain, “trigger finger” and damage to the hand and wrist, as millions of people have reported. In prior art, light touch switches cannot be used as “home” switches, or they would be already triggering their function. Prior art software has been written to avoid having to press any click button, that instead uses an algorithm which automatically causes a click if the mouse dwells in a particular spot for a certain length of time, but this has many disadvantages. There is an “ErgoClick™ Mouse Clicking Device” on the market which is operated by the non-mouse hand while the mouse hand is at the mouse, which produces clicks by shifting the weight of the palm. This has the disadvantages of not being able to leave one hand at the keyboard for actuating keyboard shortcuts while using the mouse, and of requiring a twitch of the forearm and rotation of the wrist to shift the weight of the palm, with the potential of cumulative strain. The Apple Computer “Mighty Mouse” (U.S. Patent Application Publication No. US 2006/0274042 μl) has a single electromechanical click switch, and above it touch sensors under the index and middle finger. These touch sensors are not used to trigger a click, but rather the single click switch is depressed to trigger a click in the traditional manner requiring the normal force of in excess of 50 grams, with the touch sensors serving to detect which finger is depressing the single click switch. In this prior art, clicks are triggered only by pressing in the downward direction, using more force than the weight of the resting finger. The only other stated use of their touch sensors is: “a visual preview clue may be provided on-screen when a finger is lightly pressing one or both of the touch sensors”. The Apple Computer “Mouse with Optical Sensing Surface (U.S. Patent Application Publication No. US 200/0152966 A1) obtains images of the whole hand from below a touch surface and processes them to obtain touch patterns, but does not mention the inevitable problem of inadvertent clicks resulting from hand arrival and departure from a touch surface that serves as a home resting surface for a finger, nor does it detail any specific processing methods nor claim any solutions to this problem. Without a solution to this problem, any proposed mouse employing touch sensors for home switches is not a viable device. The most specific language used concerning the actuation of functions in the latter patent application is: “the touch event may for example include translating, rotating, tapping, pressing, etc.” (Tapping in prior art is usually forceful, with considerably more force exerted than the weight of the resting finger.) The Apple Computer “Mouse having a button-less panning and scrolling switch” (U.S. Pat. No. 7,168,047 B1) has proximity touch sensors, but they are on the sides of the mouse and used only to detect whether or not the sides are being held (their purpose is to determine hand position of holding the mouse) in order to link mouse motion to either cursor movement or scrolling). They are not used by the index or middle finger, nor are they used for click-type functions.

### OBJECTS AND ADVANTAGES

This invention introduces lift-clicking, an intuitive and much more relaxed method of clicking the mouse and other computer input devices that use home-type switches. It can be used either to replace the prior art depression-type mouse button with a home touch surface and a light touch or proximity sensor, or to add a touch/proximity sensor to an existing mouse button. It can provide three or more additional functions for each finger, plus numerous new chorded functions if desired. The present invention has been designed to provide unique and practical solutions to the disadvantages of the prior art and to offer new and convenient features, including a choice of more functions triggerable by each finger. It provides a highly ergonomic zero or near zero force method of clicking, while solving the problems normally inherent to a touch sensor that serves as a resting home location for the finger. These problems include artifacts such as inadvertent clicks produced when the finger first arrives at or leaves the home sensor as the hand arrives at or departs the input device, or when the finger leaves a home position to actuate a non-home switch or a scroll device. (Inadvertent clicks could unintentionally select and cause the displacement of a precisely positioned object, accidentally open icons or menus, etc.) The present invention completely prevents the inadvertent clicking problems of home touch sensors by utilizing unique combinations of windows, timing, hand presence reference, and logic sequences carefully designed to automatically prevent artifacts.

Lift-clicking is a gentle lift, passive return method of triggering functions by means of home-type light touch sensors or switches on computer input devices. The lift-click method begins with a finger already resting on a home-type of sensor, switch or key, keeping it in the actuated state. The actuated state is where the switch is held closed if it is a normally open switch, or is held open if it is normally closed. Keeping the switch actuated does not take any effort at all because the actuation force in the method of the present invention is less than the weight of the relaxed resting finger. The force required to actuate the switch in this invention is generally between zero and ten grams. The actuated state by itself does not result in a trigger. The method consists of lifting the finger in the direction away from the touch surface of the switch, and then dropping the finger back to the touch surface. A click or other function is triggered by either the lift transition or by the drop transition following the lift. This sequence is used together with electronic logic safeguards to automatically prevent unwanted triggering by either the initial arrival of the finger on the touch surface of the home key or switch when the hand arrives, or by the removal of the finger from the switch along with the hand when the hand departs from the device. Neither a lift alone nor a drop alone results in a function being triggered.

The method of the present invention provides a choice of five different modes of operation, each of which comprises a different sequence of manual actuation combined with its own electronic processing means for triggering functions. In different ways, they all prevent unwanted triggering by being able to distinguish between finger lifts and drops that were made with the intention of triggering a function, and those that were either due to the hand departing from or arriving at the input device, or due to an excursion by the finger to a non-home switch or device.

The present invention completely solves all of the prior art problems mentioned above except the enormous number of repetitions, but it insures that these repetitions are far less of a strain. It can in fact reduce the number of repetitions somewhat because it provides more functions from a two button mouse than the prior art does, and one of the extra functions can be a double click. The lift-click method is a means to activate clicks without the stress-building push or tap of the prior art, and is the most ergonomic form of clicking. The upward or outward actuation does not have an end stop, and this enables it to be a free and relaxed motion. The return can be a gentle, completely passive drop of the finger to the actuation surface. A forceful drop or tap is neither necessary nor desirable. One can rapidly repetitively click with less effort than with push/depression clicking.

In the prior art mice, avoidance of inadvertently depressing a mouse button is a major factor in determining how one holds and moves the mouse. The index and middle fingers are devoted to remaining poised on the buttons without exerting enough pressure to actuate them. This both introduces stress and removes these fingers from full participation in holding and moving the mouse. This is an unfortunate loss because these fingers are capable of a very high degree of fine motor control. Not being able to use the full potential of these fingers has been a significant and very limiting factor in the design of most mice. The majority of current designs require or inadvertently encourage more arm, wrist and shoulder involvement in moving the mouse than would be necessary if the very agile index and middle fingers could be freed from the constraints of depression-clicking to play a more active role in XY manipulation. In the method of the present invention, when the hand is on the mouse, the lift-click light touch switches are already actuated by the resting weight of the fingers and therefore inadvertent depression is not an issue. The index and middle fingers can now be relaxed and can participate more naturally in the way the hand holds and moves the mouse. Thus this invention not only provides less stressful clicking (a gentle lift and return instead of a quick twitch to a hard bottom), but also less stressful “not clicking” (inadvertent depression is no longer possible). It also provides for more comfortable holding and moving of the mouse (all fingers can now participate equally). Reducing the above-mentioned stresses makes for more relaxed mouse movements, reduces the tendency for grasping and squeezing, and greatly lessens the chance of mouse related RSI (Repetitive Strain Injury). This method can be used on most types of pointing devices including horizontal and vertical mice, trackballs, joystick handles, pen or stylus click buttons, and also on auxiliary click switches and home-type switches on any other computer input device. When used with special two-stage keyboard home keys, to be detailed later in this specification, the lift method can also provide the ability to click ergonomically by using keyboard home keys.

The method of the present invention creates a potential for a wider range of new, more ergonomic pointing device designs, including pointing devices with a smooth unbroken top surface. This allows any amount of weight of the arm, hand and fingers to be rested on the mouse surface without danger of inadvertent clicks. New mouse shapes and ways of holding and moving the mouse become possible. A smooth continuous surface allows the mouse to be completely sealed from dirt and moisture, and also provides a better platform for haptic technology.

The lift method and its home location finger sensor can be used either alone as a single-stage switch replacing a prior art mouse button, or piggybacked together with a prior art type depression click button as a two-stage switch. In a two-stage switch the lift-click sensor (first stage) and the depression switch (second stage) can have the same or different functions assigned to them, and they actuate their functions completely independently of one another. The light touch first stage could be used for clicks and other very frequently used functions, with the heavier second stage being used for less frequently used functions, especially those not involving the need to hold the pointing device stationary. Alternatively, one could simply assign the same (e.g., the single click) function to both stages, giving choice and variety of actuation for reducing the stress of repetition. Clicking up as well as down potentiates a good balance of muscle usage, which reduces the likelihood of strain-related disorders. Further, software could be used to monitor the recent frequency of use of each stage of a two-stage switch, and to provide a reminder to use a lift method when the prior art depression method is being over-used.

A further advantage is that this method can provide a choice between two different functions by choosing the timing of the drop, as will be discussed further. New chording options become available as well. This invention also introduces momentary lifted modes that can be assigned to reroute the output of the XY encoder to provide functions such as a cursor clutch, slow cursor (fine cursor control), or scroll with mouse motion. Although lift-clicking is already inherently less likely than depression clicking to cause the mouse to move while actuating a click, an automatic momentary clutch can be configured to make inadvertent motion of the cursor while actuating a click impossible, thus eliminating an additional source of stress of the prior art. The lift-click methods are intuitive, becoming comfortable after only a few seconds of use and completely automatic in just a few minutes. The light touch switch can be of a fixed type that has no moving parts and is sealed, allowing for the design of simpler pointing devices that are easier and less expensive to manufacture, as well as being more reliable.

### SUMMARY

The present invention provides a highly ergonomic zero or near zero force light touch method of clicking, while solving the problems normally inherent to a touch sensor that serves as a resting home location for the finger. The solutions presented by this invention consist basically of lift-drop clicking, lift-delay-reference clicking, and momentary lifted modes. This method employs a light touch home switch/sensor with an actuation threshold that is less than the weight of the relaxed resting finger. In lift-drop mode, a drop triggers the function if the drop falls within a window of time initiated by the previous lift. In lift-delay-reference mode, the end of a delay initiated by the lift triggers the function if the hand is still present at the input device. A drop alone or a lift alone does not trigger a function. Artifacts due to hand arrival and departure are prevented. The method of the present invention makes it possible to replace the click buttons on a horizontal mouse with a programmable multi-point, multi-functional XY touchpad. On pointing devices that are held and manipulated by the tips of the fingers, the lift-click method of the present invention allows the convenience and speed of using a home-type of click switch without any risk of the inadvertent click triggers due to finger grip or manipulation that could occur if a home click switch were of the prior art depression type.

### DEFINITIONS

LIFT-CLICK or LIFT-CLICKING: A general term for the method of the present invention. Lift-clicking consists of lifting the finger in the direction away from a home touch surface of a switch (the home resting location for that finger) and then returning the finger to the touch surface. The term includes lift-drop, lift-delay-reference (which is referred to in this specification as lift-delay-ref or simply as lift-delay), hybrid, momentary lifted and all other modes described in this specification.

CLICKS AND CLICKING: Where the terms click(s) or clicking are used, they can refer either specifically to a left mouse button click command or left mouse button press down command followed immediately by a left mouse button release/up command, or generally to signify the triggering of any function.

A HOME RESTING LOCATION/HOME TOUCH SURFACE/HOME SWITCH: the touch surface of a switch, sensor or key which is a location that serves as a home base (home touch area or zone) for a particular finger. A particular finger is associated with a home location on which it rests when in a standby, or ready state. A home location can be a mouse surface, button, switch or sensor, or a keyboard key or switchpad switch/sensor on which a finger usually rests whenever the hand is in its normal operating position at the input device. It can be a depressible switch, or it can be a surface associated with a touch sensor, proximity sensor, optical switch, motion sensor, imaging device or a zone of an XY touchpad. Some examples of a home switch or home resting location in the prior art are the main left and right mouse buttons where the index and middle fingers normally rest, and the home row keys on the keyboard, S D F and J K L in particular.

A LIGHT OR VERY LIGHT TOUCH SWITCH: any type of sensor or switch (these terms are used interchangeably in this specification) that can detect finger presence at and/or absence from a fixed or depressible home touch surface and whose actuation threshold is less than the weight of the resting finger. Actuation threshold is less than 20 grams, usually less than 10 grams. Some small amount of actuation hysteresis may be desirable in some cases, but is not necessary. The sensor/switch can be of any type, including a mechanical switch, a membrane switch, a touchswitch or touchpad of any type, a transmissive or reflective optical switch, any type of proximity sensor, or can be a virtual sensing via an imaging device.

An ACTIVE TOUCH AREA: a touch surface that has a finger presence or absence detection sensor or sensing means associated with it.

A LIFT: the displacement of the fingertip usually in the direction perpendicularly away from the touch surface. The height of the lift is not critical, generally ranges between ⅛″ to 1″, and could be less than ⅛″, especially when the touch surface is resilient, flexible or movable and contact with the surface is not broken. Lift may not always signify/be in the upwards direction, but it always signifies REMOVAL of the finger in a direction away from the touch surface. Also, the words lift or lifted are used in the general sense to mean TO MOVE/MOVED AWAY FROM THE TOUCH SURFACE IN ANY DIRECTION, NOT PRESENT, ABSENT. They are sometimes used specifically to signify that the finger is lifted in the direction perpendicularly away from the touch surface, but the meaning of lift or lifted can also include the lifting of a finger off of an active touch area and resting it on a surface that is not an active touch area, or the SLIDING of the finger off of an active touch area with a motion generally parallel to the touch surface. Thus lifted can signify slid to the rear, for example. A sliding away from the active surface of the switch, followed by a sliding back to the active surface, or a lifting away and a sliding back, or a sliding away and then lifting and dropping back, can be used in place of lift and drop in most cases.

A SHORT LIFT: In dual window lift-drop mode, a lift that is held for a short time (usually zero to 0.5 sec) and then terminated by dropping within window A.

A MEDIUM LIFT: In dual window lift-drop mode, a lift that is held for a medium length of time (usually about 0.5 to 1 or 2 sec) and then terminated by dropping within window B.

A LONG LIFT: In lift-delay or hybrid mode, a lift that is held until any time after the end of the delay.

A DROP: the displacement of the fingertip generally in the direction perpendicularly towards the touch surface. A DROP DOES NOT ALWAYS SIGNIFY DOWNWARD, BUT ALWAYS MEANS A RETURN TO THE TOUCH SURFACE, INCLUDING BY SLIDING. Thus lift and drop generally signify away from and return to the touch surface respectively; lifted and dropped generally signify absent from and present at the touch surface respectively. The lift click and lift-drop click techniques are completely usable with touch surfaces or sensors oriented at any angle including vertical surfaces.

ACTUATED: a switch is in the actuated state when a finger is determined to be present at or contacting the touch surface and/or is either holding a normally open momentary switch closed, or is holding a normally closed momentary switch open. Thus the actuated state is the “non-normal” state of a switch, i.e. closed if it is a normally open (n.o.) switch, and open if the switch is the normally closed (n.c.) type. Actuated=finger sensed as present, returned, dropped, touching, actuating. This state is abbreviated as: [A]. In the case of an optical switch with a light beam at the touch surface, the actuated state would be the interruption of the beam.

NOT ACTUATED: the “normal” or relaxed state of a switch. Not actuated=released=finger sensed as absent, lifted, away, not actuating. This state is abbreviated as [NA]. These definitions of actuated and non-actuated are for the sake of consistency and clarity of description, and although they are utilized throughout most of this specification, this invention is not limited to these particular definitions.

TRANSITION: a change of state of a switch from [A] to [NA] or from [NA] to [A]. The moving of the finger from present at to absent from the switch (usually a lift), or from absent to present (usually a drop). The electrical output from a switch during a transition either initiates a trigger pulse, a window pulse or a delay pulse, or terminates a drag. T1: the first transition, always a lift, [A] to [NA]. The symbol used in the Figures is a vertical arrow pointing up. Electrically T1 can be a rising edge or a falling edge. T2: the second transition, always a drop, [NA] to [A]. The symbol used in the Figures is a vertical arrow pointing down. Electrically T2 can be a rising edge or a falling edge.

WINDOW: a pulse that is initiated by a transition, consisting of a preset/designated time period which begins when the pulse begins (window opens) and ends when the pulse ends (window closes). Generally the lift-drop window would be set to be somewhere between 0.5 and 2.0 seconds long.

DELAY: a preset period of time that is initiated by a transition, and the end of the delay is used as a trigger. A delay is represented in the Figures by a square pulse. Generally the delay of lift-delay would be set to be between zero and 0.75 seconds long. A designated time period can serve either as an enabling window, as a delay, or in hybrid modes, as both.

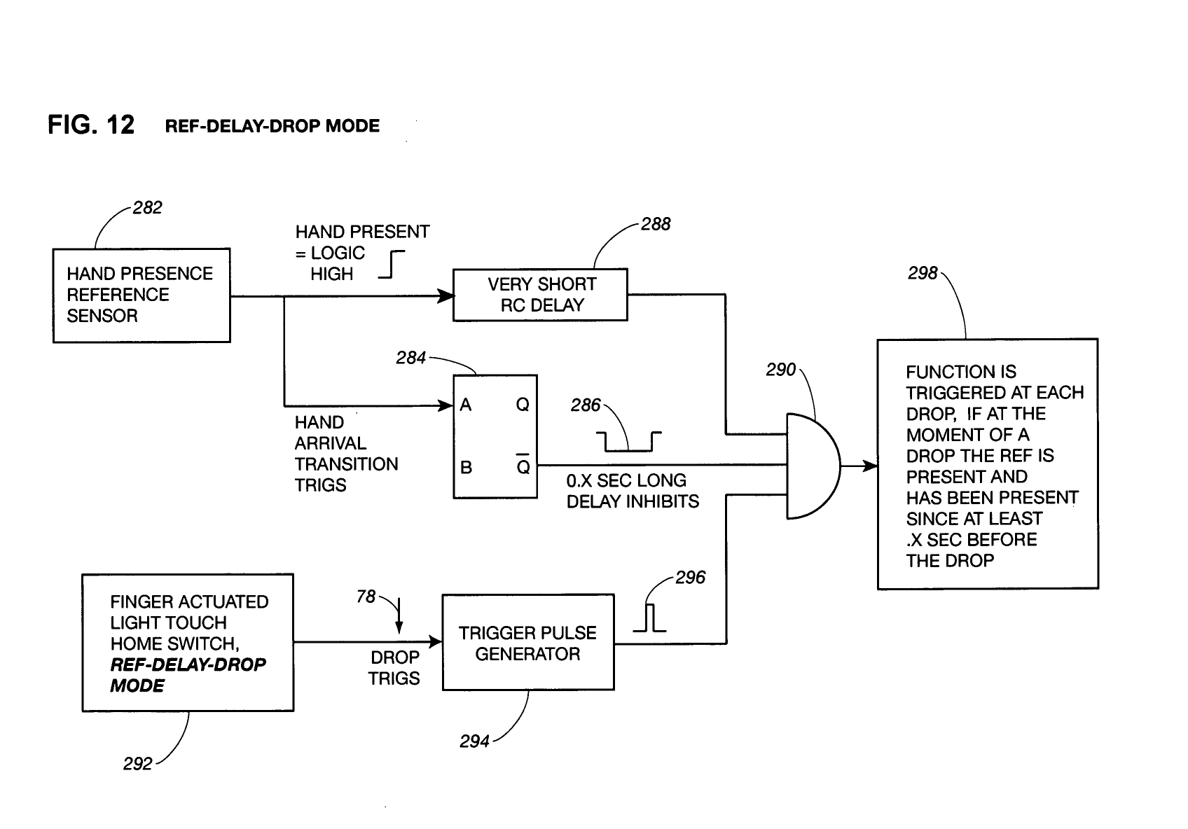

REFERENCE: a signal output from a sensor/switch/imaging device that indicates/determines whether or not the hand is present at the pointing device. Detection can be by a touch or proximity sensor at any location on the input device sensing the presence of any part of the hand except for the finger actuating the sensor whose processing mode requires the reference (with the exception of lift-drop mode where in effect the actuating finger serves as its own hand presence reference/indication means). Thus any other finger or the palm or heel of the hand may serve as the reference. Any means of sensing may be used to provide a reference indicating hand presence. A dedicated hand presence reference sensor is only needed for single finger operation or for some chords in lift-delay-ref, hybrid, and some momentary modes, since otherwise at least one finger (of the actuating index and middle fingers) is touching a home surface and can serve as an inherent hand presence reference. The convention used in FIGS. 12, and 17 through 32, is that THE PRESENCE OF THE HAND AT A SENSOR ACTING AS A REFERENCE SENSOR GENERATES A LOGIC HIGH REFERENCE SIGNAL.

MODE: A means of processing signals from light touch switches.

MOMENTARY LIFTED STATE: the finger absent or held away from a single or first stage lift-click sensor so that the sensor is not actuated. This is the not-actuated [NA] state of the switch, and can be assigned, via MOMENTARY LIFTED MODE processing, to either block, modify or reroute the output of the XY encoder of the pointing device from its default function or default speed of moving the cursor on the screen; this rerouting is maintained for as long as the finger is held lifted. It can also be used to temporarily transform the function assignments of a set of keyboard keys. The word triggering used for a momentary lifted state is meant to signify manifesting, which is a combination of enabling plus a second action. The lifted finger enables the state, and a movement of an XY encoder, or the pressing of a keyboard key, triggers/manifests the mom lifted function.

CLICKING SURFACE: The surface of a pointing device or auxiliary clickpad that has home resting locations for the fingers, and sensors for generating click functions.

MOUSE OR MICE: general terms usually used to signify any type of pointing device “horizontal mouse” or “vertical mouse” are used. Horizontal and vertical mice signify mice that have an XY POSITION ENCODER on their bottom surface that controls the on-screen cursor when the mouse is moved across a desktop or work surface, and the terms horizontal and vertical specifically refer to the orientation angle of the palm of the hand, being generally parallel to or perpendicular to the work surface respectively. Alternatively, all of the embodiments of the present invention shown as horizontal mice could instead be auxiliary mouse button pads with lift-click switches and without any XY position encoder, to be used with a separate device containing an XY encoder such as an eye tracking device, etc.

CLUTCH: a means whereby the X and Y position data flowing from the XY encoder in the mouse to the computer is interrupted, so that the mouse can be moved along the desktop without moving the cursor and without lifting the mouse. Where the term clutch is used, it signifies the CLUTCH DISENGAGED momentary lifted function, also referred to as disengage clutch or disengage cursor or cursor clutch or disengage cursor clutch momentary function.

LIFTED POSITION: the finger held away from the touch surface.

LIFTED STATE/MOMENTARY LIFTED STATE: the momentary state that is enabled as the result of MOMENTARY LIFTED MODE processing

LIFTED FUNCTION, or M: a function pre-assigned to a particular lifted state.

MOUSE HAND AND NON-MOUSE HAND: Mouse hand is the hand that uses the mouse, usually the dominant hand. Non-mouse hand is the other hand, which usually remains at the keyboard.

MEMBRANE TOUCH SWITCH: a thin multilayer membrane switch which employs resistive/semiconductive, capacitative, or any other type of sensing technology.

SINGLE-STAGE SWITCH: a switch or sensor having only a light touch type of actuation, without a depression stage.

TWO-STAGE SWITCH: a dual switch having two momentary (ON) states:

OFF(ON1)(ON2), or OFF(ON1)(ON1 & 2); the first (usually but not always top, upper or outermost) stage (ON1) is a light touch lift-type switch needing less than 10 grams to actuate, and the second (usually but not always bottom or innermost) stage (ON2) is a push/depression stage requiring at least 50 grams to actuate. Each stage has its own electrical output (though a common conductor may be shared). The first stage may be any type of light touch switch or sensor suitable for lift-clicking. These include: a very light touch mechanical switch, or any type of non-mechanical touch switch (resistive or semiconductive membrane, capacitative, electric field, optical or any type of proximity sensor) where the touch surface is either fixed, resilient/compliant, or mechanically depressible for tactile purposes. Thus a two-stage switch could be referred to as a mechanical/mechanical, touch/mechanical, proximity/mechanical, optical/mechanical type, etc. The optical switch can utilize transmission, reflection, FTIR (Frustrated Total Internal Reflection), or imaging of finger position or motion. If a touchpad that has an output that is at least partially proportional to pressure is used as the two-stage sensor, a processing means can be used to distinguish between a light touch (first stage) and a heavier pressure (second stage).

MULTI-POINT TOUCHPAD: a touch sensitive pad that is capable of detecting the X and Y coordinates of more than one finger touching the pad at the same time, and providing X and Y, and optionally Z (proportional to pressure) readout signals for each finger.

Definitions Note: For the purpose of illustration in the Figures and to provide a signal polarity that is easy to remember by association, a lifted state is usually shown as a logic high, and a dropped state as a logic low. In reality, the opposite polarities could be used just as well. The direction of the up and down arrows used to represent T1 and T2 in the Figures represent the direction of the finger transition, but do not necessarily represent the specific direction of the electrical transition (rising or falling edge, signified in the Figures by a rising step or a falling step symbol respectively), since each arrow could be associated with either electrical direction; i.e., in reality T1 can be either a rising or a falling edge electrically, as can T2. The signal edge direction depends on the specifics of the particular electronic circuit employed to implement the electrical block diagrams and timing diagrams of the Figures. For example, it depends on whether the switch or switch contacts used are normally open or normally closed, and also on whether one side of the switch is connected to signal ground or to signal high. Examples of window and delay times are given in the Figures that have a rising edge to open, and a falling edge to terminate. These are examples only, and could just as well be the other way around. The method of this invention does not rely or depend on any particular electronic circuit or particular electronic means of implementation, but is based on the concepts and logic flow of the invention as described in the claims. Implementation of this invention and its modes can be by any combination of hardware and firmware, hardware and software, or all three.

### ABBREVIATIONS USED IN THE FIGURES

˜: approximately
#: used in front of a reference number in order to clearly distinguish it from a FIG. number.

### Y: a YES in response to a choice/question mark in a diamond shape in a flowchart.

### N: a NO in response to a choice/question mark in a diamond shape in a flowchart.

### TPG: Trigger Pulse Generator

### TRIG: trigger

### TRIGS: triggers (the verb)

### PG: pulse generator

### DPG: delay pulse generator

### WIN: window (of time)

### FUN: function

REF: reference (hand presence reference sensor or signal: a means of indicating that a hand is present at the pointing device).

### REQ: required

### SW: switch

### PROX: a proximity sensor of any type including capacitative, electric field, or optical including imaging or the interruption or reflection of a light beam.

### MOM: momentary (on for as long as held)

### CLK: click

### L: left

### RT.: right

### DBL: double, as in double-click

### GM: gram(s)

### DN: down

### TGL or TOGL: toggle

### FOV/SO: toggle between “move Field Of View (eyepoint) with mouse”, and “move Selected Object with mouse”.

### P/M: toggle between Position control and Motion control modes

### TRANSL Z: move mouse to translate along Z axis (in SO mode moves selected object, in FOV mode zooms field of view)

### ENT: enter

### SEC: second (of time)

### SIMULT: simultaneous

### SEQ: sequential

### PD: pointing device

### FTIR: Frustrated Total Internal Reflection

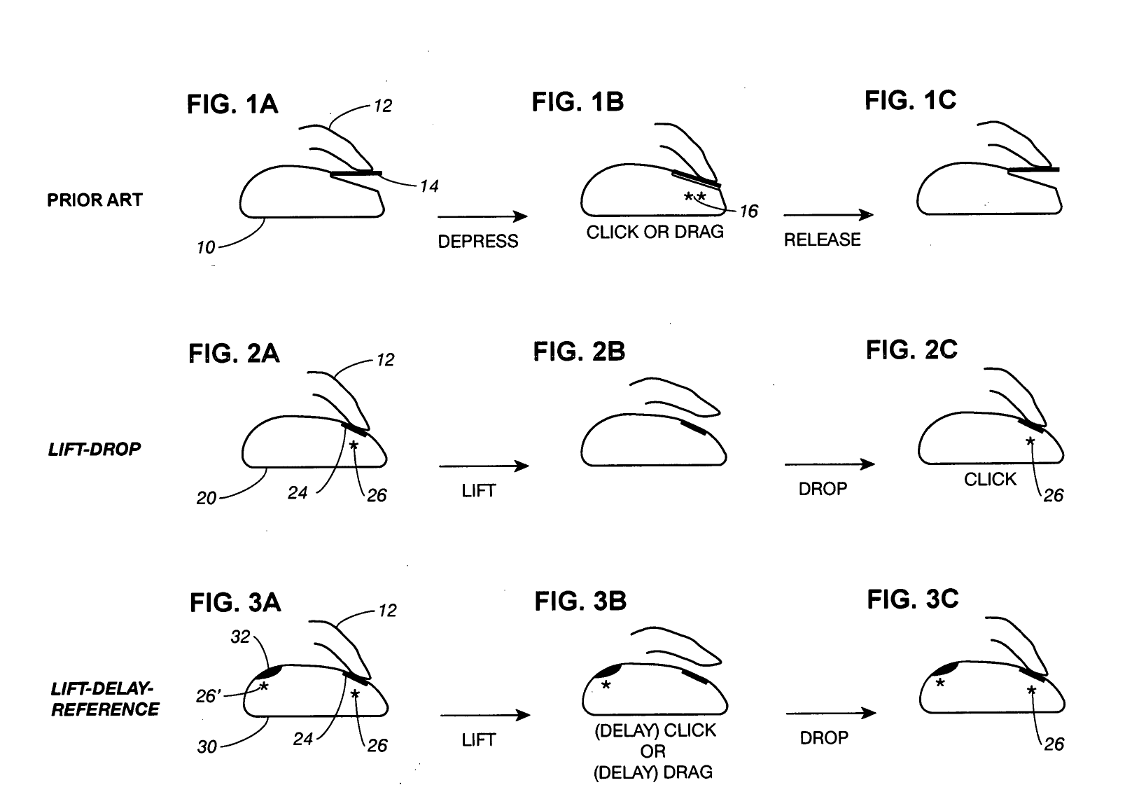

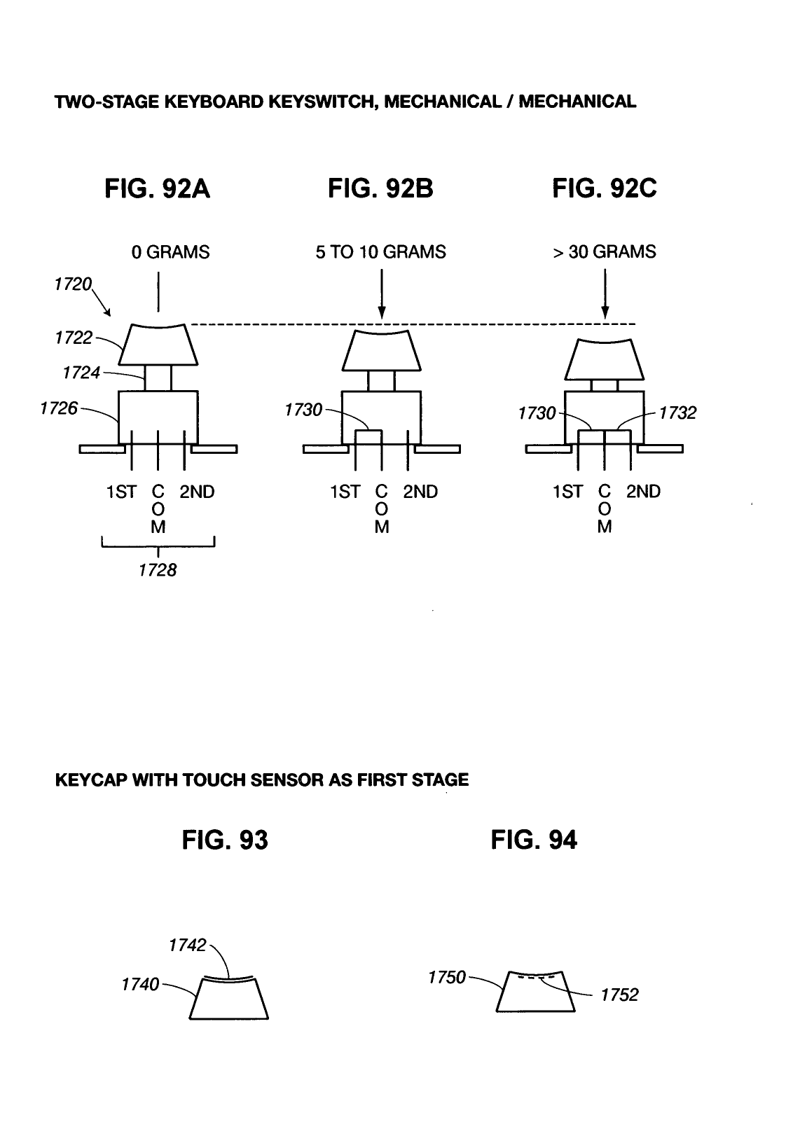

* (SINGLE ASTERISK): denotes the actuation of a lift type of switch, or the actuation of the lift stage of a two-stage switch (the lift stage is always the first stage), or the actuation of a reference sensor. It may or may not also denote actual triggering of the function assigned to the switch, depending on the lift mode and timing.
** (DOUBLE ASTERISK): denotes the heavy depression (usually >50 grams)/actuation of a standard type of mechanical switch, or the heavy depression/actuation of the standard depression stage of a two-stage switch (the heavy depression stage is always the second stage, and its depression always causes the triggering of its assigned function). WHENEVER A SECOND STAGE IS ACTUATED, THE FIRST STAGE REMAINS ACTUATED, THAT IS, THE DOUBLE ASTERISK INDICATES THAT BOTH STAGES ARE ACTUATED. This link of first stage to second stage actuation need not always be the case, but this link is used in the drawings for the sake of consistency, and because it is preferred electrically because it automatically precludes unwanted triggerings of first stage functions when the second stage is actuated. This is detailed further in the discussion of FIGS. 92A, 92B, 92C, 95 and 96. Asterisks are used in FIGS. 1 through 4, 52, 53 and 55 through 58.

### DISCUSSION OF DEFINITIONS

Lifting usually deactuates, and dropping/returning usually actuates the switch. The term actuation is defined as a finger actuating the switch. Actuation itself does not necessarily trigger the function. The signal processing of the present invention uses directionally specific change of state/transition edge outputs of light-touch home switches to generate pulses which in turn trigger functions, and/or uses continuous output levels from the switches to hold a function on or off. In some of the drawing Figures of this specification (FIGS. 1 through 4, FIGS. 40B and 40D, FIGS. 52 and 53, and FIGS. 55 through 58), the actuated state of a light touch lift switch (or of a reference sensor) is indicated by a single asterisk placed in close proximity to the switch. Actuation may or may not also trigger the function assigned to the switch. The actuated state of a prior art type of full depression switch is indicated by a double asterisk placed in close proximity to the switch, in which case actuation is synomonous with triggering the assigned function. The light touch switch could be either a small displacement type (about one millimeter) or a touch or proximity sensor with no depression required at all. It could employ any type of switch mechanism, including electrical contacts, magnetic, capacitative, resistive, inductive, electric field or optical means, and can include any type of membrane or other mechanism.

The finger position states for a light touch lift switch, regardless of whether or not the lift causes a break in contact between the fingertip and the touch surface, are: RESTING/RELAXED and actuating the switch, or LIFTED and the switch released to its normal position (normal being defined as open if it is a normally open switch, or closed if it is a normally closed switch). The transition between relaxed and lifted is the lift transition T1, and the transition between lifted and relaxed is the drop, return or re-touch transition T2. To summarize: ACTUATED=finger sensed as present, returned, dropped, touching, actuating; NOT ACTUATED=released=finger sensed as absent, lifted, away, not actuating; lifting produces a transition from switch actuated to switch not actuated, or T1; dropping produces a transition from switch not actuated to switch actuated, or T2.

The lift can be just enough to overcome the weight of the finger on the switch to produce a change in state of the switch and optionally also a tactile release, without the fingertip actually breaking contact with the touch surface. Alternatively, in the course of changing the state of the switch, the fingertip can be lifted far enough to break physical contact from the touch surface.

In situations where the light touch lift switch is of the fixed type (zero displacement), the lift always causes the breaking of contact of the fingertip with the touch surface, and the relaxed state can also be referred to as present at the surface, and the lifted state as absent from the surface; with the transitions being: T1=present to absent, and T2=absent to present.

The lift switch of the present invention requires an actuation force of no more than the weight of the resting finger, the actuation requirement/threshold preferably being in the range of zero to 10 grams, and never more than 20 grams. The actual weight of a resting finger, with the other fingers and the palm supported separately, usually ranges from 15 to 30 grams. (The majority of prior art mouse and keyboard switches have an actuation force between approximately 55 and 85 grams.) In the case of generally vertical switch surfaces, such as on a pointing device handle or on a vertical mouse, the grasping/holding force usually exceeds 20 grams, and thus the light touch switch preferred actuation force of between zero and 10 grams still applies (since the grasp would then hold the light touch switch in the actuated state without any extra pressure being applied).

The method of the present invention can be implemented by any means of detecting the dropped/present and lifted/removed positions of the finger. This can be accomplished for example, by any arrangement of proximity sensors, or by any type of optical sensors, including having the fingers in the view of a digital camera, and the output of the camera fed into image processing software which determines when and which fingers are down or up.

Many of the Figures of this specification show pointing devices being used by the right hand. It is intended that for left-hand use, the mirror image be visualized and the terms right and left be interchanged.

### BRIEF DESCRIPTION OF THE DRAWINGS

FIGS. 1 THROUGH 32 describe the operation of the lift-click method by means of sequential illustrations, flow charts, circuit block diagrams and timing diagrams that detail the operation, logic and characteristics of the lift-click modes. Note that FIGS. 1 through 4 show left hand operation (in order to use left to right sequential illustration).

FIGS. 1A through 1C are a time sequence of images that show the use of a prior art mouse button/click switch on a traditional mouse.

FIGS. 2A through 2C are a time sequence of images that diagram the use of the lift method of the present invention on a mouse having a button with a relatively fixed touch sensor surface whose actuation threshold is less than the weight of the relaxed resting finger. The mode is lift-drop.

FIGS. 3A through 3C are a time sequence of images that diagram the use of the lift method of the present invention on a mouse having a button with a relatively fixed touch sensor surface whose actuation threshold is less than the weight of the relaxed resting finger. Here the mode is lift-delay, where the click function is triggered by either the lift or by the end of a delay triggered by the lift.

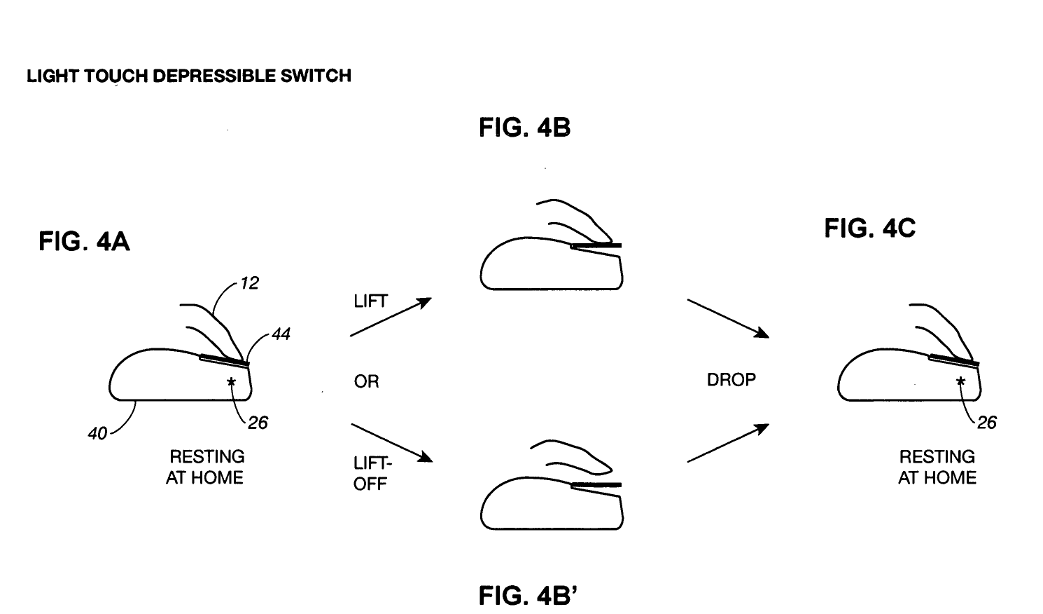

FIGS. 4A through 4C are a time sequence of images that show the general mechanics of the lift method of the present invention on a mouse having a switch with a depressible switch surface whose actuation threshold is less than the weight of the relaxed resting finger. Here the click function is triggered by either a lift-delay or a lift-drop. At the top of the lift, finger contact is either maintained (FIG. 4B) or broken (FIG. 4B′).

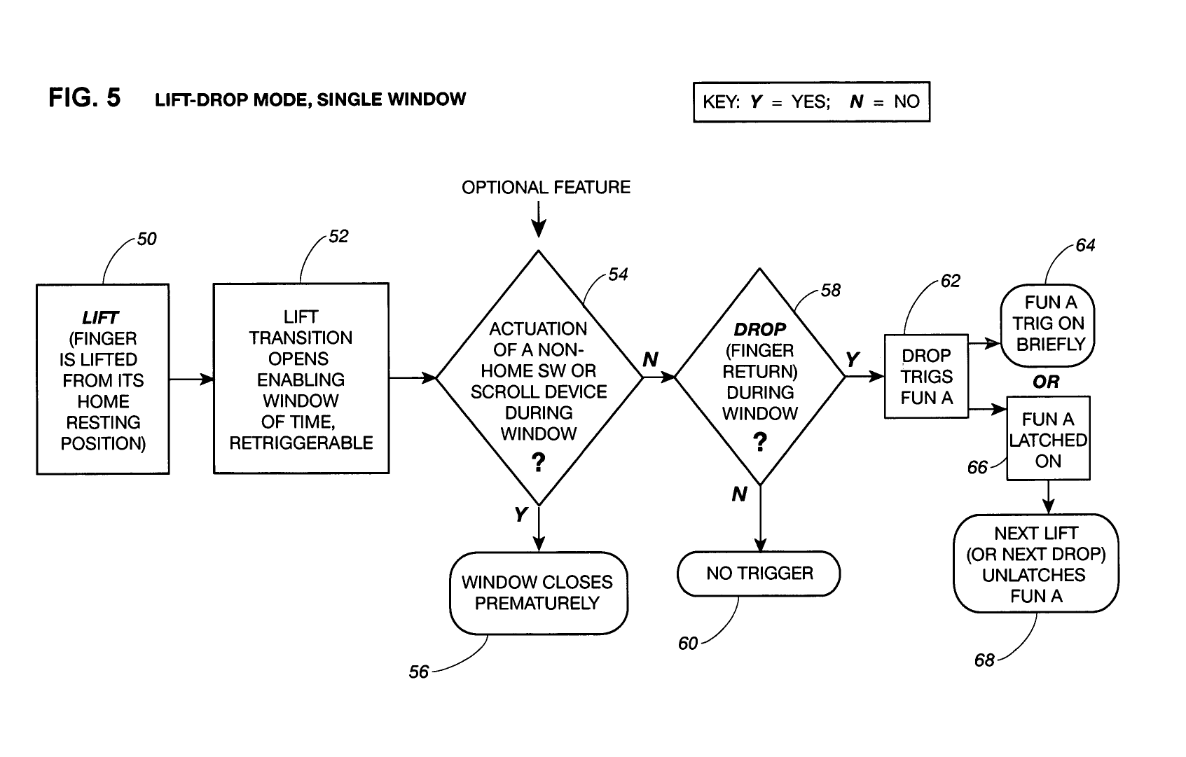

FIG. 5 is a flowchart describing the single window lift-drop mode.

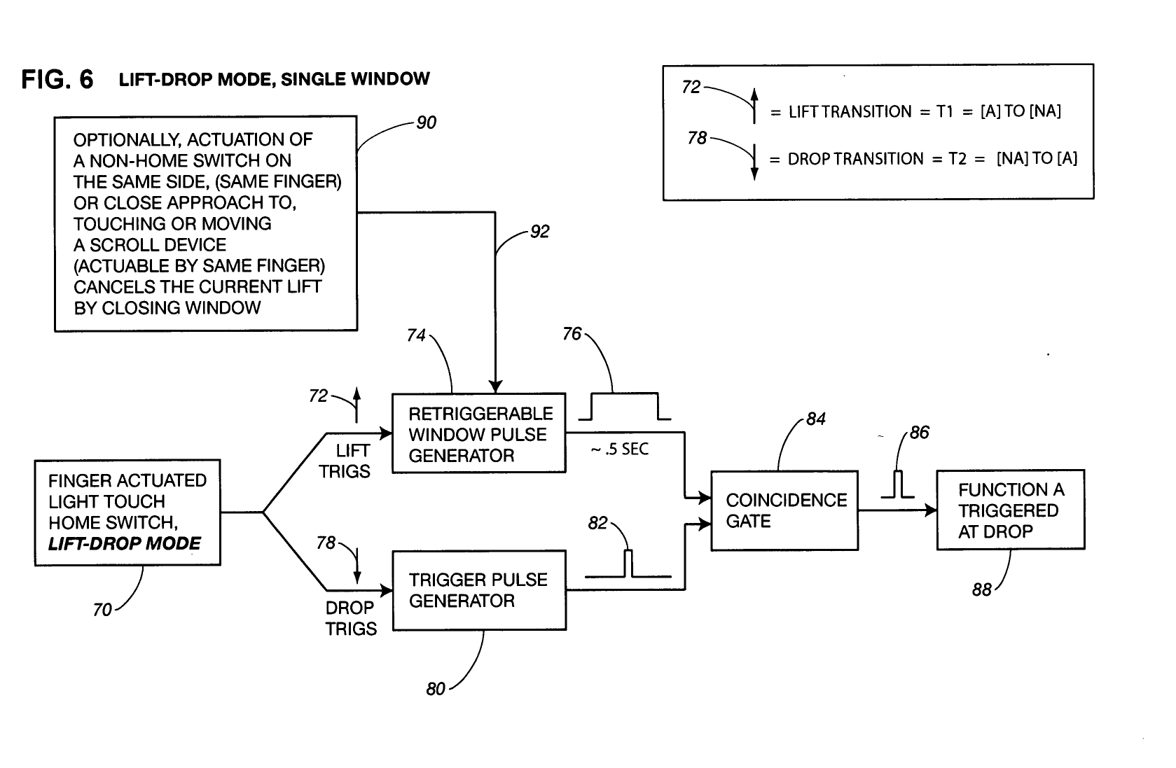

FIG. 6 is an electronic block diagram illustrating the detailed characteristics and use of the single window lift-drop mode including a provision for automatically canceling the lift if any non-home switch is actuated.

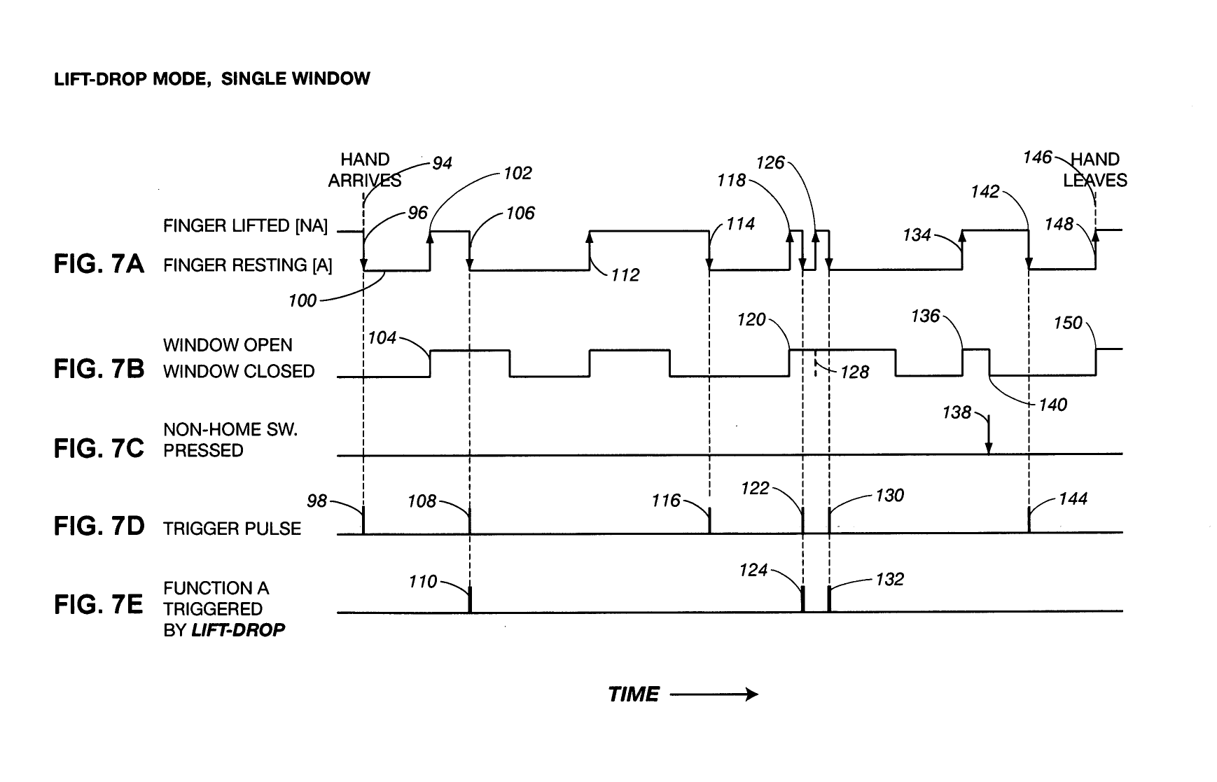

FIG. 7 is a timing diagram illustrating the operation of the lift-drop mode of FIG. 5 and FIG. 6.

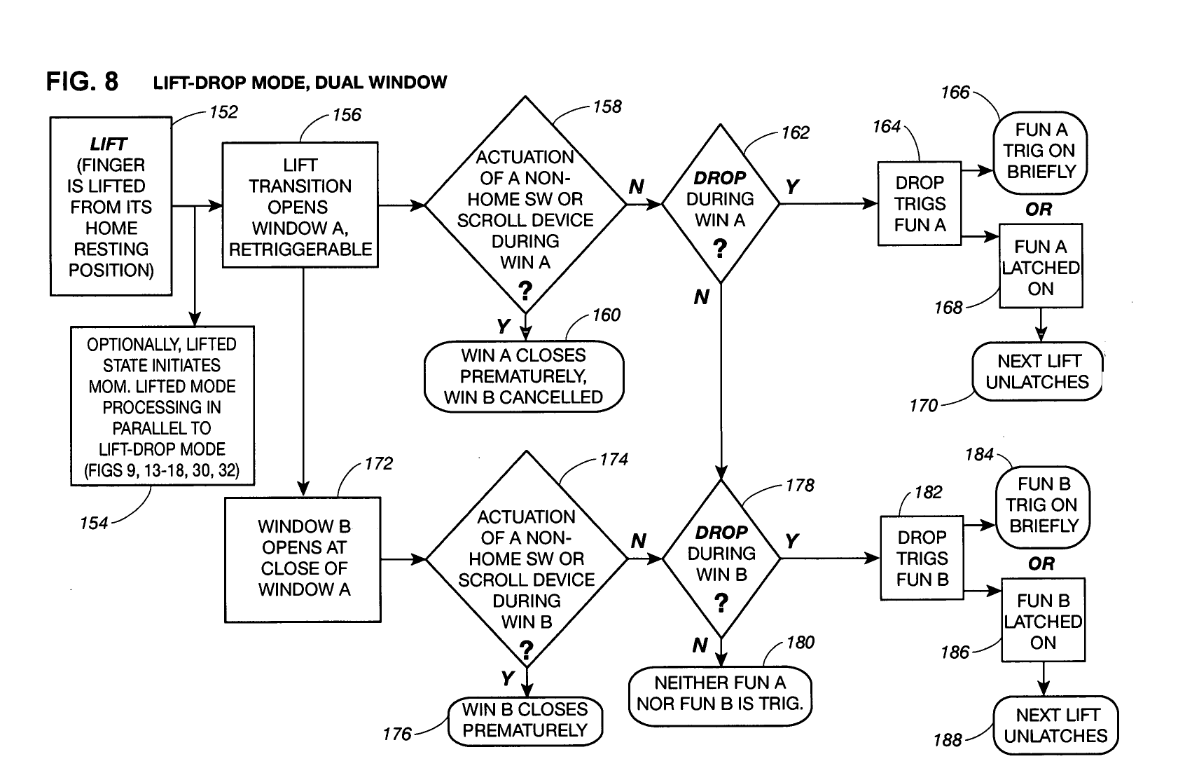

FIG. 8 is a flowchart introducing the AB dual window concepts of short lift-drop and medium lift-drop.

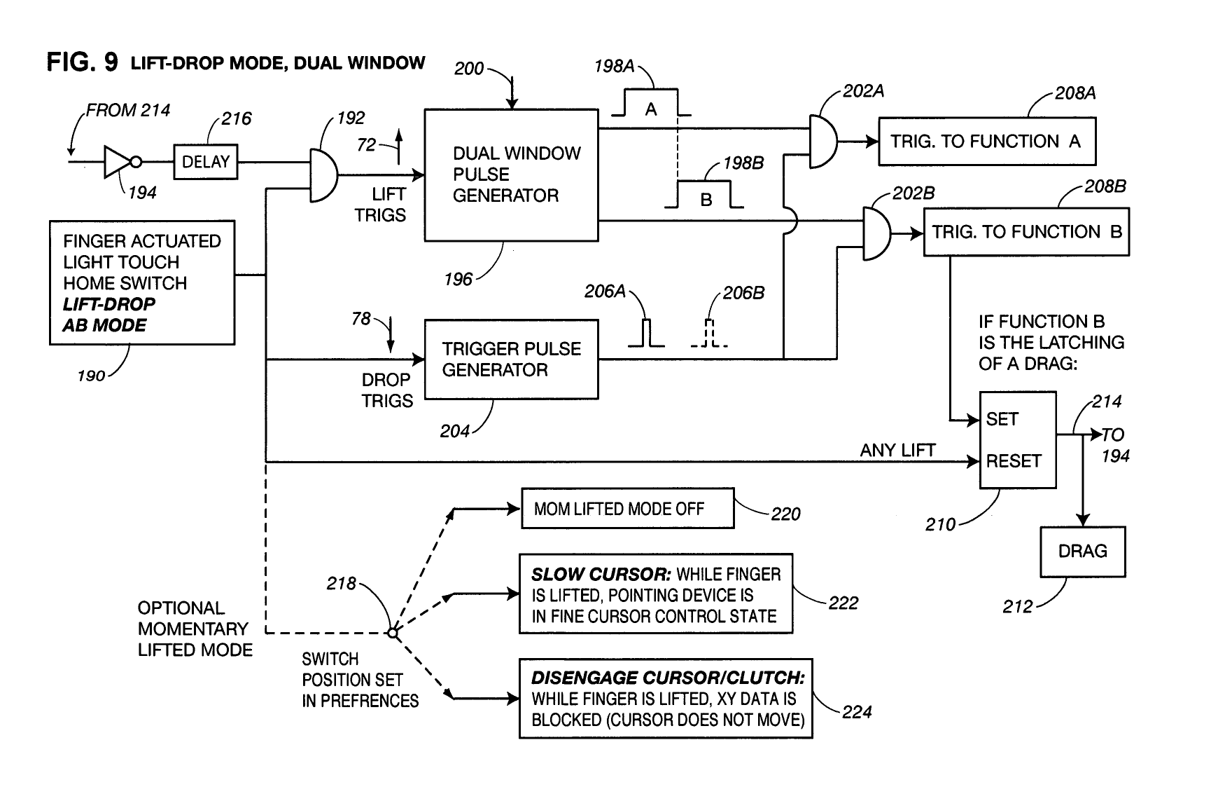

FIG. 9 is an electronic block diagram that implements the lift-drop dual window mode.

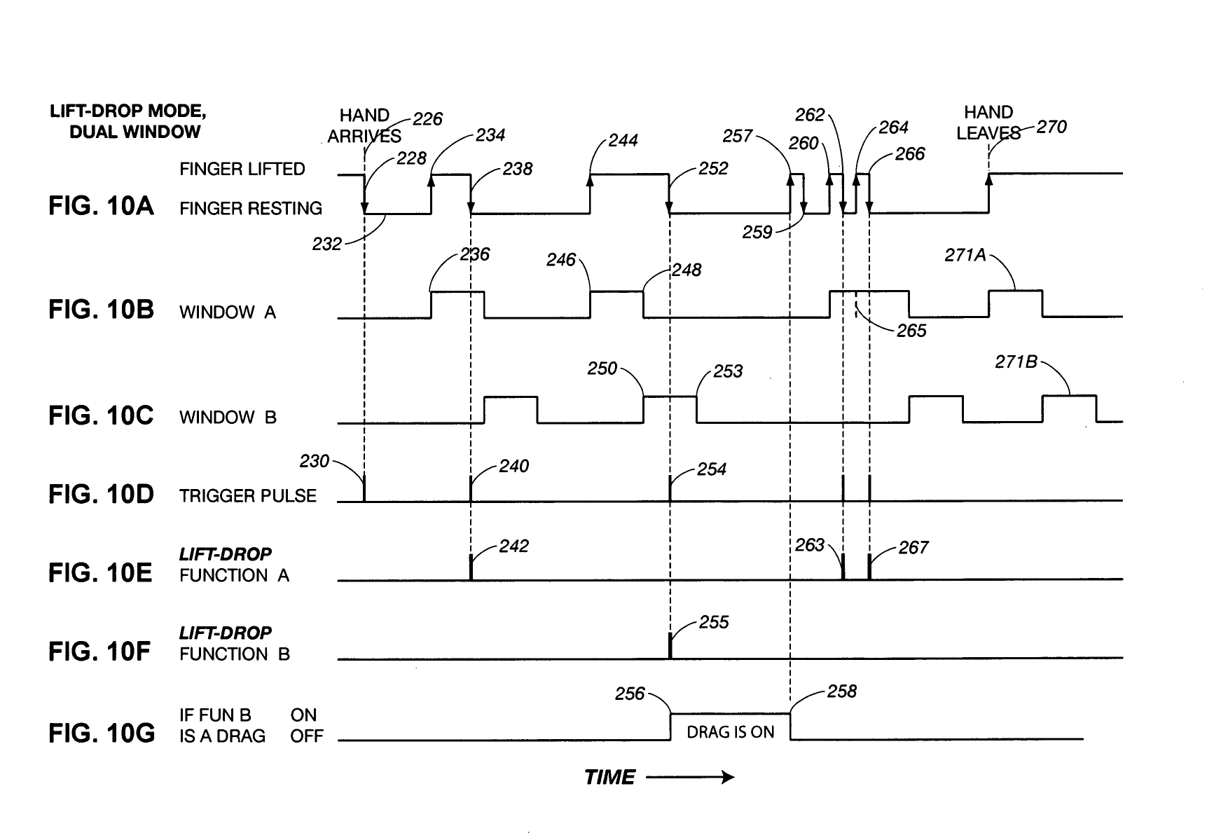

FIG. 10 is a timing diagram illustrating the detailed characteristics and use of the dual window lift-drop mode.

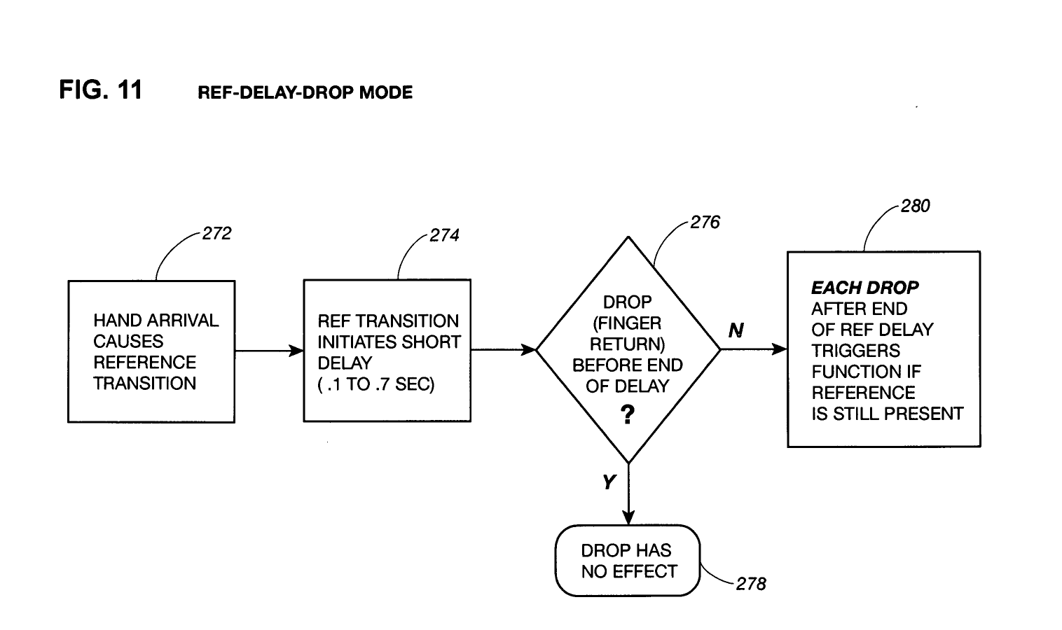

FIG. 11 is flowchart illustrating an alternate lift-click mode: the reference-delay-drop mode.

FIG. 12 is an electronic block diagram illustrating the reference-delay-drop mode.

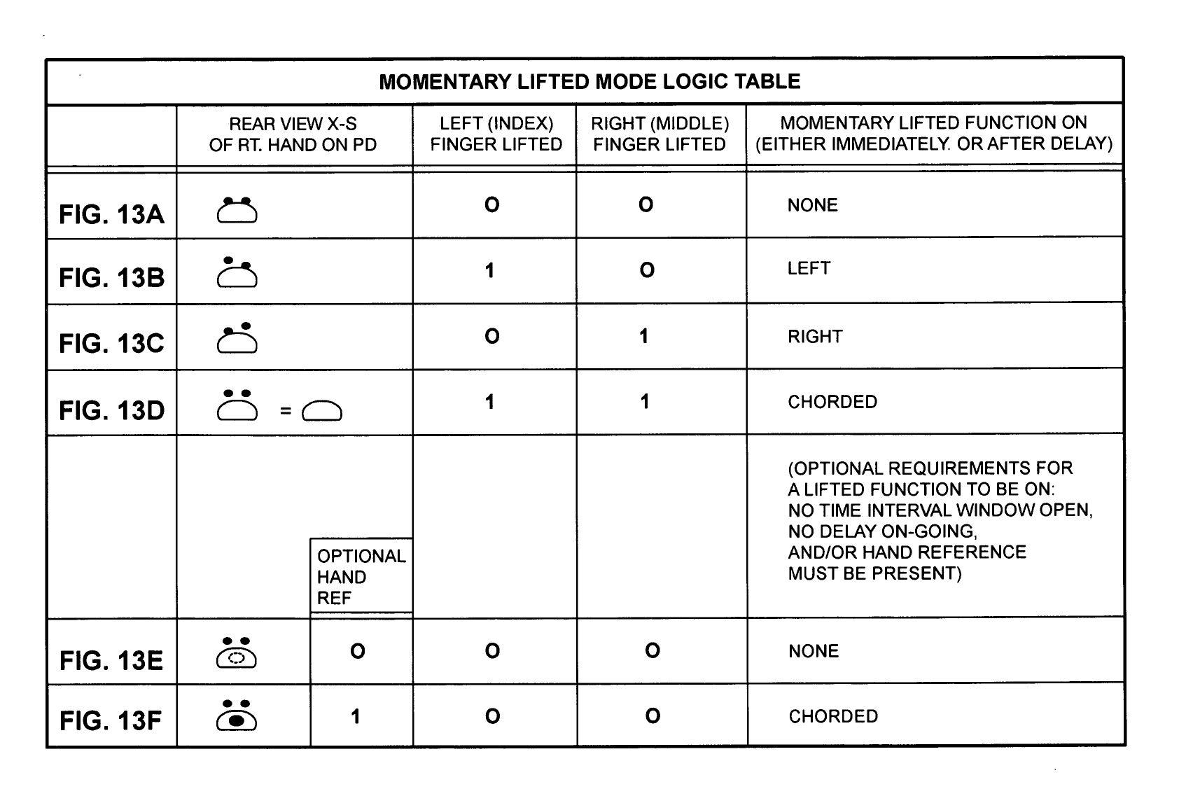

FIGS. 13A through 13F comprise a table showing momentary lifted mode logic.

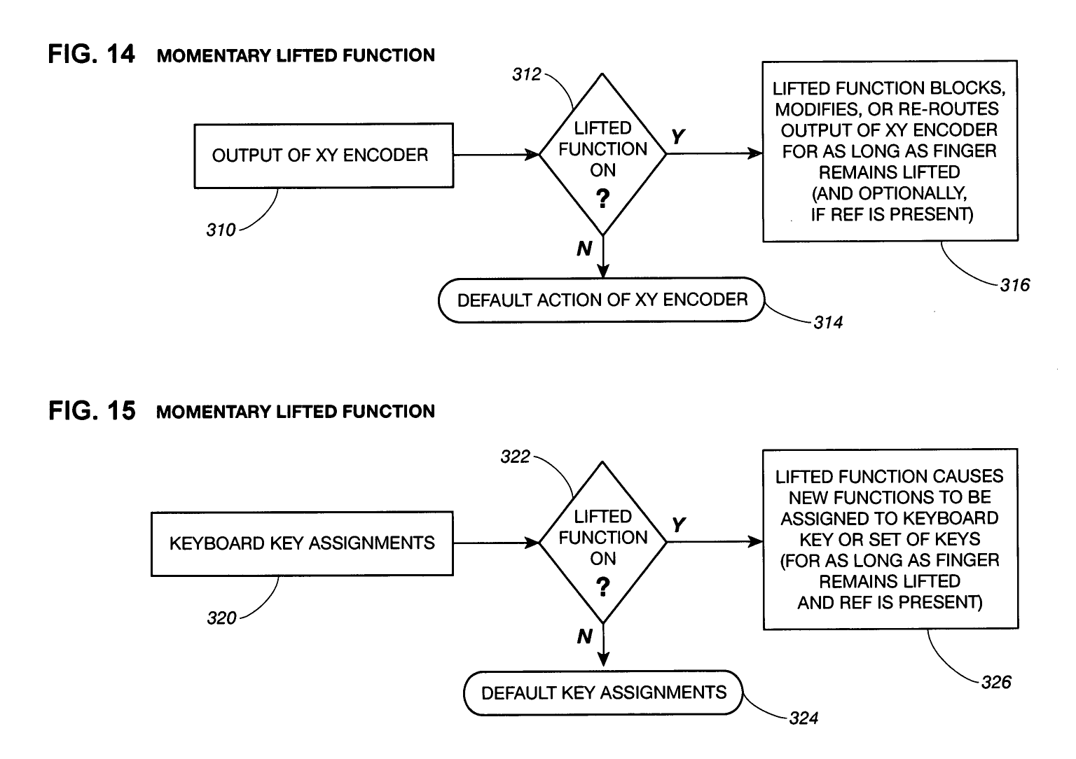

FIG. 14 shows the use of a momentary lifted function to affect the output of a pointing device's XY encoder.

FIG. 15 shows the use of a momentary lifted function momentarily change the functions assigned to keyboard keys.

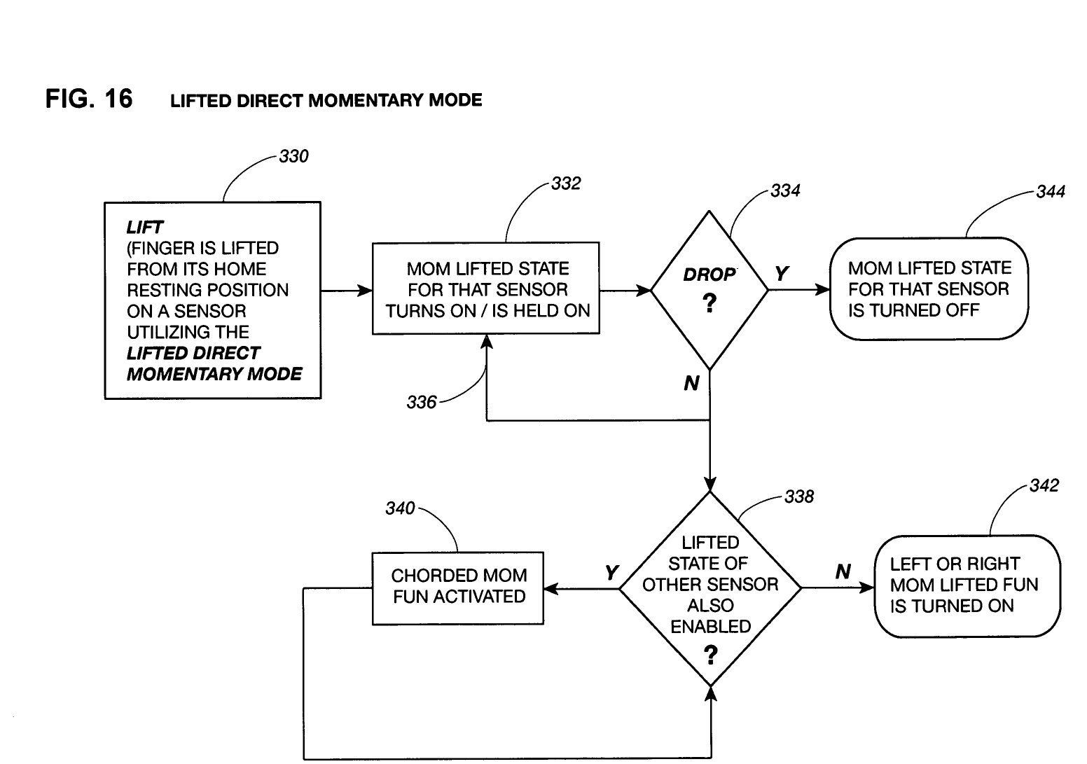

FIG. 16 is a flowchart illustrating the operation of the lifted-direct momentary mode.

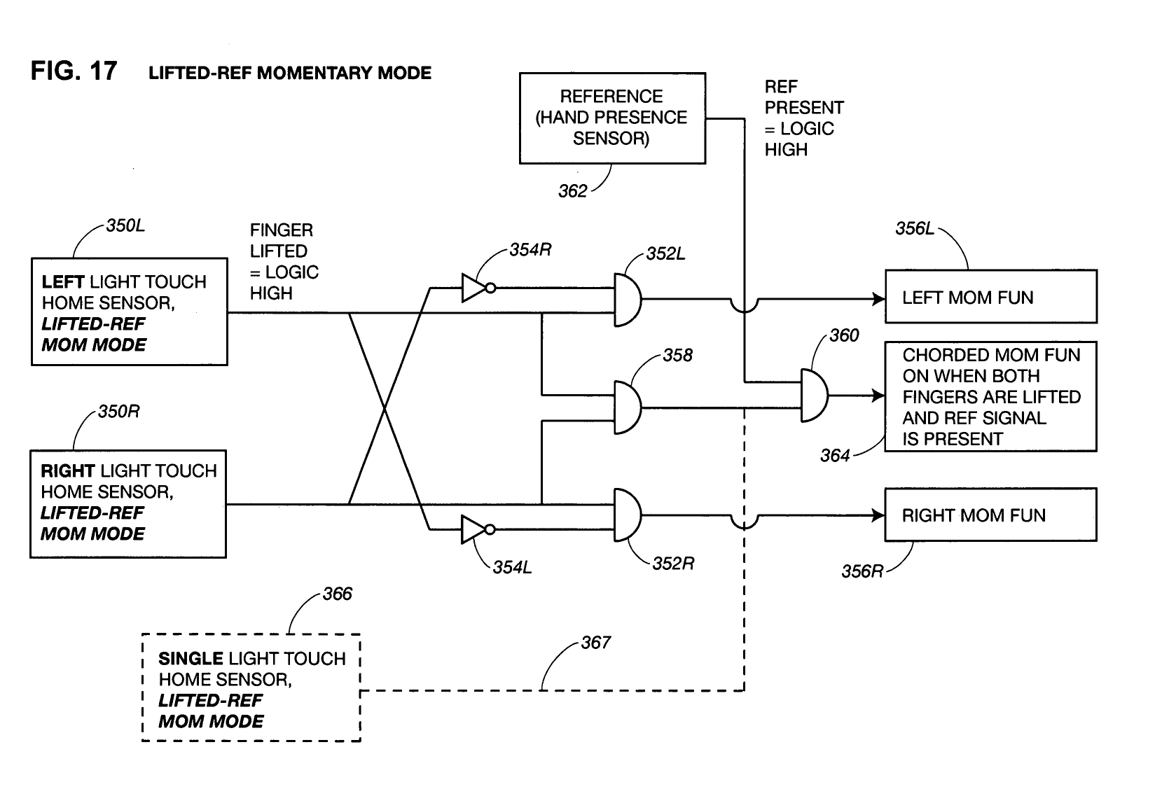

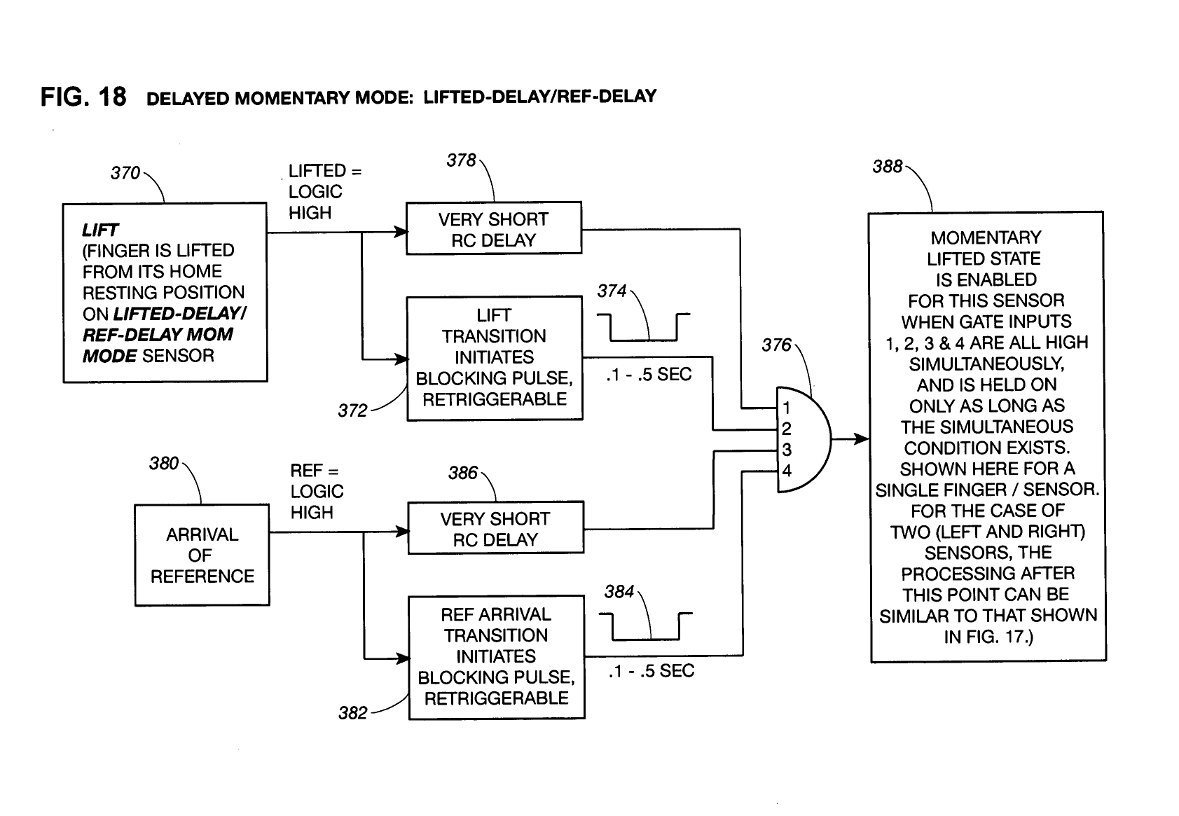

FIG. 17 is an electronic block diagram illustrating the lifted-reference momentary mode.

FIG. 18 is a flowchart illustrating the operation of the lifted-delay/ref-delay momentary mode.

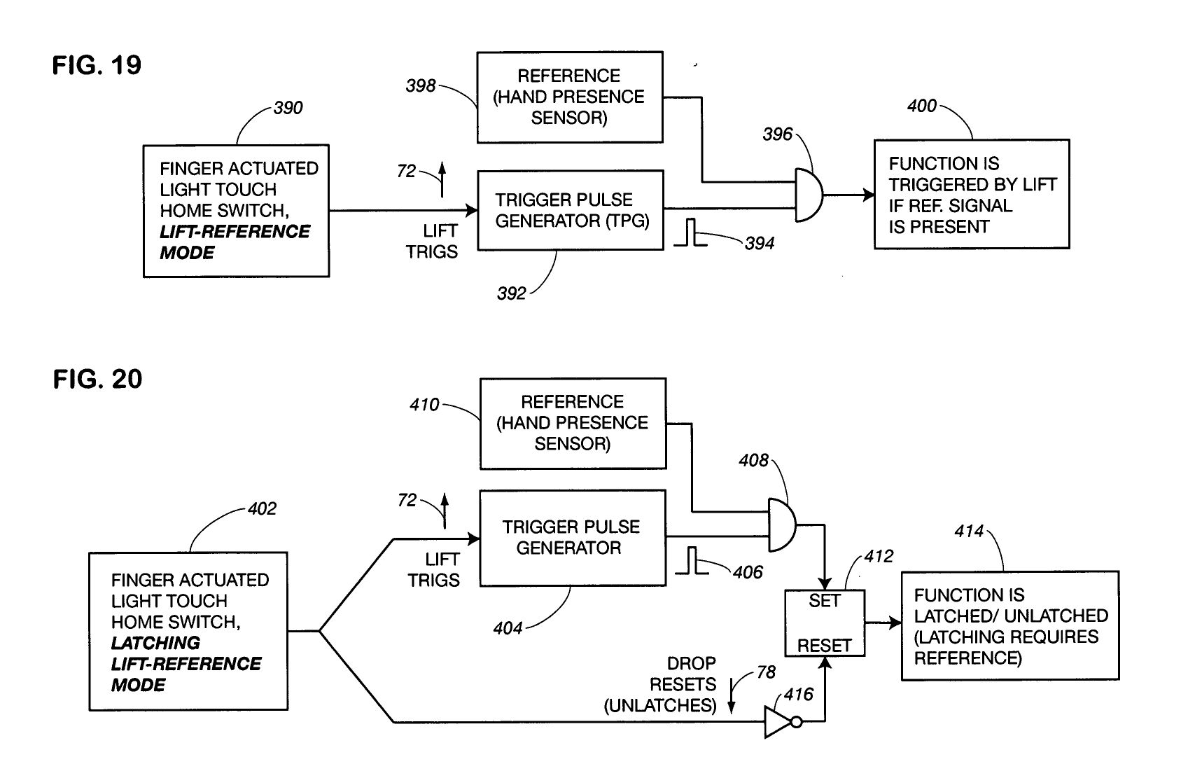

FIG. 19 is an electronic block diagram illustrating the lift-reference mode.

FIG. 20 is an electronic block diagram illustrating the latching lift-reference mode.

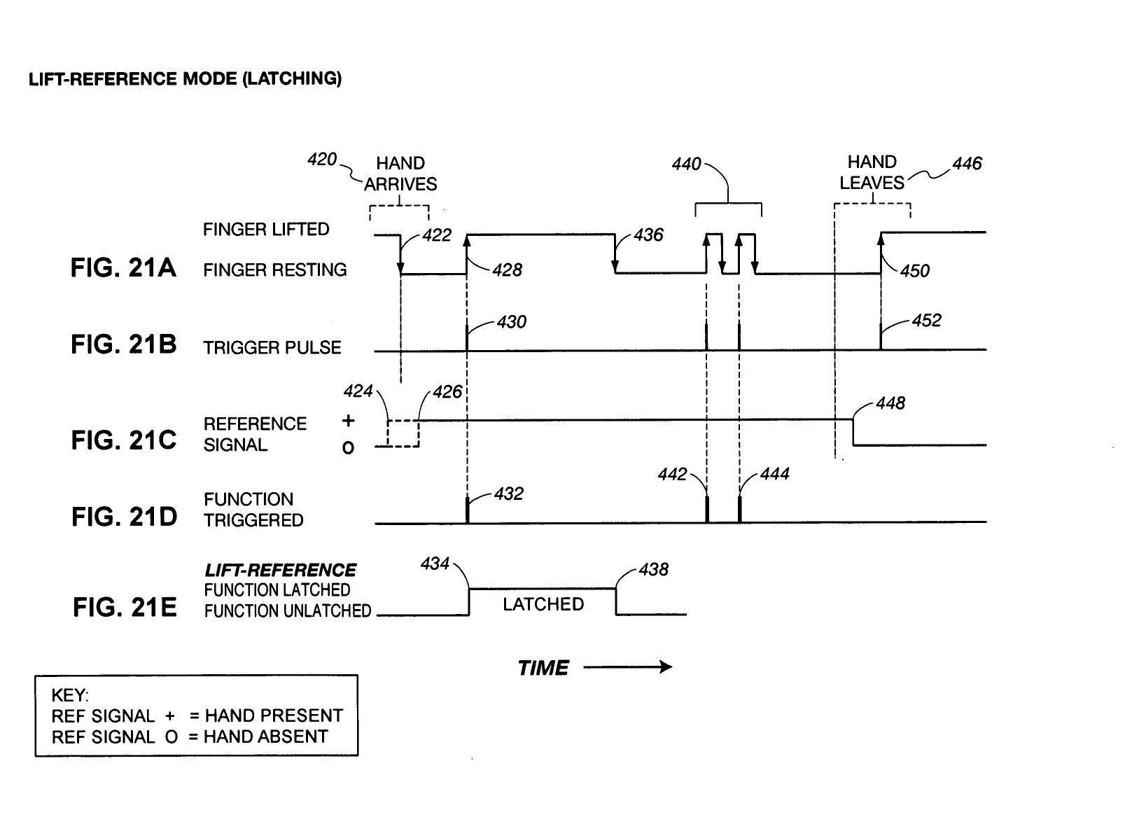

FIGS. 21A through 21E comprise a timing diagram illustrating the detailed characteristics and operation of the lift-reference mode of FIG. 19 and the latching lift-reference mode of FIG. 20.

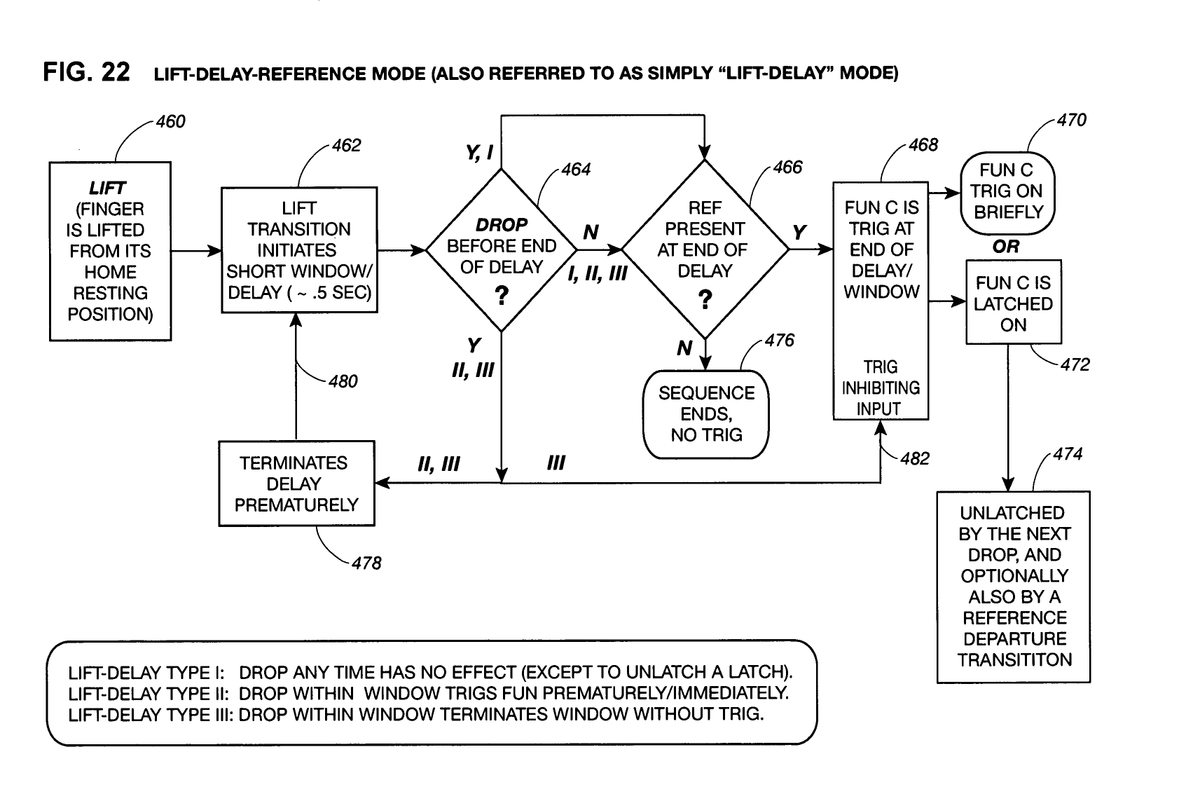

FIG. 22 is a flowchart illustrating the operation of the lift-delay mode.

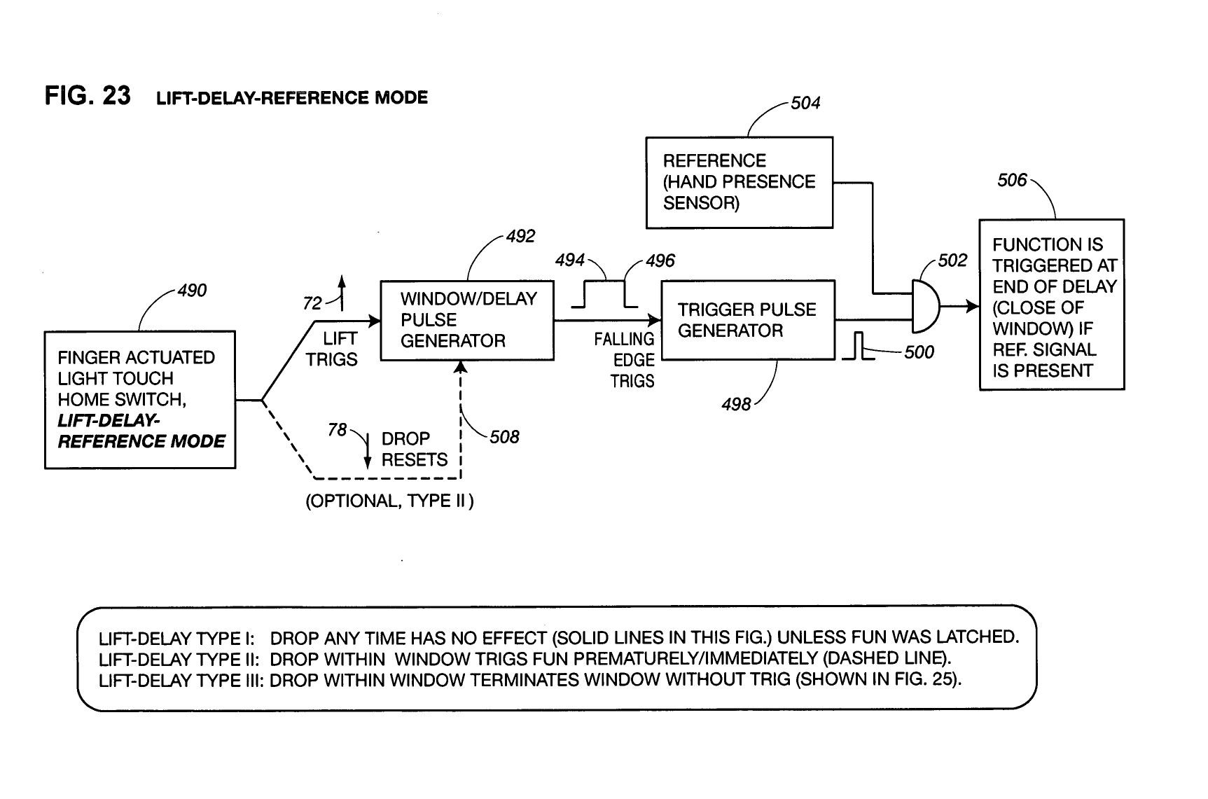

FIG. 23 is an electronic block diagram illustrating the operation of the lift-delay mode.

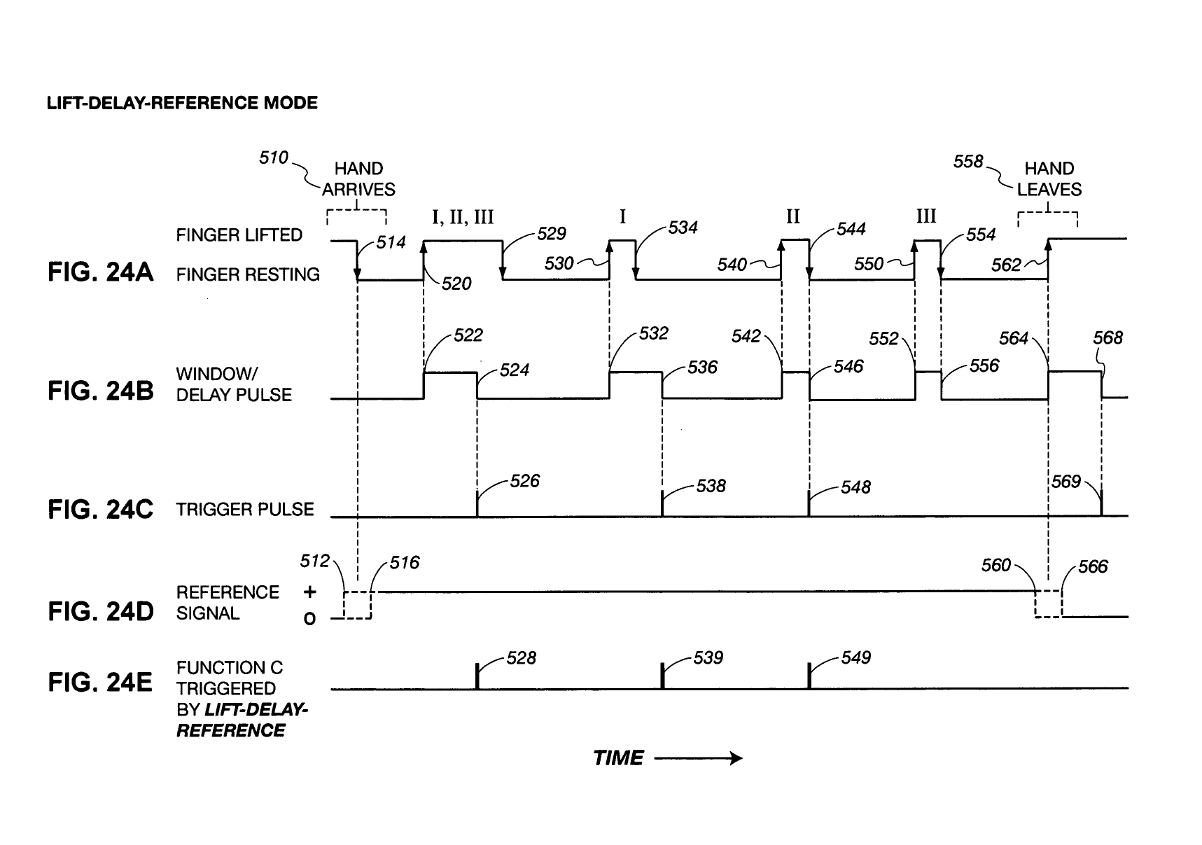

FIG. 24 is a timing diagram showing the detailed characteristics and operation of the lift-delay mode of FIGS. 22 and 23.

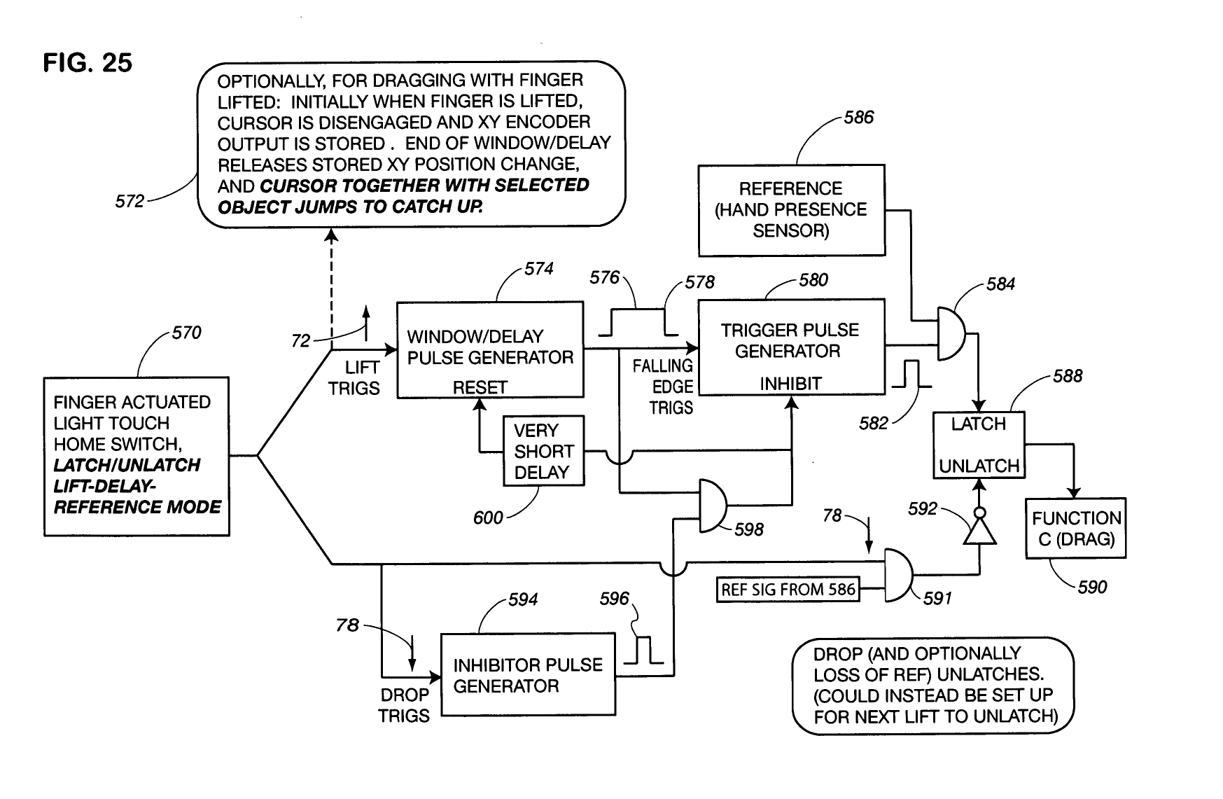

FIG. 25 is an electronic block diagram illustrating the operation of the latch/unlatch lift-delay mode.

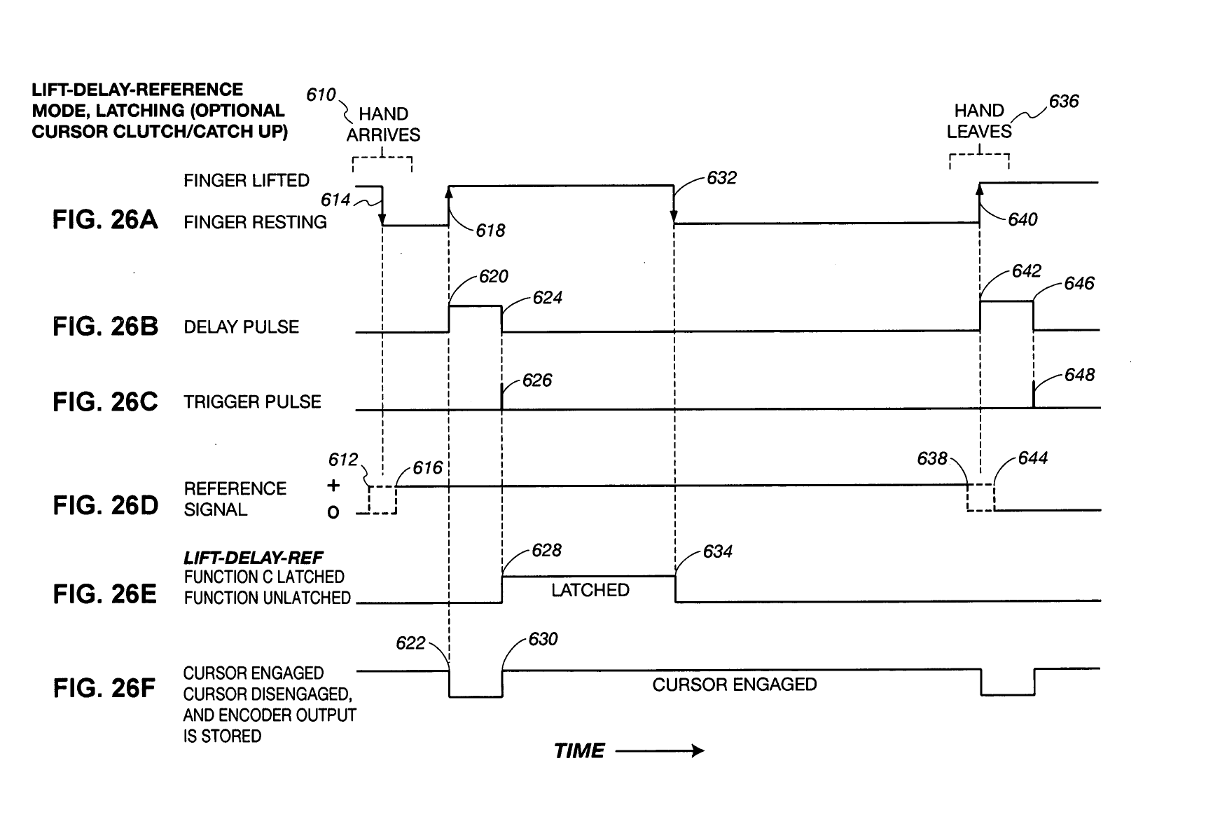

FIGS. 26A through 26F is a timing diagram showing the detailed characteristics and operation of the latch/unlatch lift-delay mode of FIG. 25.

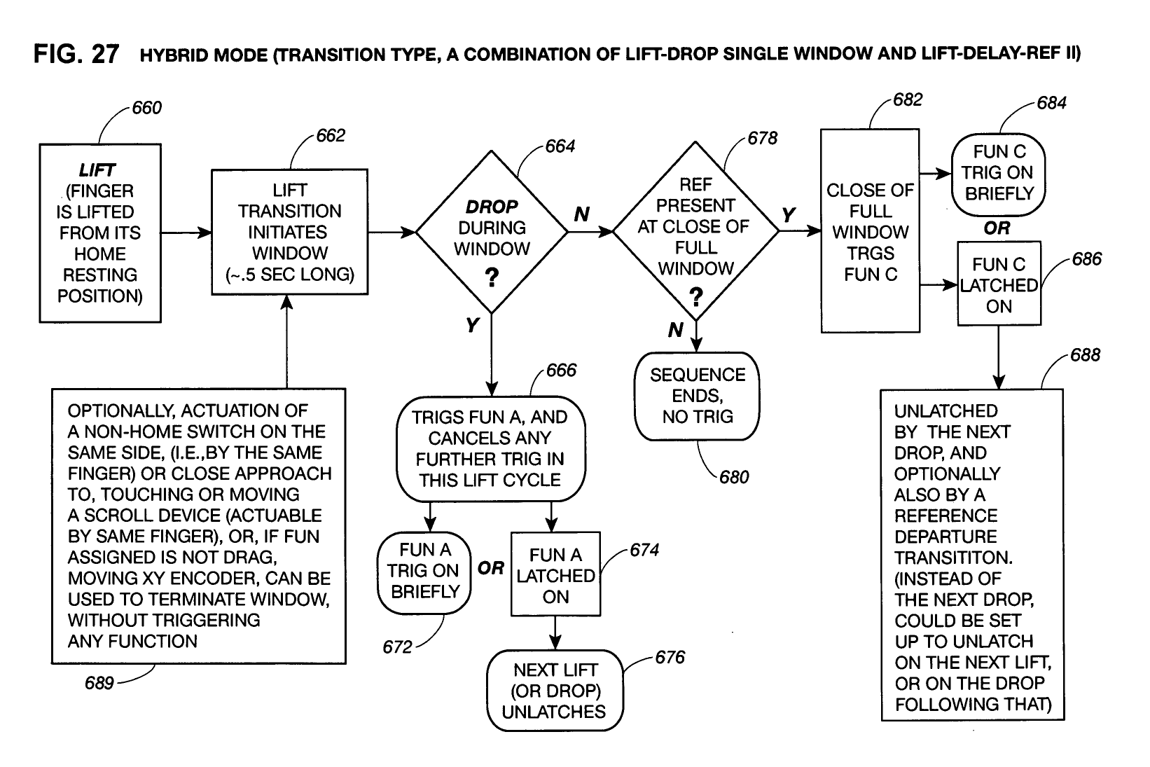

FIG. 27 is a flowchart illustrating the characteristics of a hybrid mode that combines lift-drop and lift-delay functions.

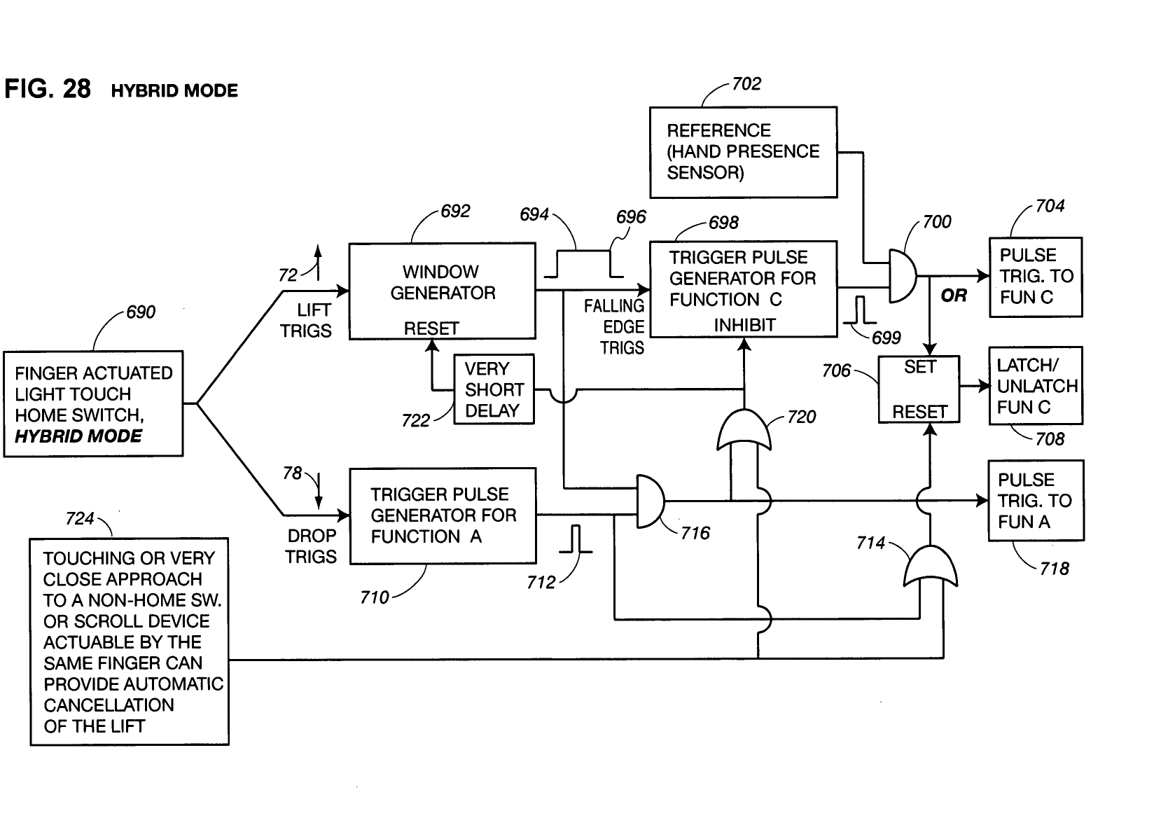

FIG. 28 is an electronic block diagram illustrating the operation of the hybrid mode of FIG. 27.

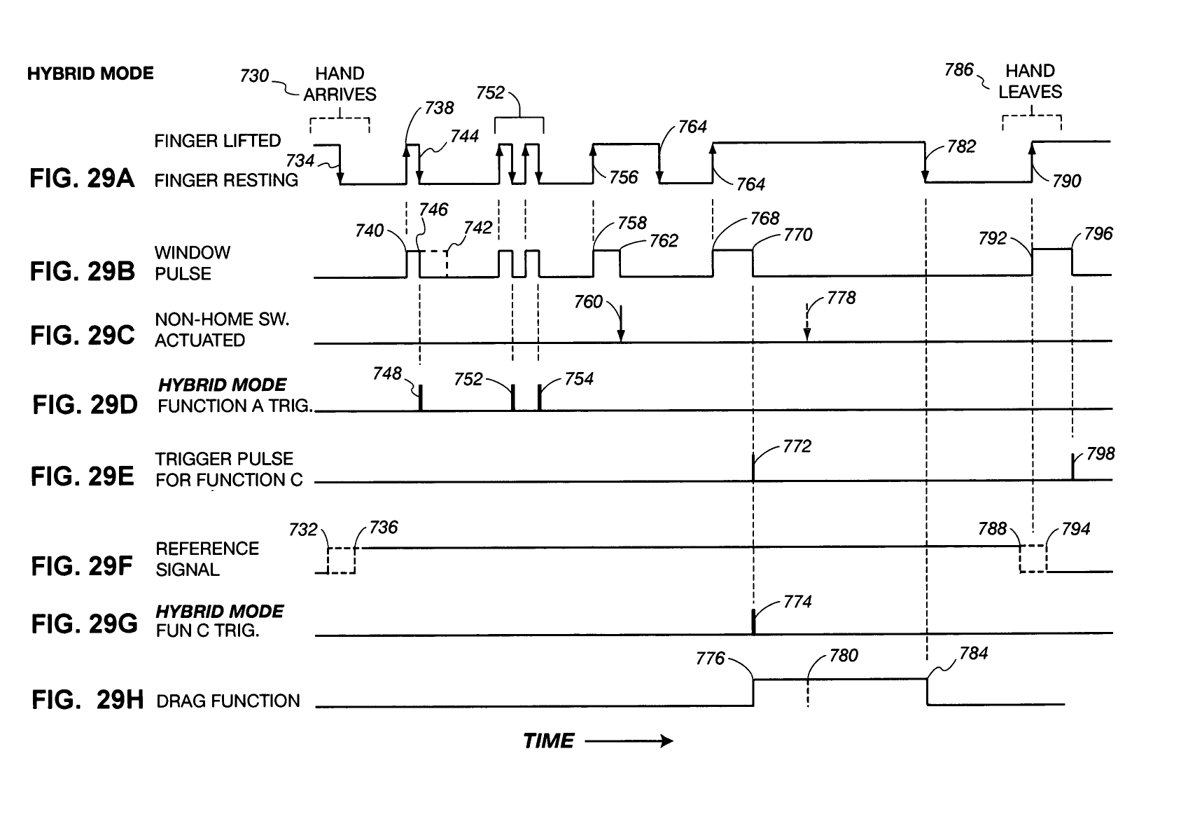

FIG. 29 is a timing diagram showing the detailed characteristics and operation of the hybrid mode of FIGS. 27 and 28.

FIG. 30 is an electronic block diagram showing the operation of a hybrid mode where the finger held lifted directly holds function C on, without having to use a latch.

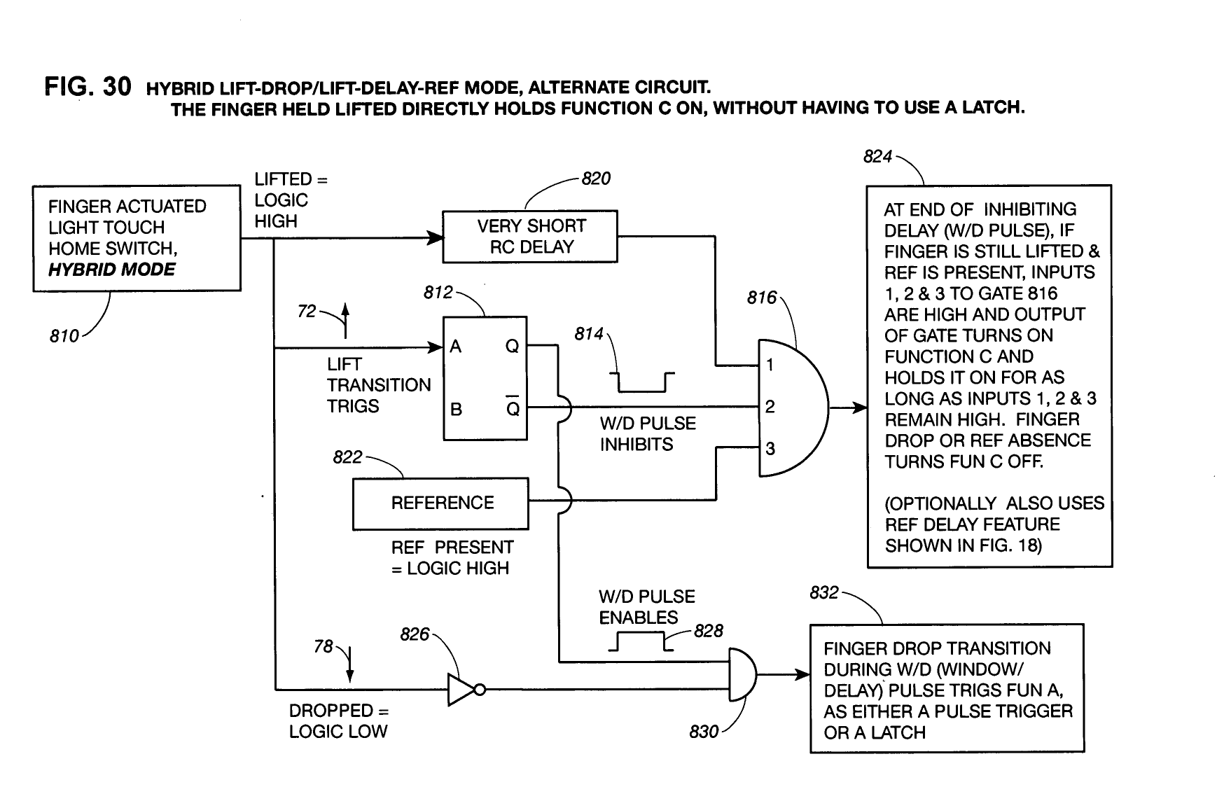

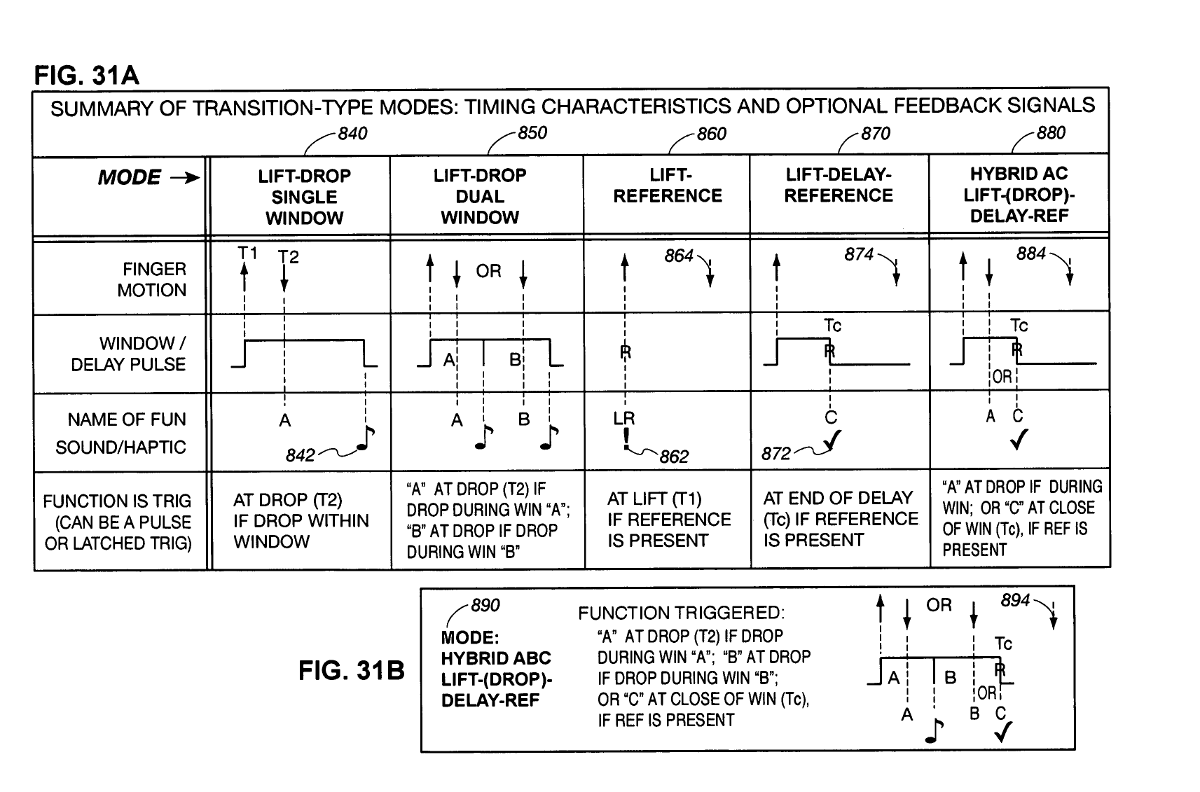

FIGS. 31A and 31B comprise a table that summarizes transition-type mode timing characteristics and shows optional click sounds.

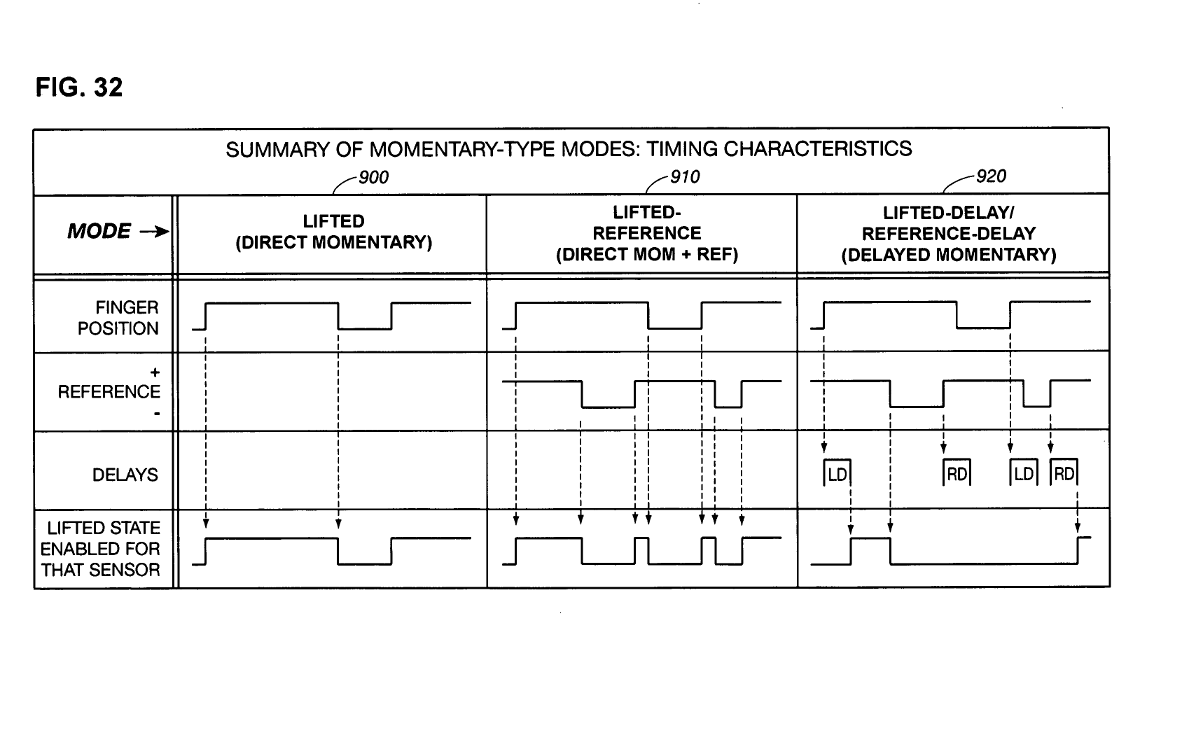

FIG. 32 is a table summarizing momentary-type mode timing characteristics.

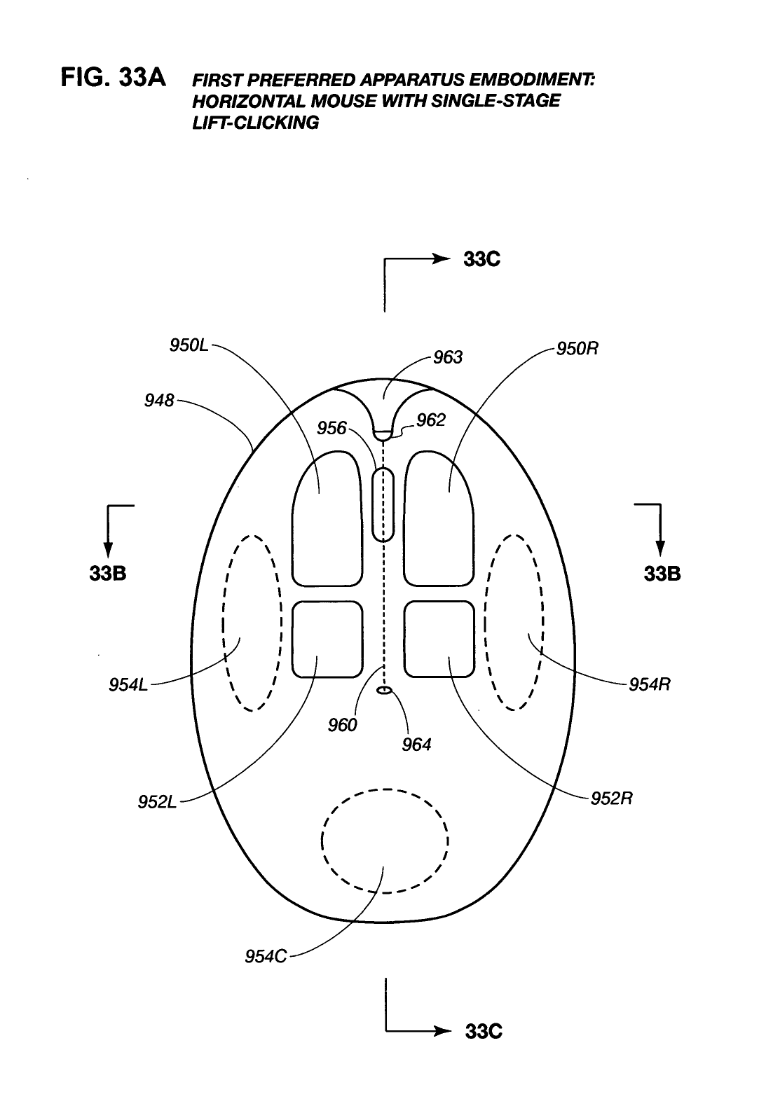

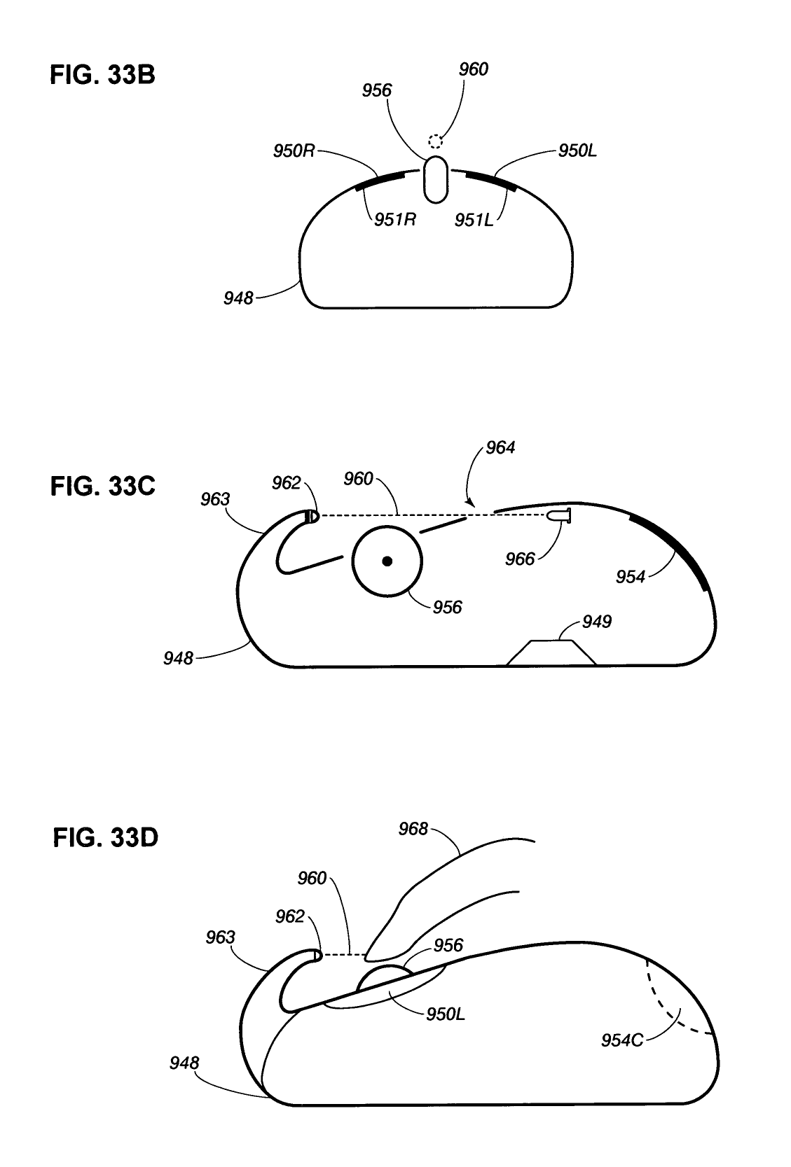

FIGS. 33 THROUGH 42 illustrate a number of embodiments of the lift-click method in mouse-type pointing devices, including function assignments and setup.

FIGS. 33A through 33D illustrate a first preferred apparatus embodiment of single-stage lift type sensors on a horizontal mouse, showing left and right relatively fixed type touch switches and a light beam sensor for detecting a finger at the scroll device.

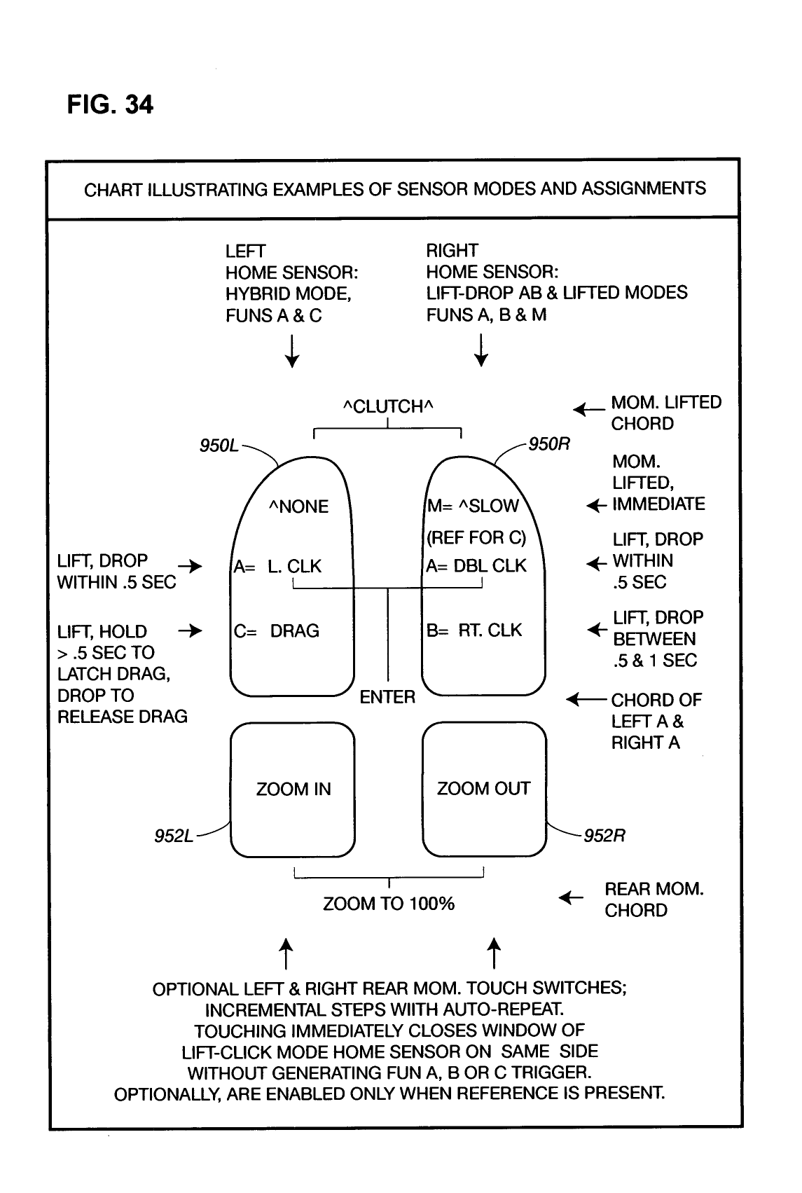

FIG. 34 is a chart showing an example of assignments of modes and functions to the sensor/switches of the embodiment pictured in FIG. 33A.

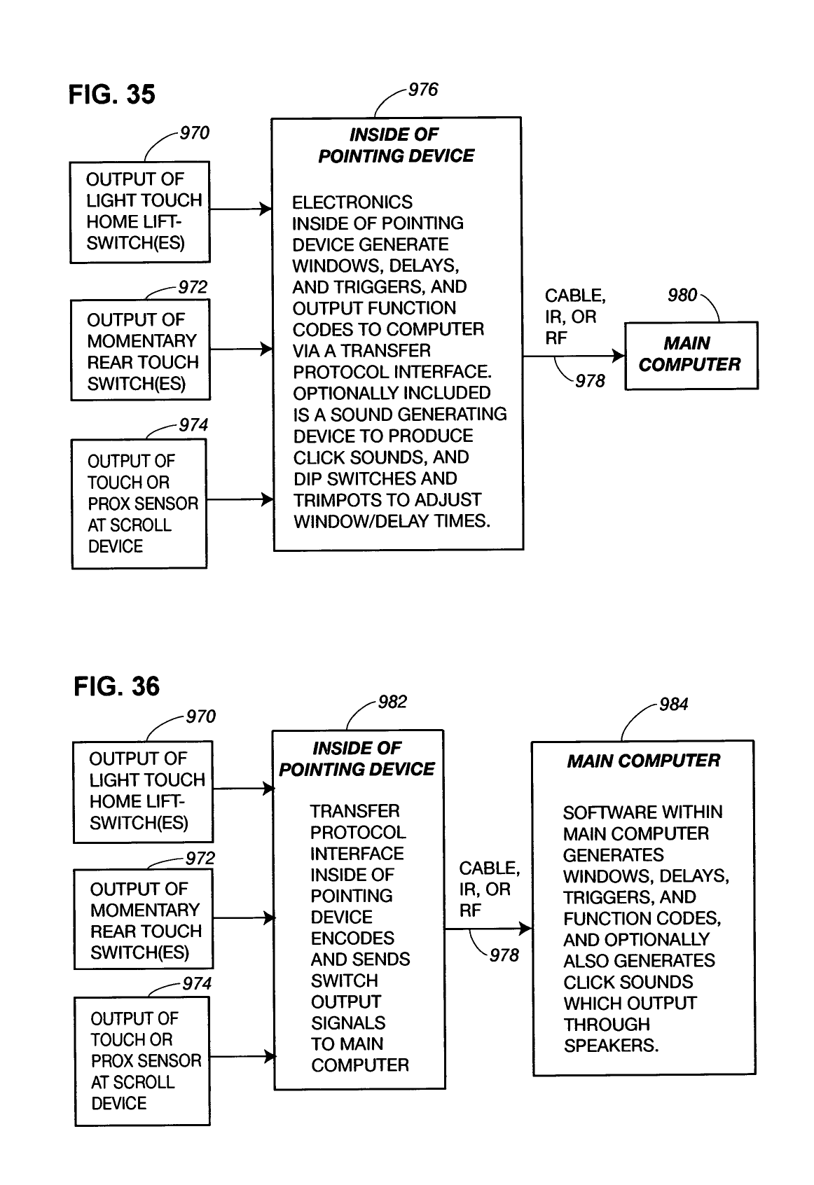

FIG. 35 describes the operations carried out within a version of the embodiment of FIG. 33A where most of the processing for the lift-type switching is carried out inside the pointing device.

FIG. 36 describes the operations carried out within a version of the embodiment of FIG. 33A where most of the processing for the lift-type switching is carried out inside the computer.

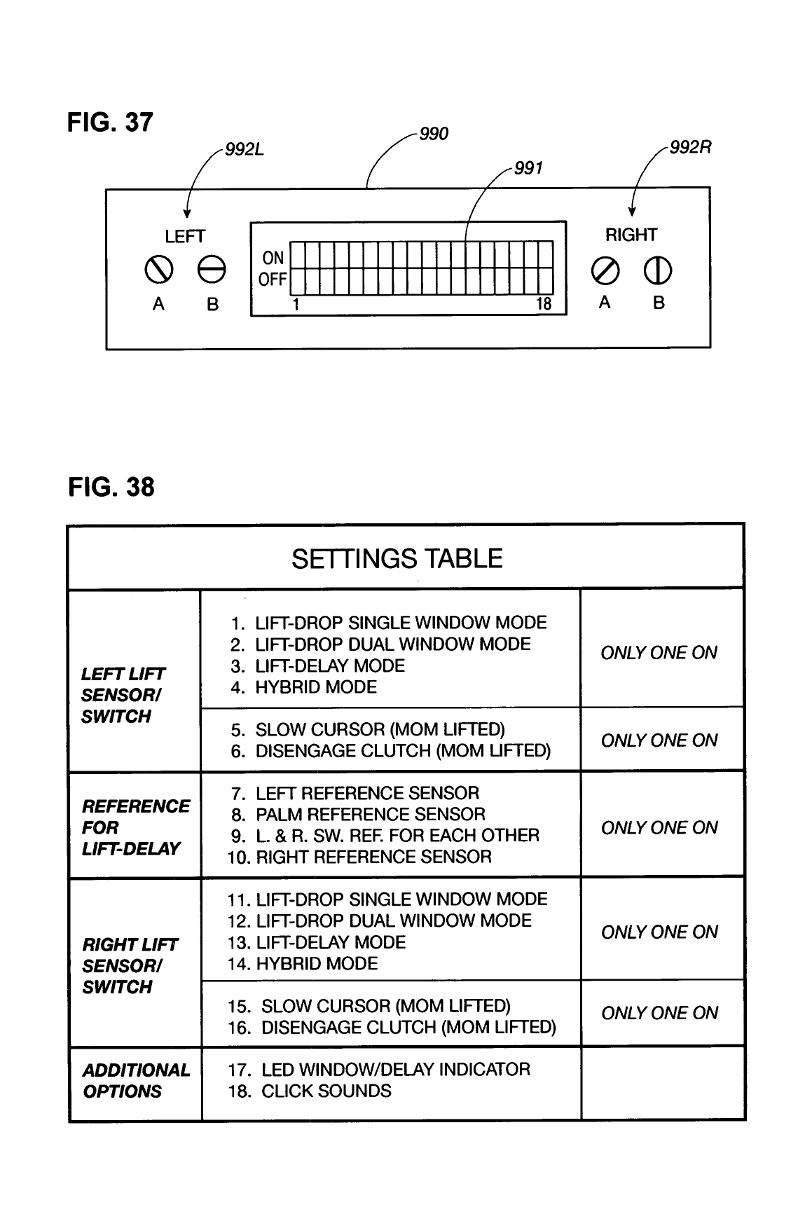

FIG. 37 is a view through an optional hatch in the mouse of FIG. 33A, showing internal optional switches for choosing mode and reference, and optional adjustment screws for setting window and delay times.

FIG. 38 shows a settings table describing the functions of the 18 dip switches of FIG. 37. This table can also serve as a list of preference settings in an on-screen window for using driver software instead of dip switches to choose mode and options.

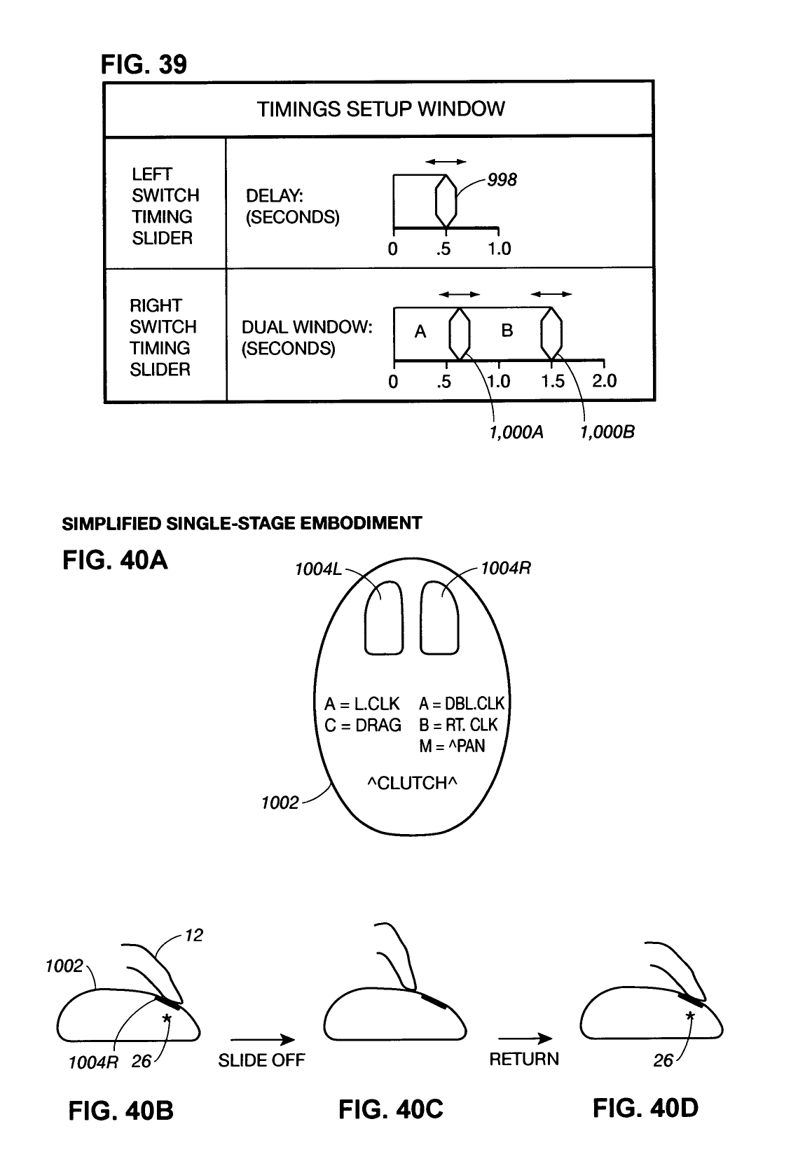

FIG. 39 illustrates a timings setup window for driver software that provides sliders for on-screen setting of window and delay times.

FIG. 40A is a top view of an alternate, simplified embodiment of the lift type of switches on a mouse, showing left and right lift-type sensors. FIGS. 40B, 40C and 40D are side views that demonstrate the use of the embodiment of FIG. 40A by sliding a finger along the touch surface. (Left hand operation is shown.)

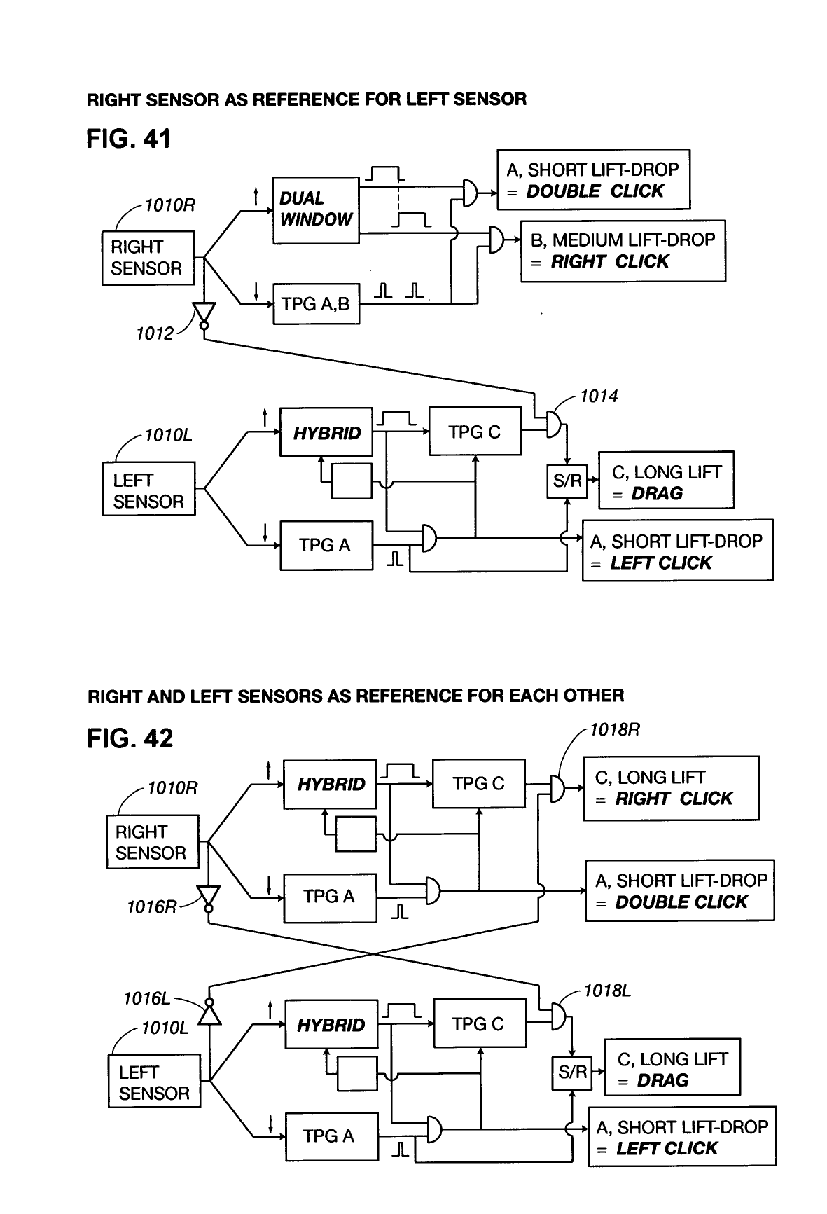

FIG. 41 is an electronic block schematic diagram illustrating how two lift-type sensors, such as those shown in the embodiment of FIG. 40A, can serve as finger presence references for each other when one sensor is using a lift-drop mode and the other is using a hybrid mode.

FIG. 42 is an electronic block schematic showing how two lift-type sensors, such as those shown in the embodiment of FIG. 40A, can serve as finger presence references for each other when both use a hybrid mode.

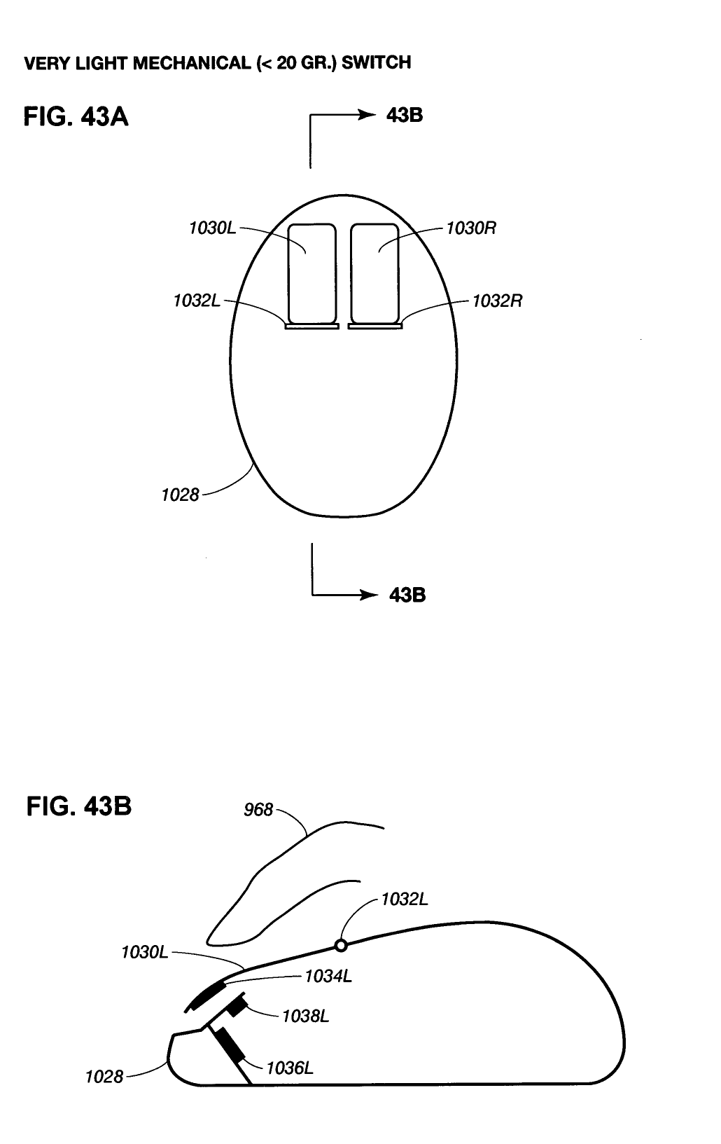

FIGS. 43 THROUGH 48 present detailed single-stage light touch lift-click switch mechanisms, shown embodied in horizontal mouse type pointing devices (replacing the prior art >20 gm depression/push mouse buttons).

FIG. 43A is a top view of a mouse embodiment carrying two lift-type switches (as left and right mouse buttons) of a mechanical small displacement depressible type (non-fixed), requiring less than ten grams of force to actuate.

FIG. 43B is a side view cross-section of the mechanical lift-switch embodiment of FIG. 43A, showing an example of internal mechanism utilizing magnets for both repulsion (in lieu of a spring return mechanism) and for sensing depression via a magnetic sensor.

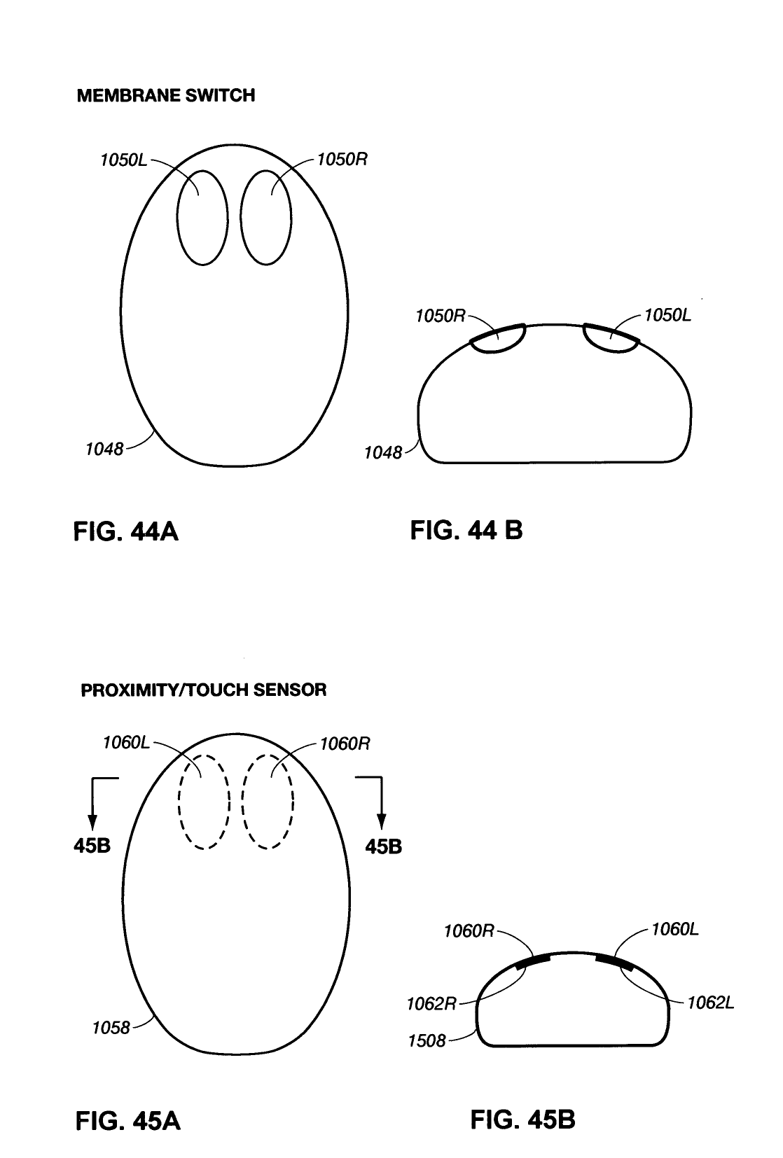

FIG. 44A is a top view and FIG. 44B is a front view, of a thin membrane touch switch embodiment of the lift-switch of the present invention.

FIG. 45A is a top view, and FIG. 45B is a front view cross-section, of an internal touch/proximity sensor switch embodiment of the lift-switch of the present invention.

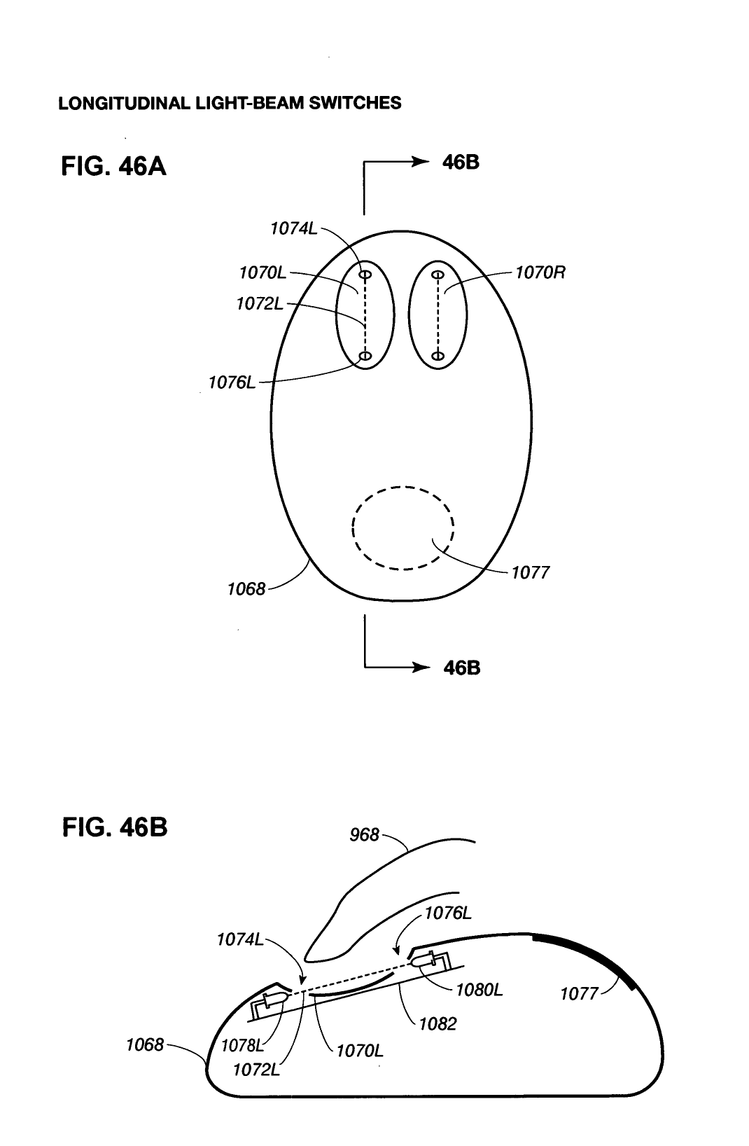

FIG. 46A is a top view, and FIG. 46B is a side view cross-section, of a longitudinal light-beam finger lift sensor switch embodiment of the lift-switch of the present invention, where each switch utilizes a LED producing a light beam parallel to the long axis of the finger, a photosensor, and a fixed touch surface.

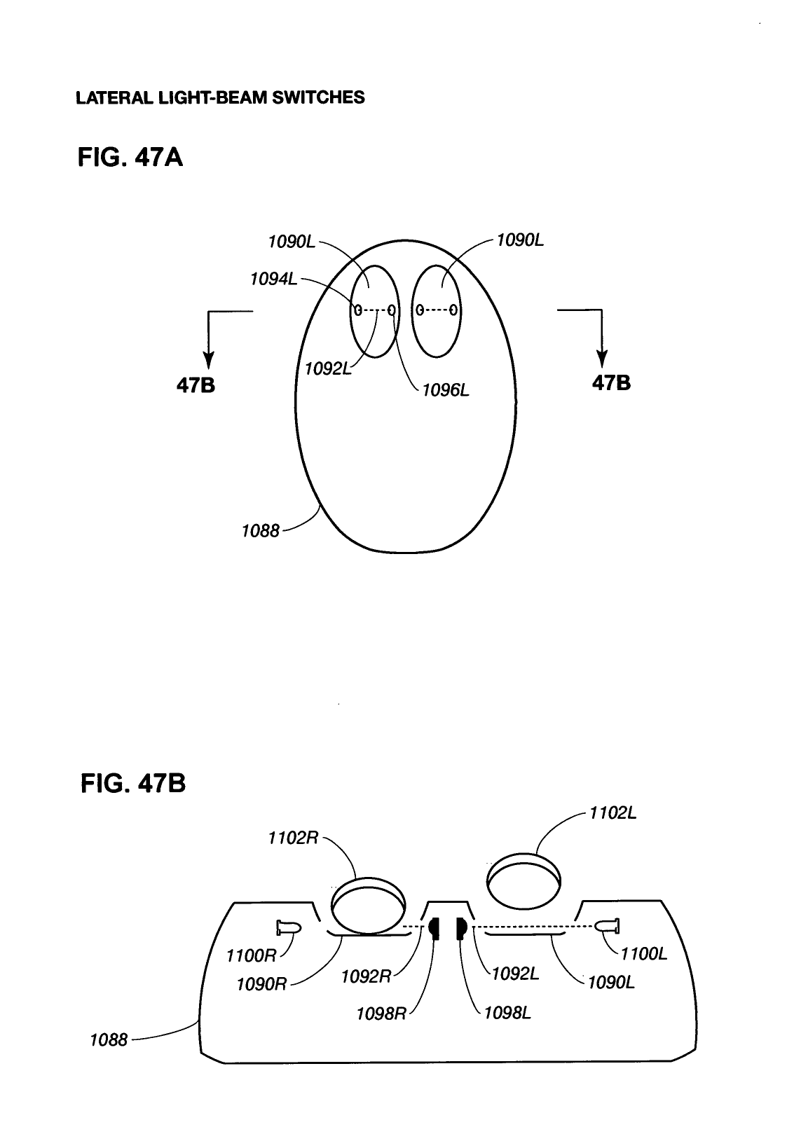

FIG. 47A is a top view, and FIG. 47B is a front view cross-section, of a lateral light beam-finger lift sensor switch embodiment of the lift-switch of the present invention, where each switch utilizes a LED producing light beams perpendicular to the long axis of the finger, a photosensor, and a fixed touch surface.

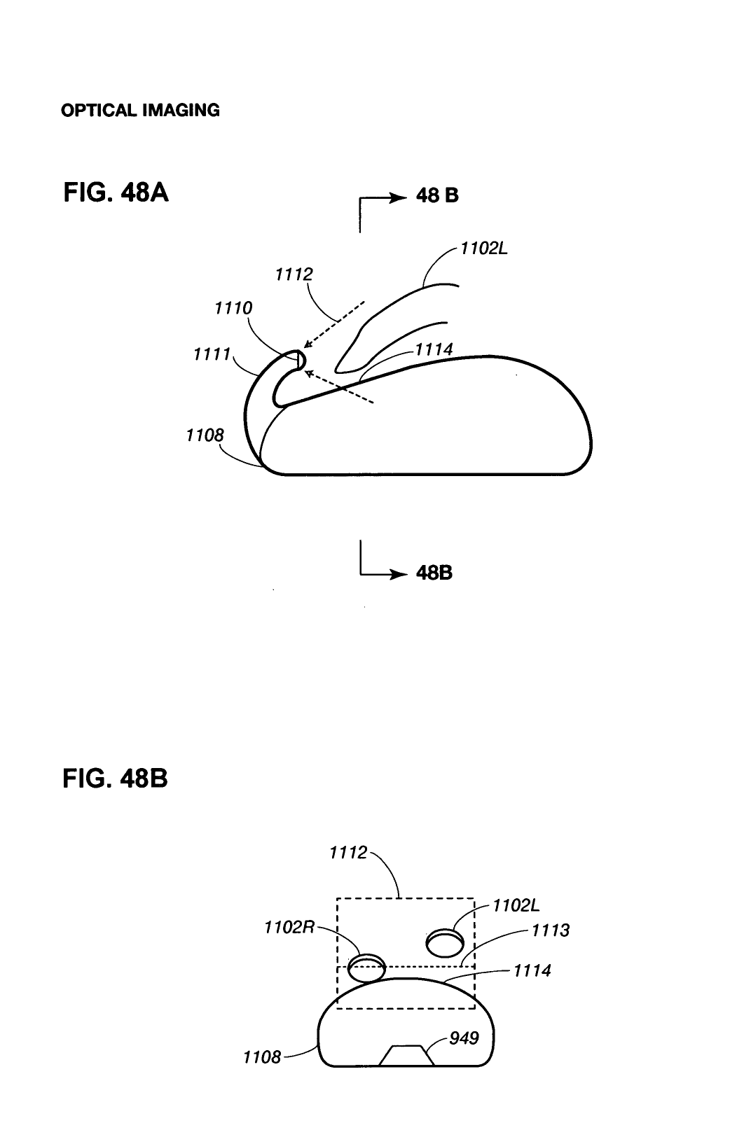

FIG. 48A is a side view, and FIG. 48B is a front view cross-section, of a video imaging finger sensor embodiment of the lift-switch of the present invention.

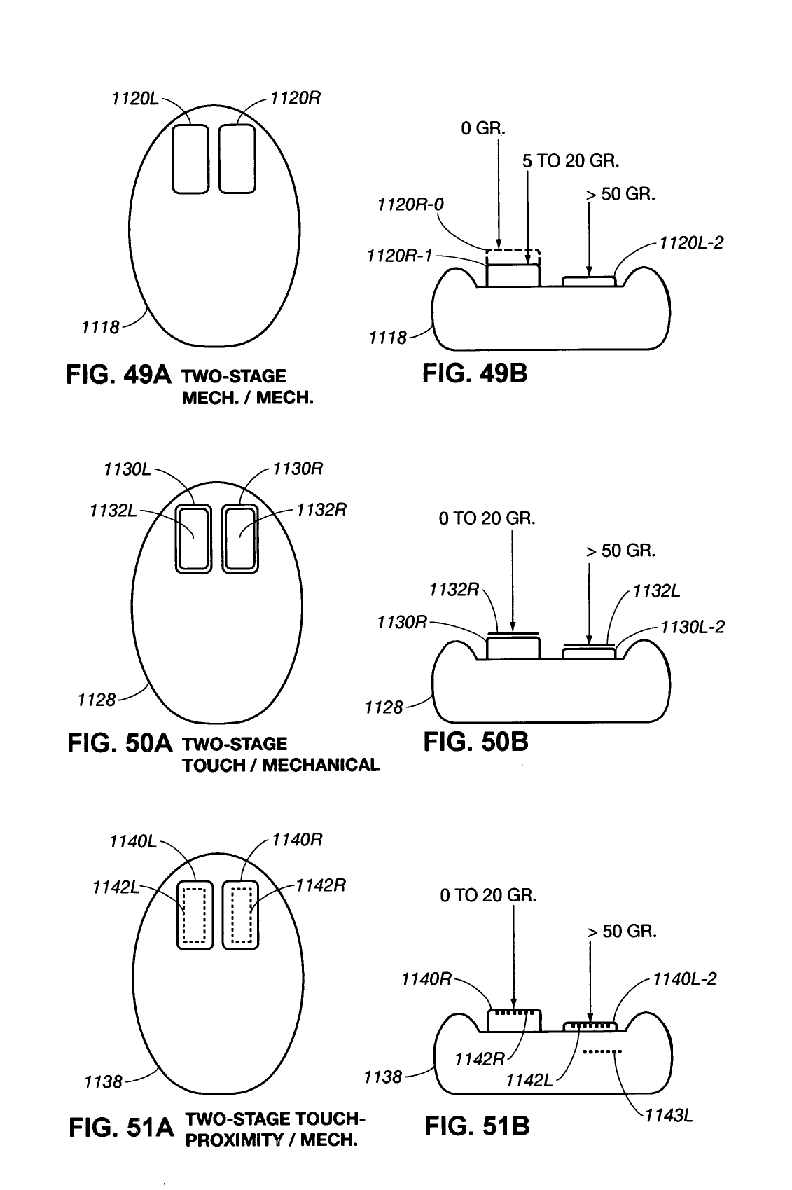

FIGS. 49 THROUGH 58 illustrate two-stage switch mechanisms and chording.

FIG. 49A (top view) and FIG. 49B (front view) introduce two-stage home switches in the form of two-stage/two-step depression mechanical switches, with the first stage being a very low-force small displacement lift-switch, and the second stage a standard depression switch similar to prior art depression-type electromechanical click switches.

FIG. 50A and FIG. 50B illustrate touch membrane/mechanical two-stage switches with a resistive or capacitative light touch membrane switch as the first stage, layered on top of a mechanical second stage switch.

FIG. 51A and FIG. 51B illustrate proximity-touch sensor/mechanical two-stage switches with a sensor inside the pointing device as the first stage.

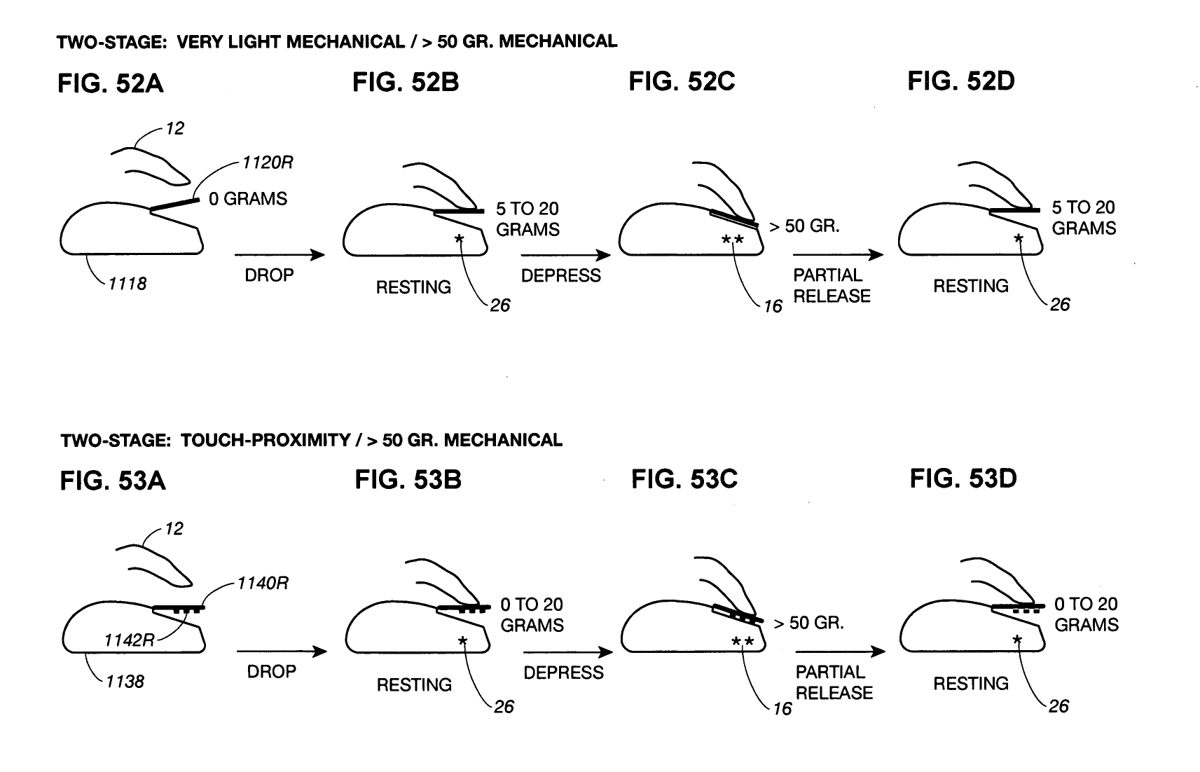

FIGS. 52A through 52D are a sequence of images in time portraying the left-hand operation of a light mechanical/heavy mechanical two-stage switch of the type shown in FIGS. 49A and 49B.

FIGS. 53A through 53D are a sequence of images in time portraying the left-hand operation of a light touch/heavy mechanical two-stage switch with a fixed first stage of the touch-proximity type as shown in FIGS. 51A and 51B.

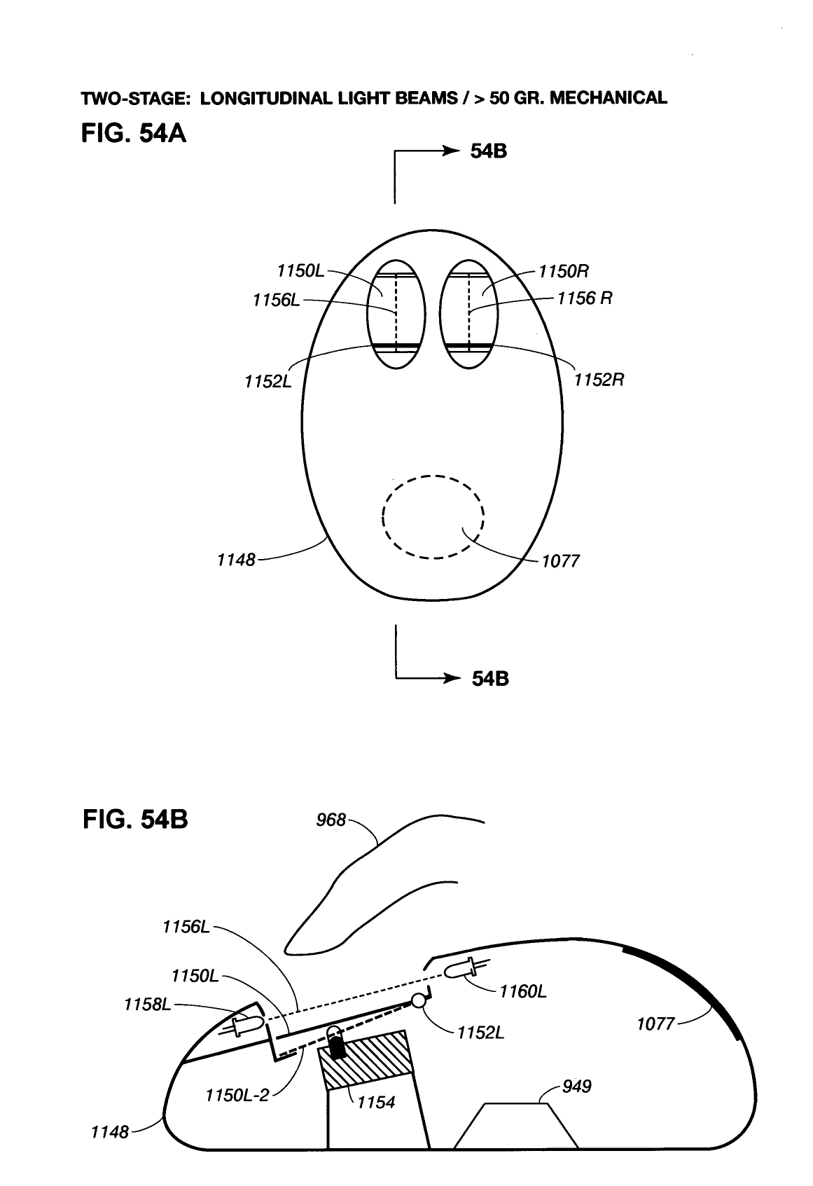

FIG. 54A (top view) and FIG. 54B (side view cross-section) illustrate optical sensor/mechanical two-stage switches with a longitudinal optical beam sensor as the first stage and an internal microswitch as the second stage.

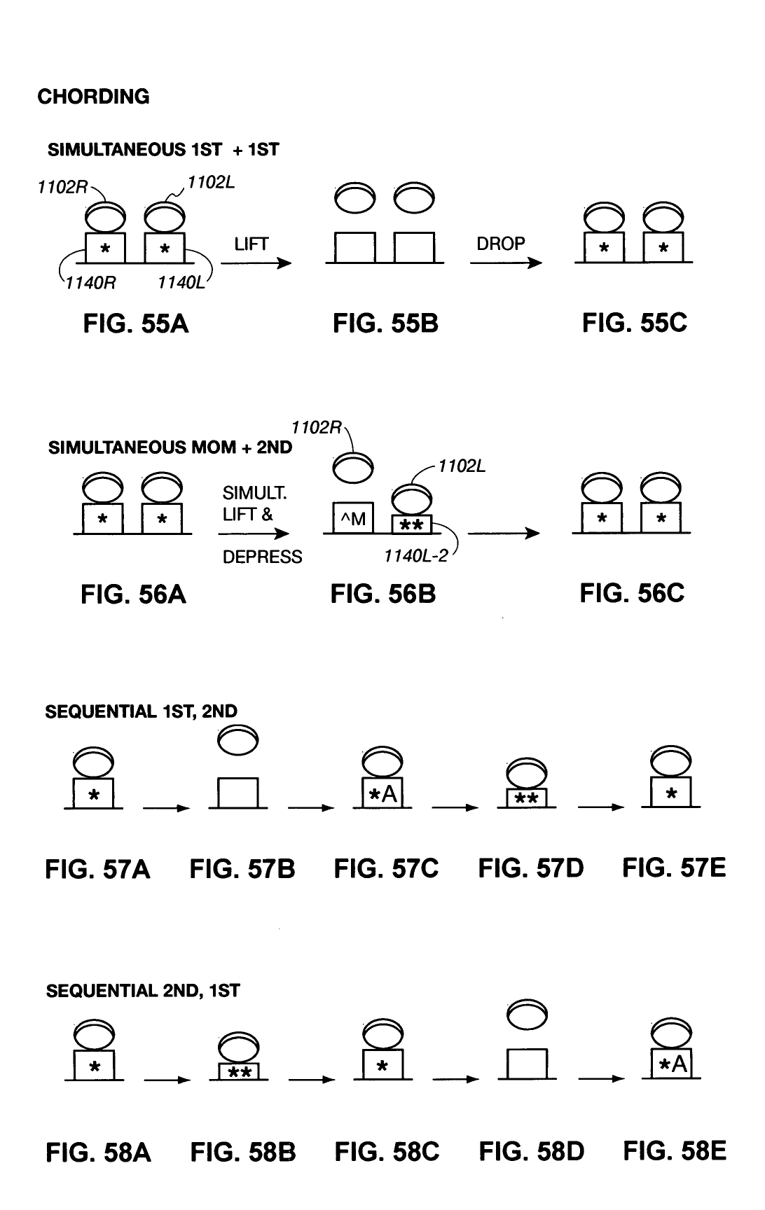

FIGS. 55A through 55C are a time sequence of front view images that show “simultaneous” same direction chording of two adjacent lift-type single stage lift switches (or the first stages of two-stage switches) to trigger additional functions, where the single stage or the first stage is a fixed touch surface actuated by proximity or contact.

FIGS. 56A through 56C are a time sequence of images that show “simultaneous” lift/depress opposite direction chording of the first stages of two adjacent two-stage switches where the first stage is a fixed touch surface actuated by proximity or contact.

FIGS. 57A through 57E are a time sequence of images that show the sequential chording of the two stages within the same two-stage switch, with the first stage being of the lift type, and demonstrates the lift type being actuated first and the full depression stage second.

FIGS. 58A through 58E are a time sequence of images that show the sequential chording of the two stages within the same two-stage switch, with the first stage being of the lift type, and demonstrates the full depression stage being actuated first and the lift type second, which is a reversal of the sequence of FIGS. 57A through 57E.

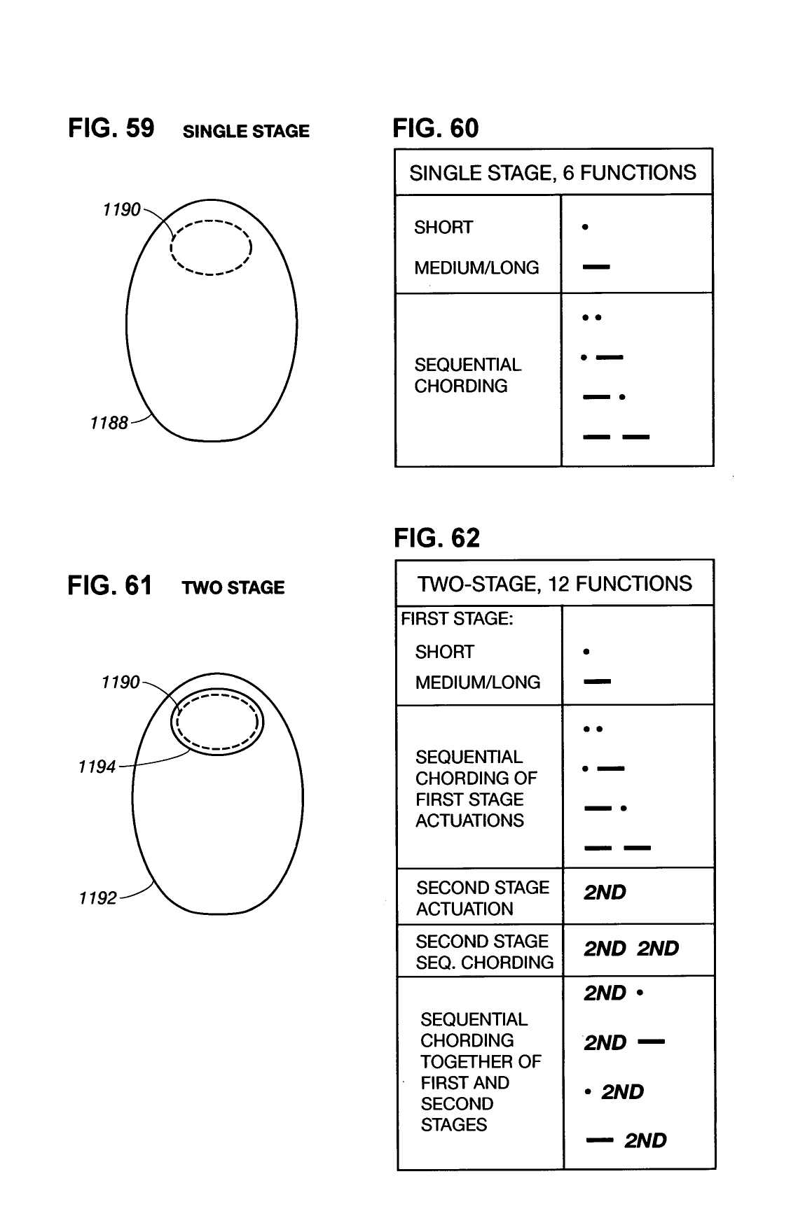

FIGS. 59 THROUGH 75 show horizontal mouse apparatus embodiments with examples of function assignments.

FIG. 59 shows a top view of the simplest embodiment of the lift switch of the present invention, one single-stage (fixed or small depression) lift switch on a pointing device.

FIG. 60 shows how six different functions may be triggered by the use of the one single-stage lift switch of FIG. 59.

FIG. 61 shows a top view of an additional embodiment of the lift switch of the present invention, a single two-stage lift switch on a pointing device.

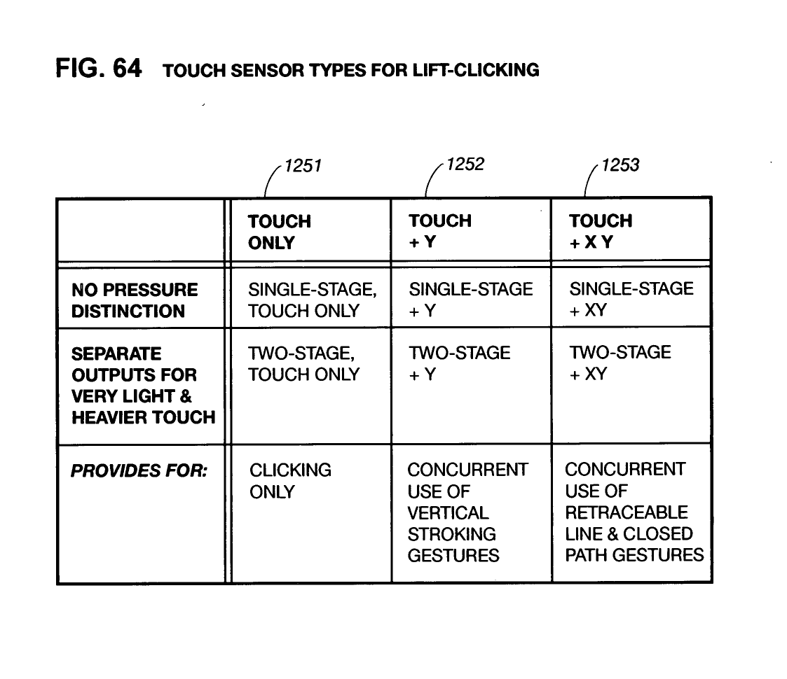

FIG. 62 shows how twelve different functions may be triggered by the use of the one two-stage lift switch of FIG. 64.

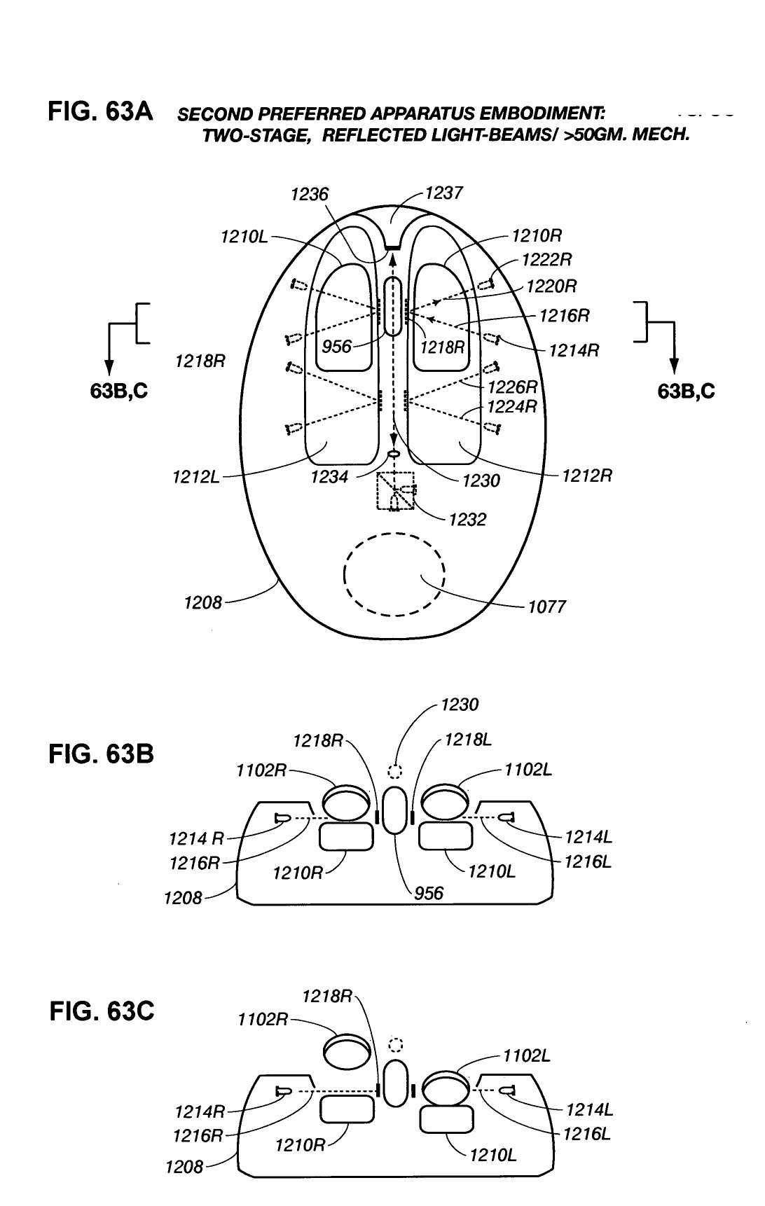

FIGS. 63A through 63C illustrate a second preferred apparatus embodiment: a horizontal mouse with left and right two-stage lift switches, with the first stage and the rear momentary switches being optical beam switches, and including an optical beam sensor of finger presence at the scroll wheel, and prior art type depression switches as the second stage.

FIG. 64 is a table listing touch sensor types for lift-clicking, including those that allow for concurrent gesturing.

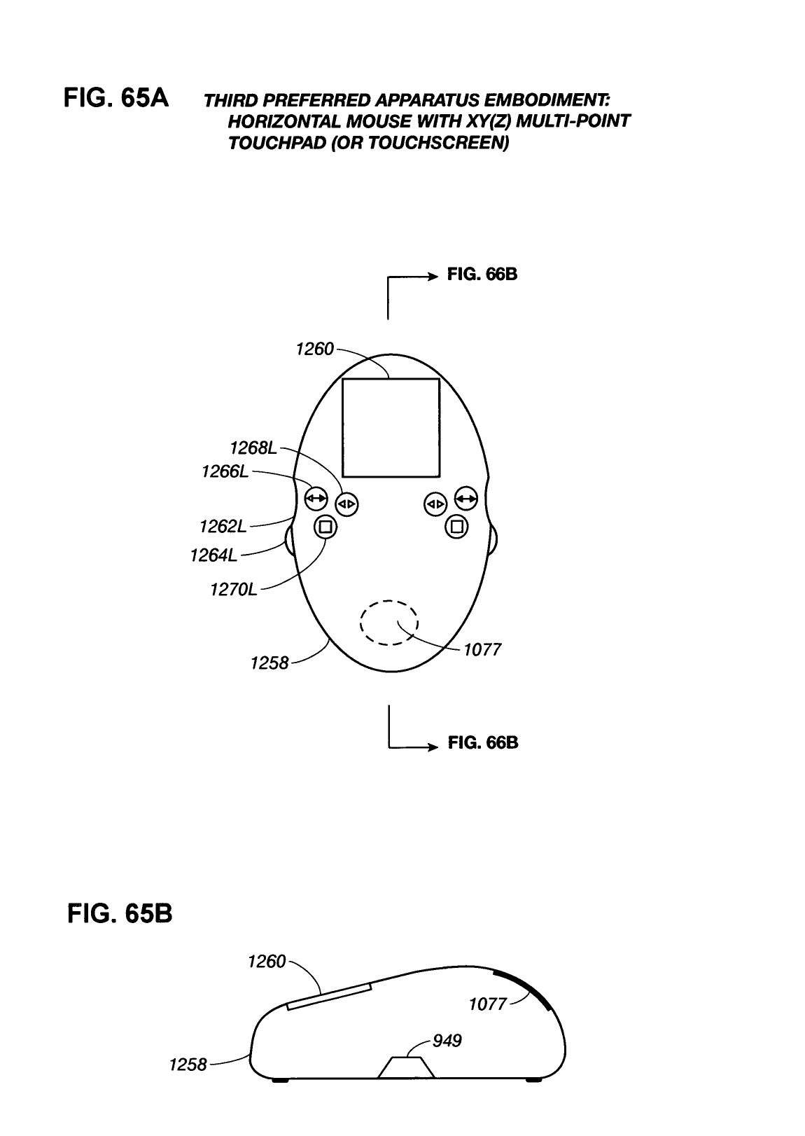

FIGS. 65A and 65B show a third preferred apparatus embodiment: a horizontal mouse with an XY(Z) multi-point touchpad or touchscreen as the clicking surface in place of mouse buttons, providing lift-click modes and a variety of other states including arrow keys, page navigation, and panning.

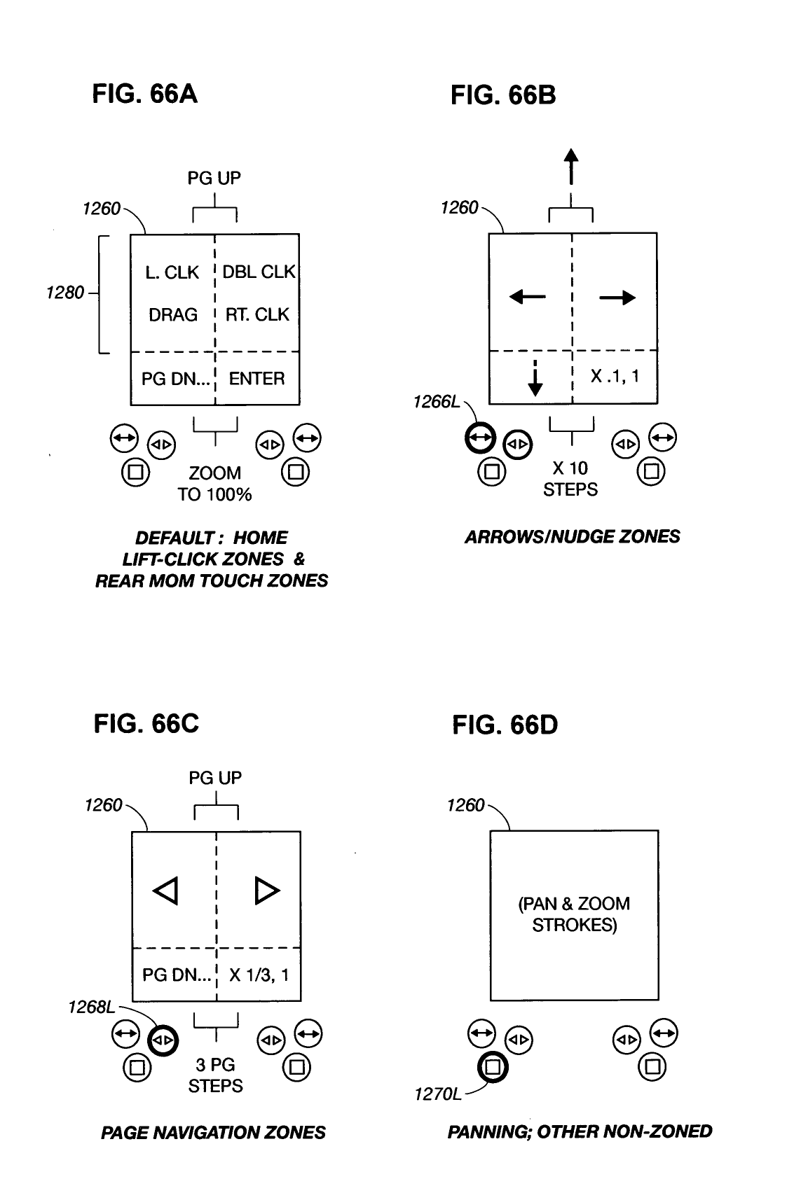

FIGS. 66A through 66D illustrate function assignment labels for four different states of the embodiment of FIG. 65.

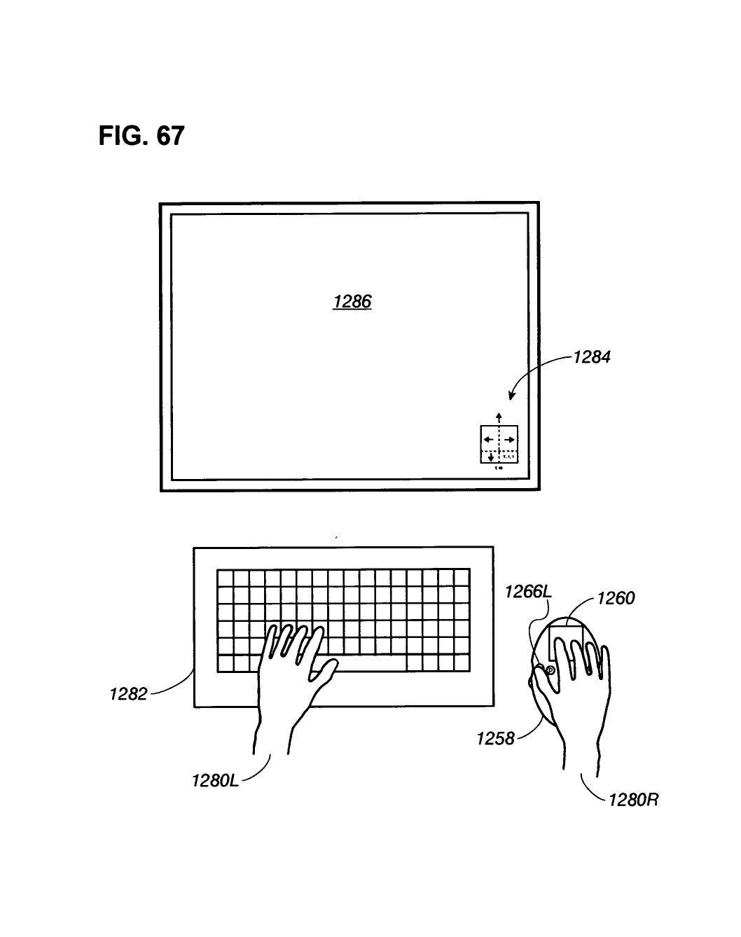

FIG. 67 illustrates an optional on-screen floating window displaying the function assignments of the current state of the embodiment of FIG. 65.

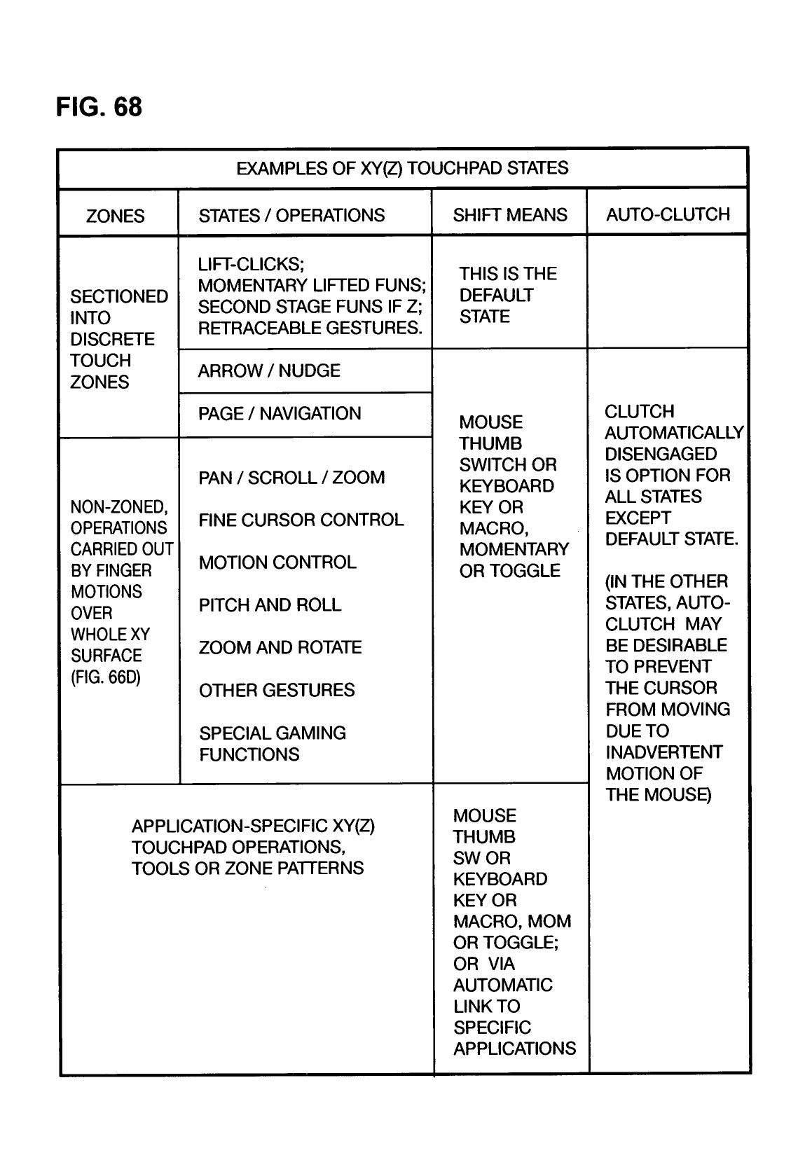

FIG. 68 is a table showing examples of XY(Z) touchpad states for the embodiment of FIG. 65.

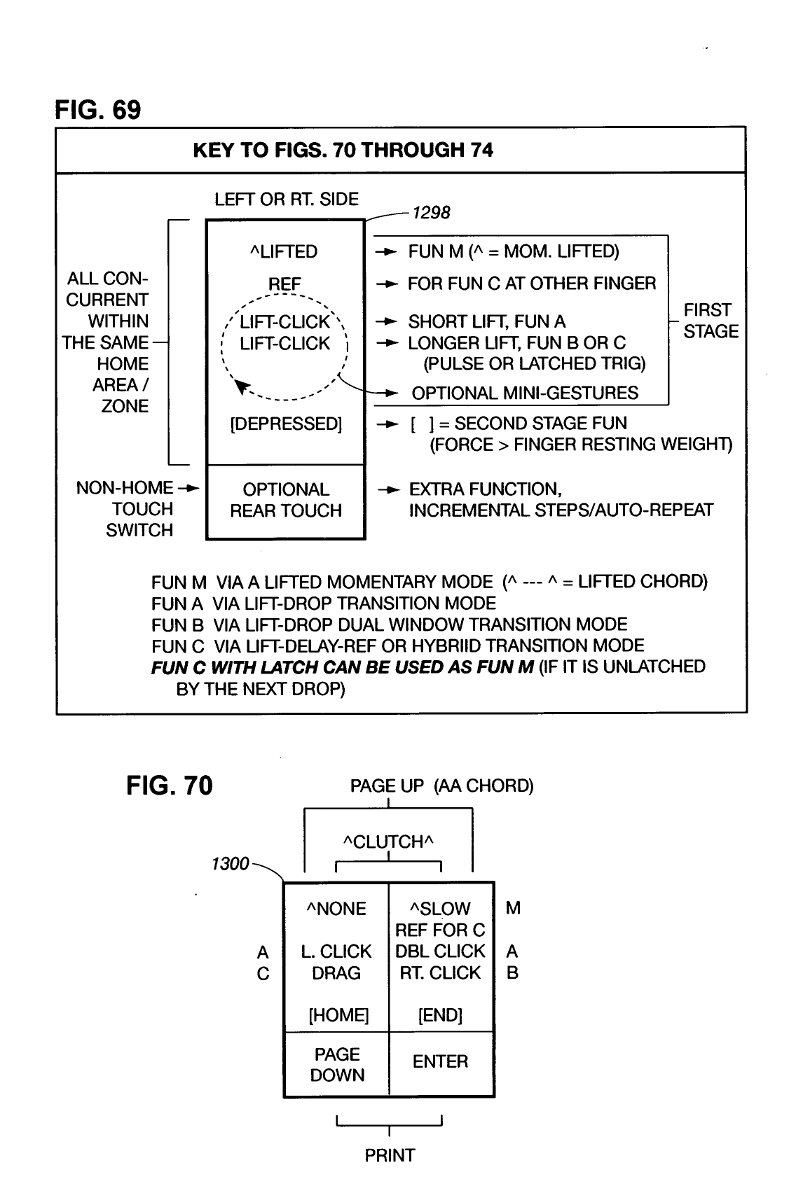

FIG. 69 is a chart that can apply to all two-stage embodiments of this invention, explaining the switch zones, mode and function designations, and in particular serves as a Key to FIGS. 70 through 74.

FIG. 70 is a diagram of one example of possible mode and function assignments for an embodiment with left and right two-stage lift-click switches.

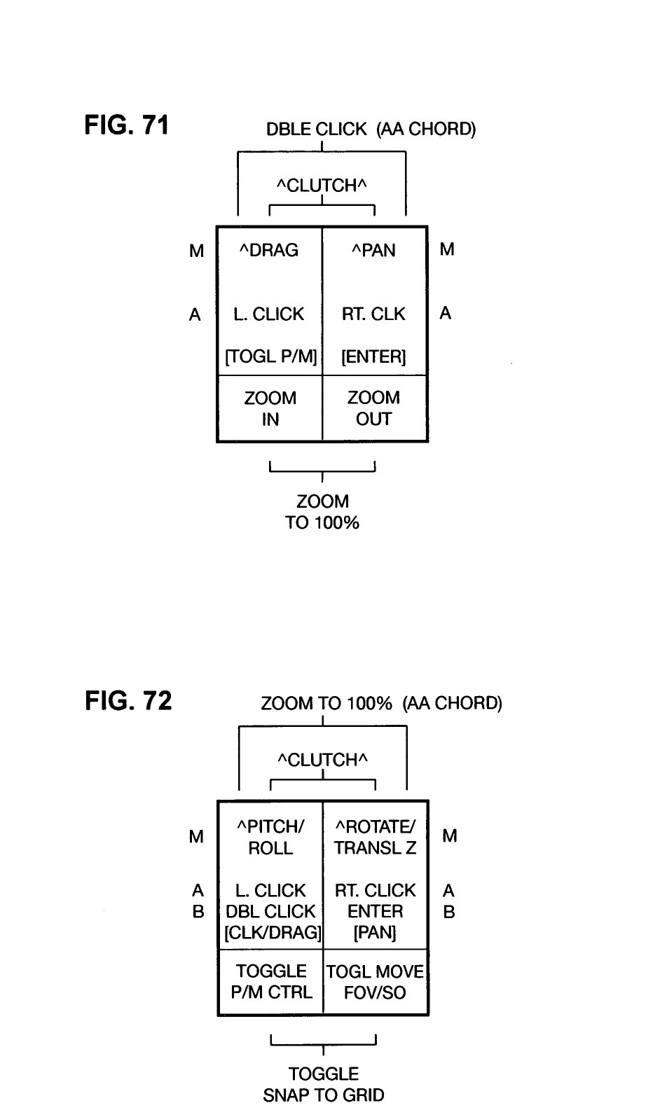

FIG. 71 is a diagram of another example of possible mode and function assignments for an embodiment with left and right two-stage lift-click switches, where the left depression switch functions to toggle the momentary lifted panning function (pan with mouse motion) alternately between P (Position control) and M (motion control).

FIG. 72 is a diagram of another example of possible mode and function assignments for an embodiment with left and right two-stage lift-click switches, which provides six degree of freedom control divided into three controls, and includes a rear momentary switch toggling between move FOV (Field Of View) and move SO (Selected Object).

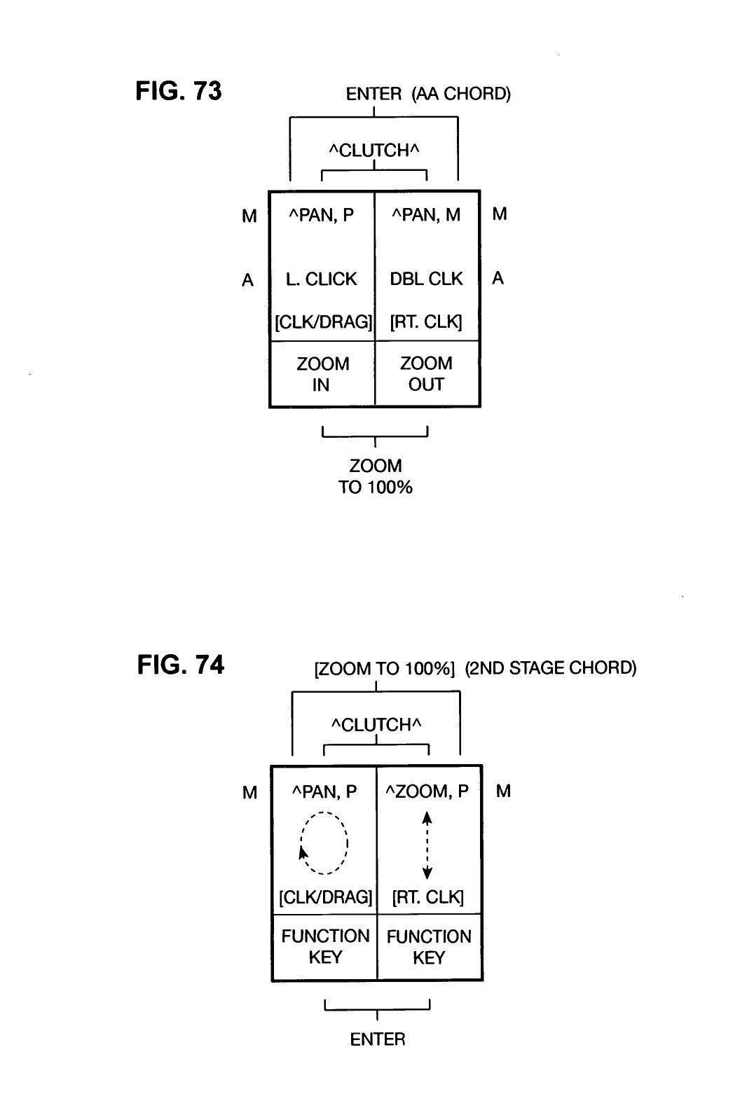

FIG. 73 is a diagram of another example of possible mode and function assignments for an embodiment with left and right two-stage lift-click switches, where the right and left lifted modes provide a choice of Position control panning, or Motion control panning.

FIG. 74 is a diagram of an additional example of possible mode and function assignments for an embodiment with left and right two-stage lift-click switches, where the only home zone lift-click mode used is momentary lifted, and the depression switches are used in the conventional prior art manner.

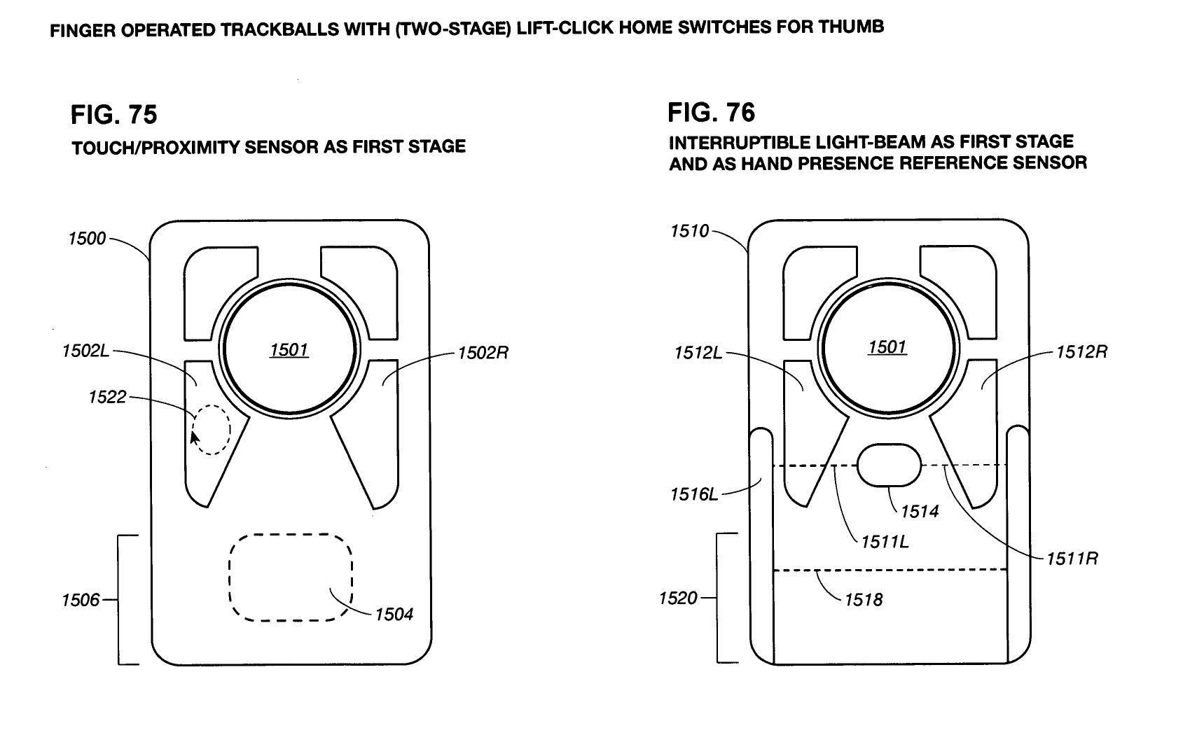

FIGS. 75 THROUGH 82 show the embodiment of the lift-click method into a variety of additional types of pointing devices.

FIG. 75 is a top view of a finger operated trackball with lift-click switches for use by the thumb.

FIG. 76 is a top view of a finger operated trackball with one interruptible light-beam as a first stage lift-click sensor for use by the thumb, and another as a hand presence reference sensor.

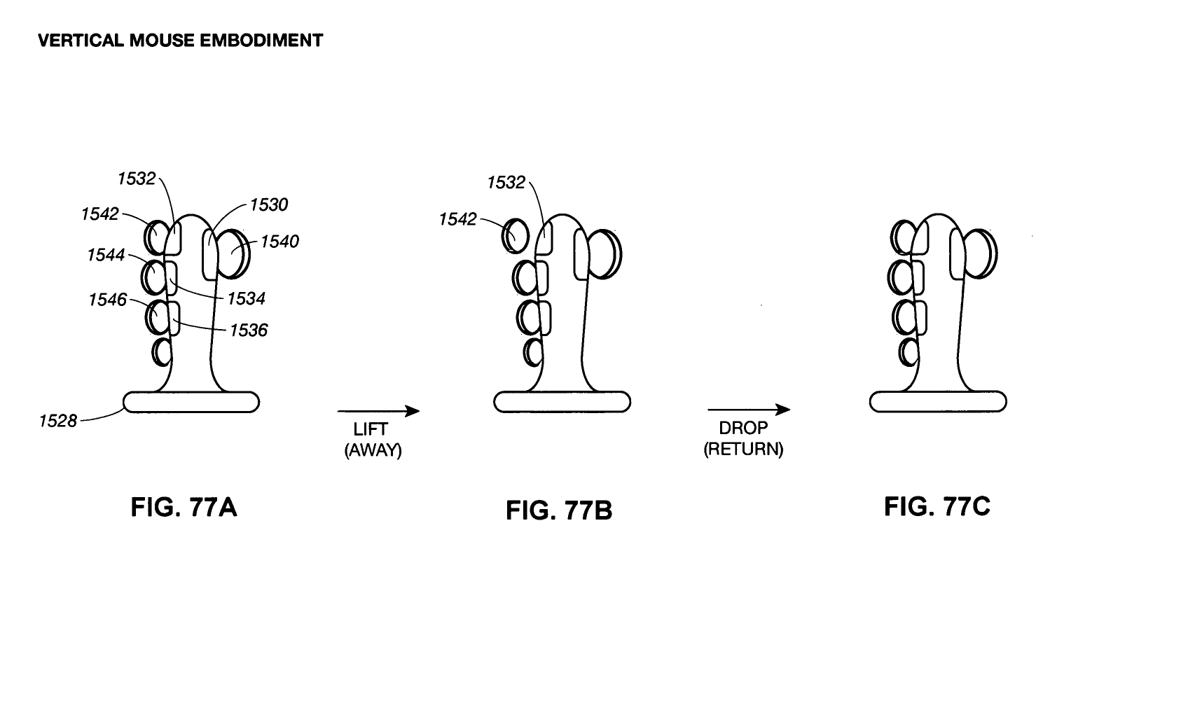

FIGS. 77A, 77B and 77C are sequential images in time illustrating a front view of a vertical mouse type of embodiment of the lift methods of the present invention. Multiple lift switches and/or reference finger reference sensors are shown.

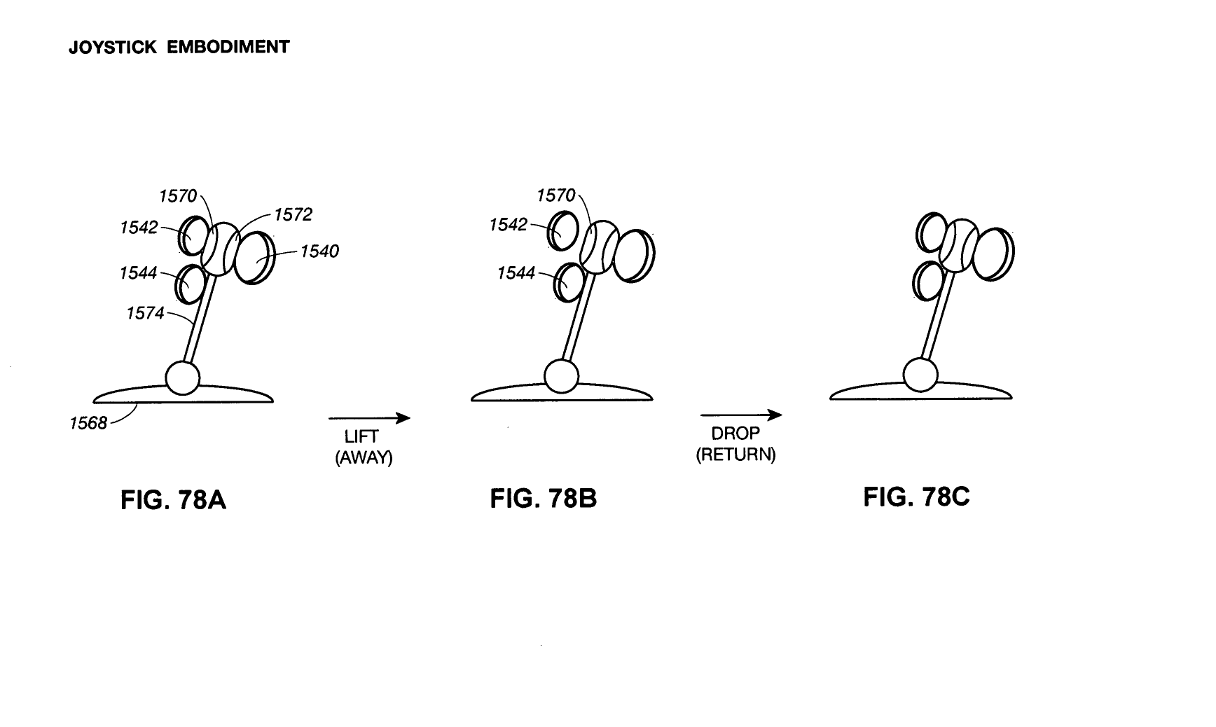

FIGS. 78A, 78B and 78C are sequential images in time showing a front view of a joystick type of embodiment of the lift switch methods of the present invention, and demonstrate its use.

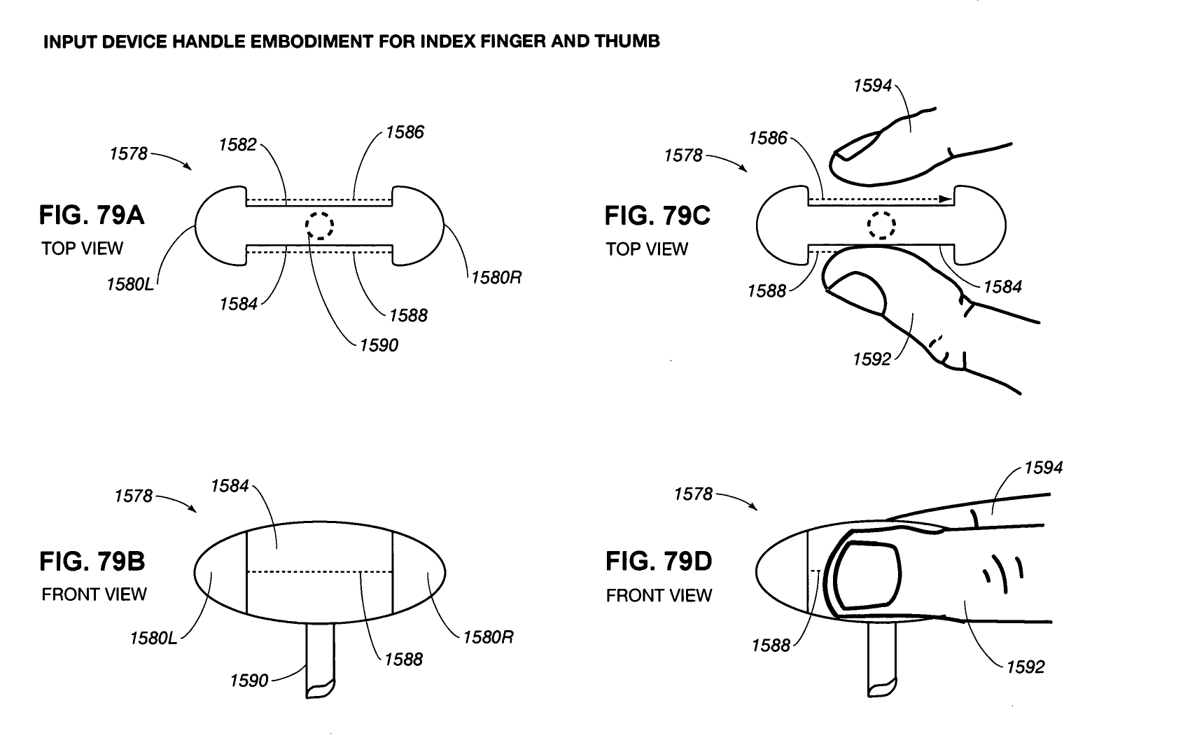

FIGS. 79A through 79D illustrate a computer input device handle embodiment of the lift methods of the present invention for fingertip use, with one or two interruptible light-beam home switches.

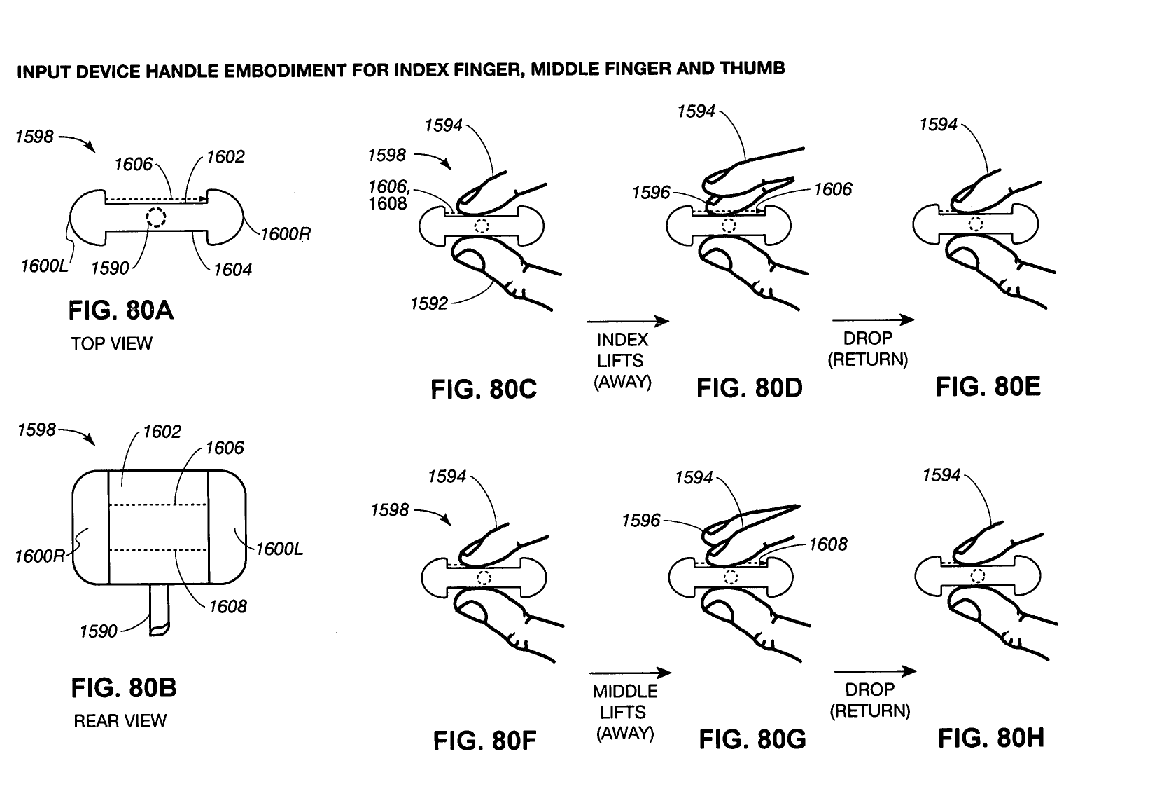

FIGS. 80A through 80H show a computer input device handle embodiment of the lift methods of the present invention for fingertip use, with two or three interruptible light-beam home switches.

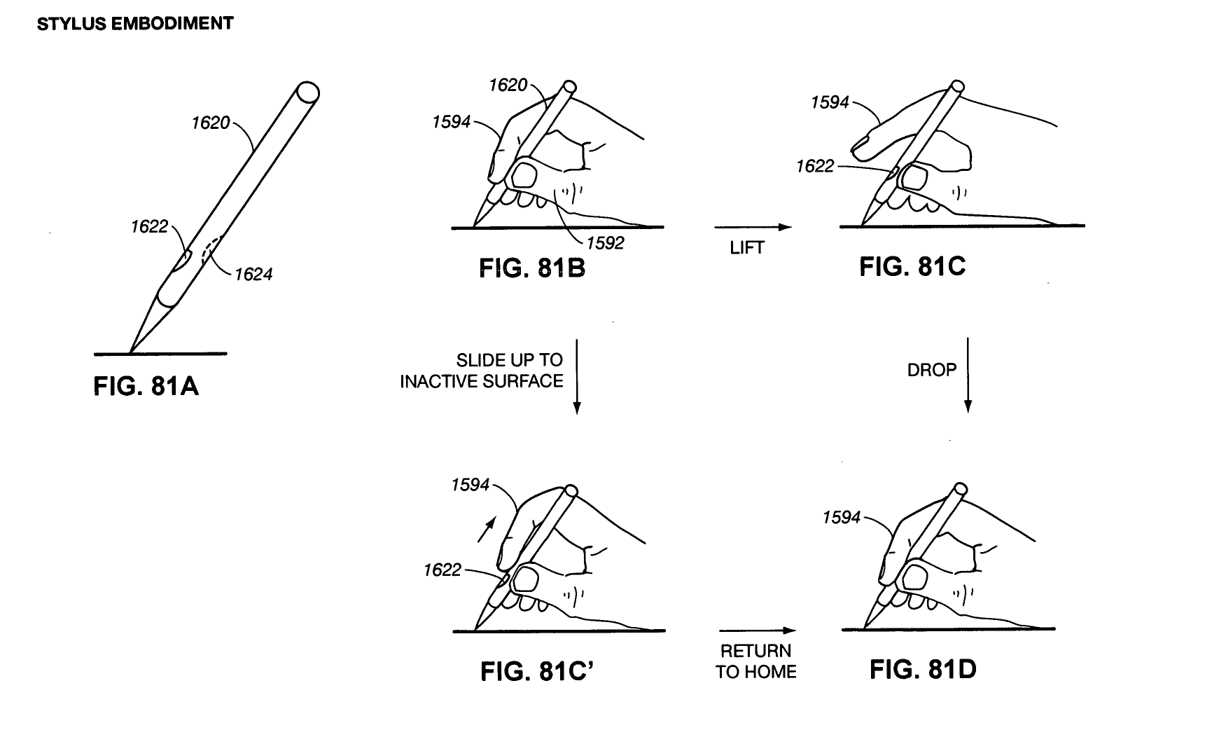

FIGS. 81A through 81D illustrates a pen or stylus embodiment of the lift methods of the present invention, having a top touch switch and an optional bottom touch switch.

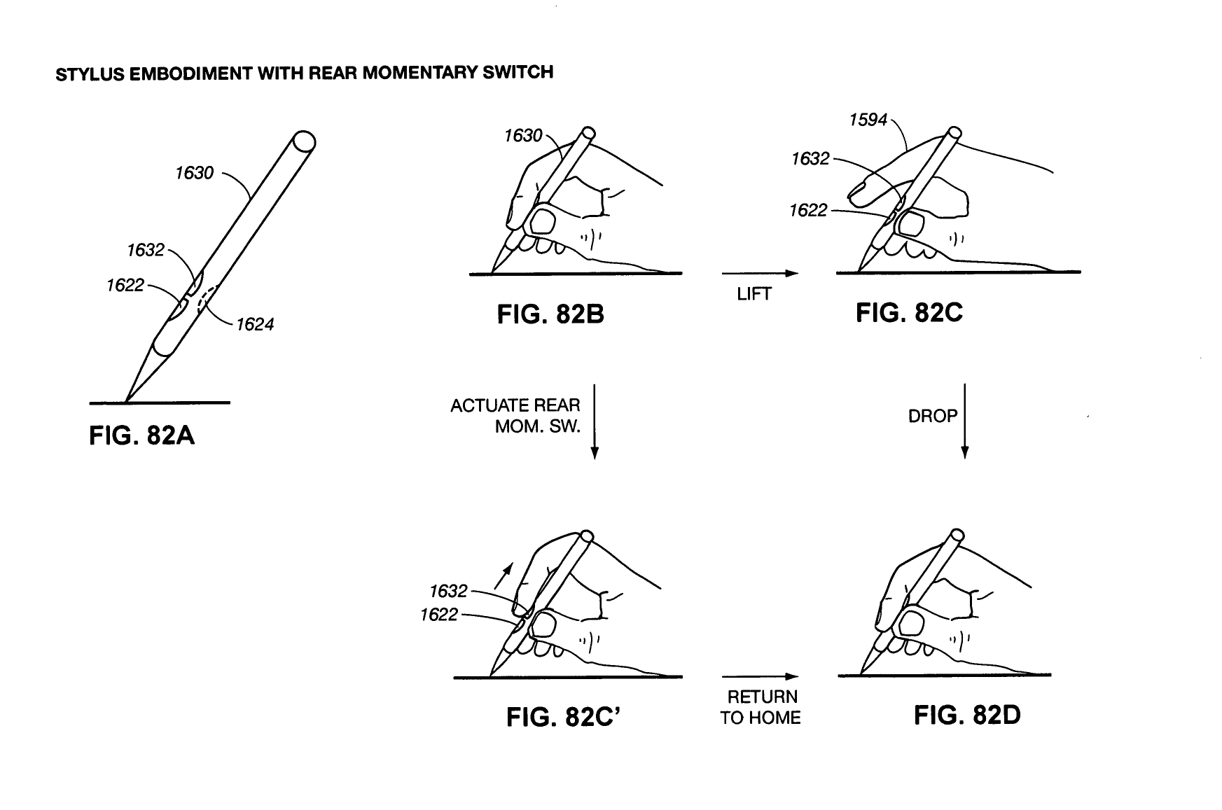

FIGS. 82A through 82D illustrate a different pen or stylus embodiment of the lift methods of the present invention, having two top touch switches and an optional bottom touch switch.

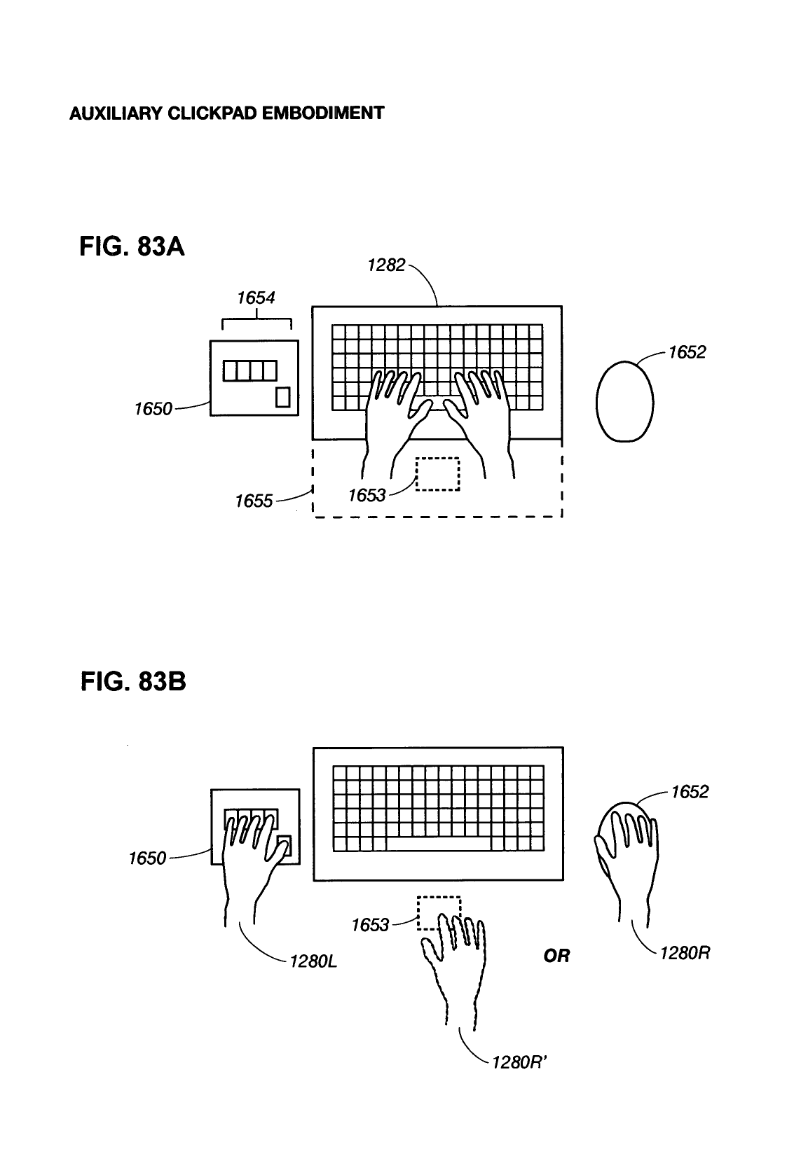

FIGS. 83 THROUGH 96 illustrate the lift-click method embodied into auxiliary keypads and keyboards.

FIGS. 83A and 83B are top views of an auxiliary clickpad, a keyboard and a mouse showing an example of the use of lift-type light touch home switches (single or two-stage) on a clickpad.

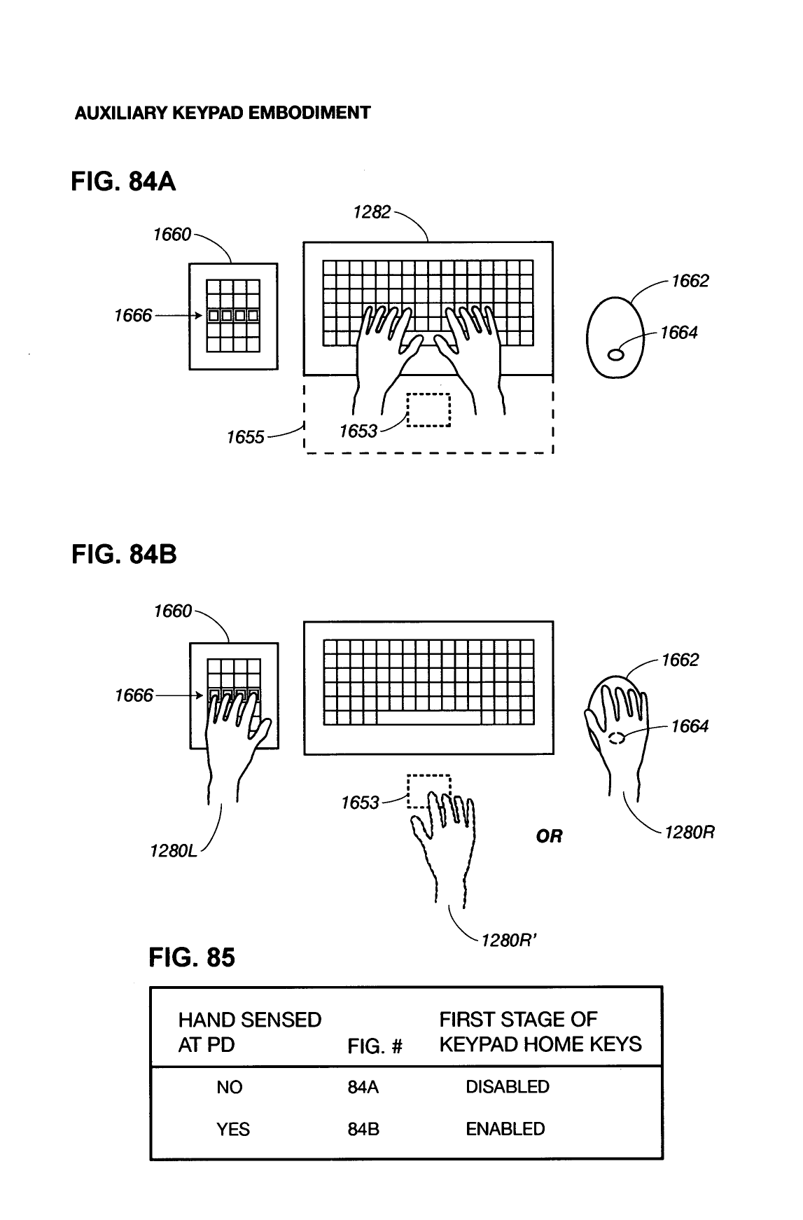

FIGS. 84A and 84B are top views of an auxiliary/numeric keypad, a keyboard, and a mouse having a hand-location sensor, and is an example of the use of two-stage home switches on a keypad external to the pointing device and keyboard.

FIG. 85 is a truth table showing the effect of hand location, via the hand sensor at the pointing device as shown in FIGS. 84A and 84B, on the enabling and disabling of keypad home key two-stage lift switches.

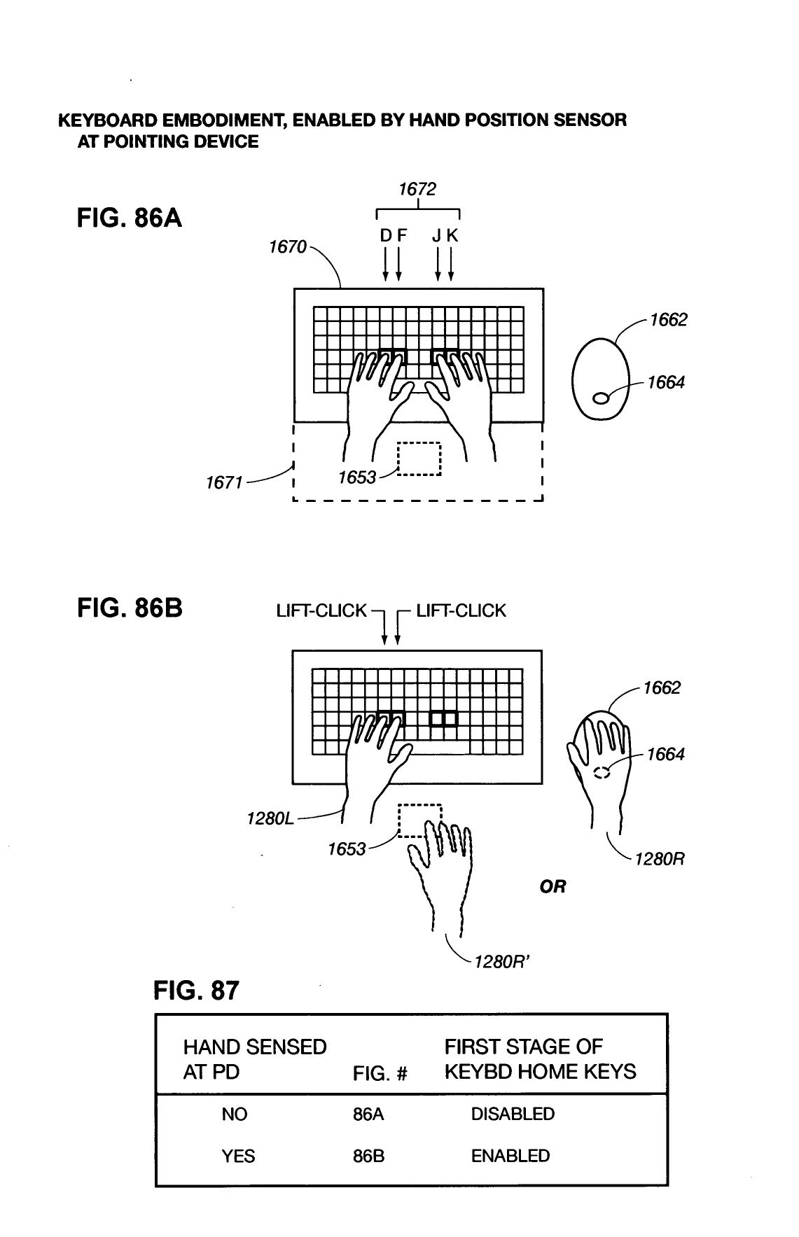

FIGS. 86A and 86B are top views illustrating the operation of a keyboard with two-stage light touch lift switches in the D, F, J and K home key positions, used with either a pointing device having a hand-location sensor, and/or with a trackpad (which inherently acts as a hand location-sensor while being touched).

FIG. 87 is a truth table showing the effect of hand location, via the hand sensor at the pointing device as shown in FIGS. 86A and 86B, on the enabling and disabling of keyboard home key two-stage lift switches.

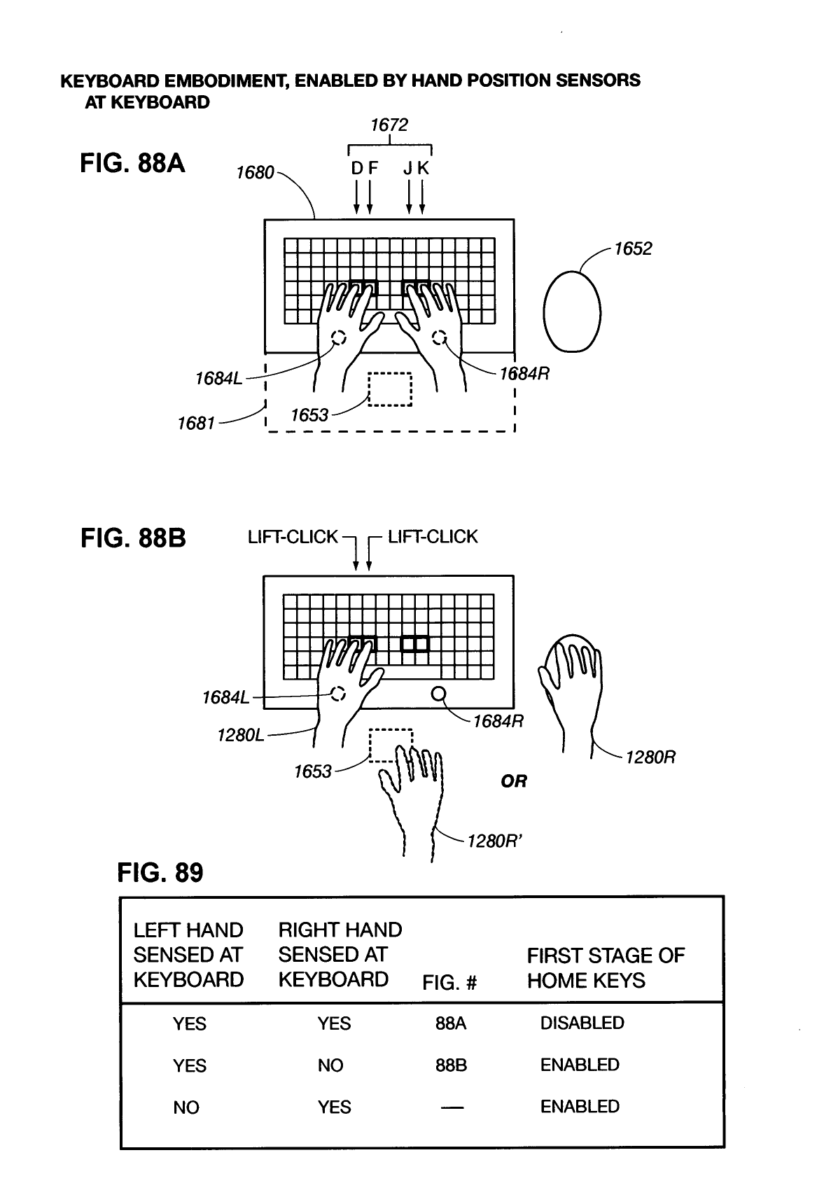

FIGS. 88A and 88B are top views illustrating the operation of a keyboard with two-stage light touch lift switches in the D, F, J and K home key positions, and with the keyboard having left and right hand-location sensors.

FIG. 89 is a truth table showing the effect of hand location, via the keyboard hand sensors shown in FIGS. 88A and 88B, on the enabling and disabling of keyboard home key two-stage lift switches.

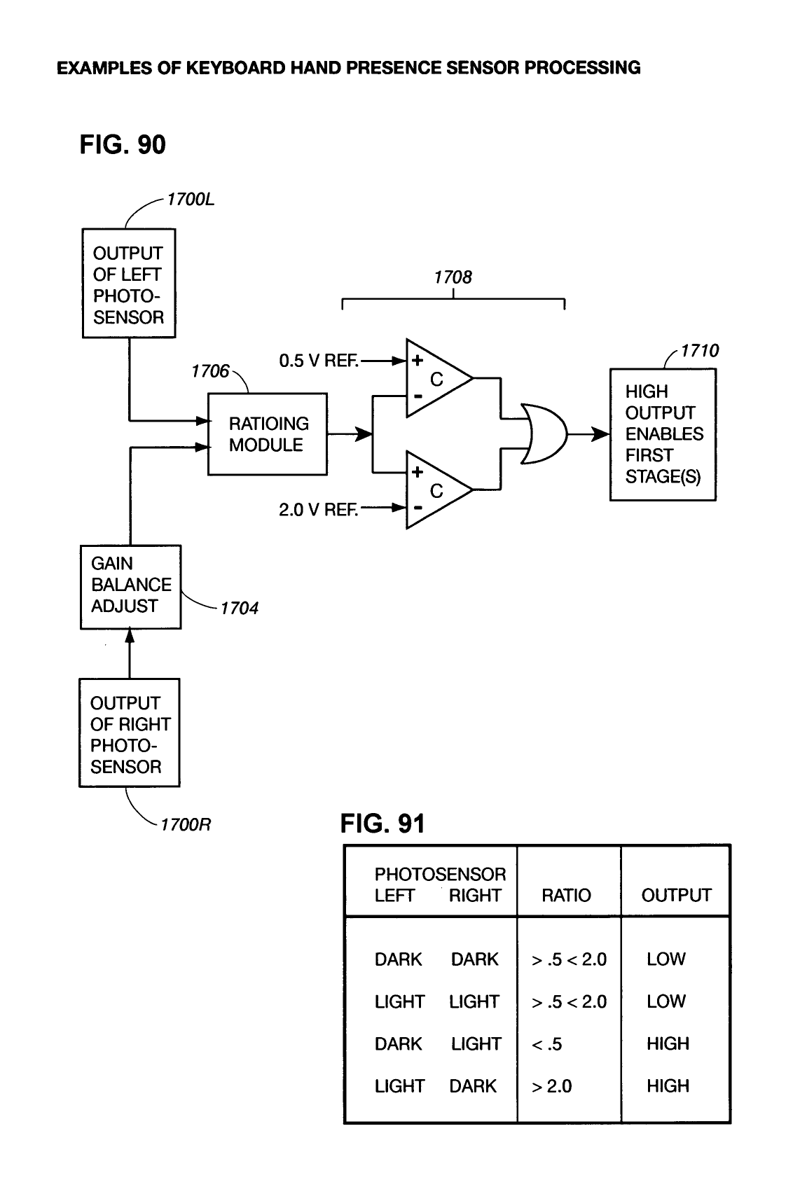

FIG. 90 is an example of an electronic schematic showing one possible implementation of the truth table of FIG. 89, using keyboard ambient-light hand location sensors to enable keyboard first stage switches only when one hand is absent from the keyboard.

FIG. 91 is a table demonstrating how the schematic diagram of FIG. 90 implements the truth table of FIG. 89 to convert hand position into a disabling or enabling of the first stage of home keys.

FIGS. 92A, 92B and 92C are sequential images in time that show the operation of a two-stage keyboard keyswitch, with the first stage actuated by a slight depression, and the second stage actuated in a manner similar to a standard depression keyswitch.

FIG. 93 shows a keycap for a touch/mechanical type of two-stage keyswitch with a membrane on top as a first stage on top of a second stage keyswitch similar to the second stage shown in FIG. 92C.

FIG. 94 shows a keycap with a proximity sensor underneath its top surface that could be used as a first stage on top of a second stage keyswitch similar to the second stage shown in FIG. 92C.

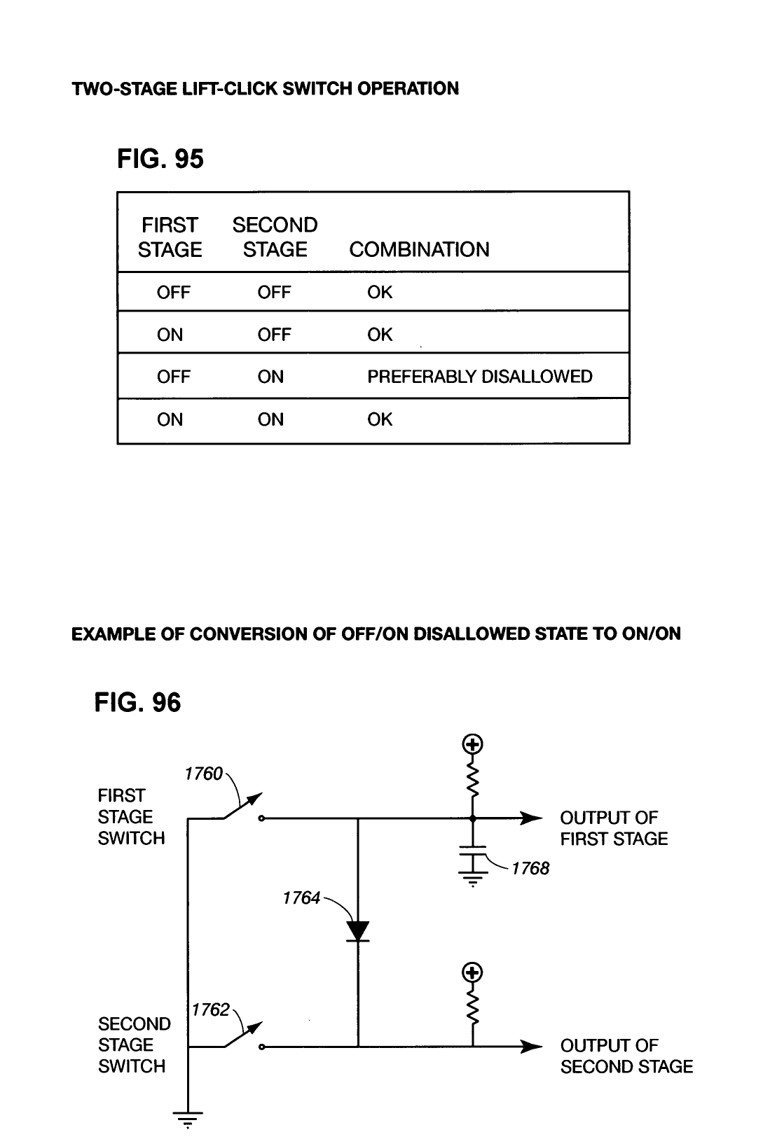

FIG. 95 is a table showing allowable combinations of stage actuations for the switch shown in FIGS. 92A, 92B and 92C.

FIG. 96 is an example of schematic that effectively accomplishes the electronic conversion of an OFF(ON1)(ON2) two-stage momentary switch into a OFF(ON1)(ON1 & 2) type, similar to the switch shown in FIGS. 92A, 92B and 92C.

### DETAILED DESCRIPTION OF THE DRAWINGS

FIGS. 1 THROUGH 32 describe the operation of the lift-click method by means of sequential illustrations, flow charts, circuit block diagrams and timing diagrams that detail the operation, logic and characteristics of the lift-click modes. Note that FIGS. 1 through 4 show left hand operation (in order to use left to right sequential illustration).

FIGS. 1A through 1C are a time sequence of side view images that show the use of a prior art mouse button home switch on a traditional horizontal mouse. FIG. 1A shows horizontal mouse 10 with finger 12 resting on (and not actuating) standard prior art mouse button 14. FIG. 1B shows the finger depressing/holding the switch down (with a force greater than the weight of the resting finger), with the double asterisk 16 indicating actuation of the switch and triggering of the assigned click or drag. FIG. 1C is identical to FIG. 1A, and shows the resting state again after the finger has released the switch. The actuation threshold of a standard type of depressible mechanical mouse button usually exceeds 50 grams.

FIGS. 2A through 2C are a time sequence of side view images that diagram the use of the LIFT-DROP MODE of the present invention on a horizontal mouse 20 having a lift-click type of home sensor 24 whose touch surface is relatively fixed/non-depressible. This mouse button is an optical, proximity, or touch sensor/switch whose actuation threshold (zero to ten grams) is less than the weight of the relaxed resting finger. The * (single asterisk) 26 denotes actuation. Actuation of a lift type of switch does not necessarily include triggering its assigned function, but simply means momentarily holding closed a normally open switch, or momentarily holding open a normally closed switch. The moment within this sequence at which the function is triggered depends on the lift mode and the timing. In lift-drop mode the click function is triggered by the drop, if the drop occurs within a window of time initiated by the lift. In FIG. 2A the finger is shown resting passively on the mouse, holding home switch 24 actuated, as shown by the presence of the asterisk. In FIG. 2B the finger has lifted away from the switch, deactuating it (no asterisk). At the top of the lift (FIG. 2B), finger contact with the switch surface is shown as broken.

FIG. 2C shows the finger having returned to resting position, actuating the switch as indicated by asterisk 26, at which time the click (or other assigned function) is triggered if the return has occurred within the window.

FIGS. 3A through 3C are a time sequence of side view images that show the use of the lift-delay-reference mode, sometimes simply called LIFT-DELAY MODE, of the present invention on mouse 30 having home sensor 24 whose touch surface is relatively fixed/non-movable and with an actuation threshold that is less than the weight of the resting finger. The single asterisk 26 denotes the actuation of switch 24, and single asterisk 26′ denotes the actuation of the hand presence reference sensor 32 (by the palm or a different finger, not shown in these Figures). The lift-delay click or drag function is triggered by the lift or by the end of a delay initiated by the lift, provided that reference sensor 32 is actuated. FIG. 3A shows the relaxed finger 12 resting on fixed touch surface of home switch 24 and passively actuating (asterisk 26) the switch simply by its presence or by its resting weight. When the finger is lifted out of contact with the surface, deactuation occurs, and FIG. 3B is the result, which initiates a delay of between zero and 0.4 seconds. At the end of this delay the click or drag is triggered provided that reference sensor 32 is indicating hand presence at this time. With a fixed touch surface, depending on the type of finger presence sensor associated with the touch surface and the resilience of the surface, the finger could possibly provide deactuation by a very slight lift without actually breaking contact with the surface; but usually the finger would be lifted completely off of the touch surface to provide deactuation. FIG. 3C shows the finger having been allowed to drop back to home switch touch surface 24, reactuating (asterisk 26) the switch, and resulting in the same configuration as the initial resting position shown in FIG. 3A.

FIGS. 4A through 4C are a time sequence of side view images that show the general mechanics of the lift method of the present invention on a mouse 40 having a mouse button 44 with a depressible surface, whose actuation threshold is less than the weight of the relaxed resting finger. The click function is triggered by either a lift-delay or a lift-drop. The initial and final images FIGS. 4A and 4C show the finger 12 relaxed at rest, with switch 44 fully depressed and actuated. FIG. 4A shows the finger 12 relaxed/resting passively on switch 44, depressing it very slightly (in the range of about one millimeter) and actuating it, as indicated by the single asterisk 26. When the finger is lifted, the switch is deactuated. At the top of the lift, contact is either maintained (FIG. 4B) or is broken (FIG. 4B′). Allowing the finger to drop downwards results in the actuated resting position shown in FIG. 4C, which is identical to FIG. 4A. In order to use a switch with contact maintained at the top of the lift as in FIG. 4B, a noticeable tactile event and/or audible click at the switch transition is needed.

Light touch switches are already used in many types of devices, but not as click “home” switches on a pointing device or keyboard, because prior to the lift methods of the present invention, one could not employ a touch switch as a home switch since its function would already be triggered in/by the rest position, and because of the problem of inadvertent triggers during hand arrival and departure. On pointing devices the most frequently used click switches are usually of the home type because they are used so often that one does not want to have to reach with the finger to activate them; one wants the finger to be there initially, already resting at home on them. In prior art the use of a light touch switch would require hovering, a totally unsatisfactory method for a home switch.

THE FIVE MODES OF THE METHOD OF THE PRESENT INVENTION are as follows (for overall summary tables see FIGS. 31 and 32):

1. LIFT-DROP A, FIGS. 2, 5, 6, 7; trigs fun A upon drop within window initiated by the previous lift, no other hand presence ref required. A variation is LIFT-DROP AB, FIGS. 8, 9, 10; drop within win A trigs fun A, drop within win B trigs fun B. The window requirement prevents the drop due to arrival of the hand from causing an inadvertent trigger.
2. LIFT-DELAY-REF C, FIGS. 3 and 22 through 26; triggers function C, (C for Close of window) at close of window/end of delay initiated by lift, provided that ref is present. A special zero delay case is LIFT-REF, FIGS. 19, 20, 21. Both require hand presence ref. The delay-ref requirement prevents the lift due to departure of the hand from causing an inadvertent trigger. (See FIGS. 22 and 23 for types I, II and III.)

### 3. HYBRID AC, combination of lift-drop A and lift-delay-ref C, FIGS. 27, 28, 29, 30. Drop within window/delay trigs fun A (no other ref required); if no drop, end of delay trigs C (ref required). Hybrid ABC is also an option (FIG. 31B).

4. MOMENTARY LIFTED M, FIGS. 13 through 18, FIG. 32; enabled as long as the finger is held lifted, usually triggered/manifested by a second action, such as motion of an XY encoder of a pointing device. Ref and delays optional (see FIG. 32). May be used concurrently with lift-drop modes, and sometimes with lift-delay-ref or hybrid modes.
5. REF-DELAY-DROP, FIGS. 11, 12. Trig on drop, requires ref having been present at least 0.x sec prior to drop, and at drop. Generally not a preferred mode.

All of the above five lift-click modes (except momentary lifted modes) are used to trigger functions either as a brief pulse trigger, or as a latch.

The horizontal mice of FIGS. 1A through 4C carry an XY motion/position encoder in the underside of the body of the mouse that causes the on-screen cursor to track the horizontal translation of the mouse across the desktop in the traditional manner. This encoder can be of any prior art type. For the above Figures, as well as in most of the Figures of this specification, this encoder can be understood to be present in the underside of the pointing device, but it is not always illustrated. Alternatively, many of the embodiments of the present invention shown the Figures could serve, without an XY encoder in their underside, for use as auxiliary mouse button clickpad devices.

FIG. 5 is a flowchart that describes the single window lift-drop (lift-drop A) mode. The first step (50) is a lift of the finger from its home resting position. The lift transition opens a retriggerable time window (52) during whose duration the triggering of a function by a drop is enabled. An optional feature (54) is that the actuation (Y for Yes) of a non-home switch by the same finger whose lift initiated the window, or actuation of or very close approach to a scroll device, immediately and prematurely closes the window (56), and thus appropriately prevents an unintended trigger from being generated by the return home of the finger from its non-home excursion. If no non-home excursion is detected (N for No), and if no drop has occurred (N for No) while the window is open (58), no trigger is produced (60). If no (N) non-home excursion is detected, and the window is still open, a drop (58, Y) during the window triggers function A (62). This trigger can be either a brief pulse (64), or a latched trigger (66). If the trigger is latched, the next lift by the same finger (68) can unlatch function A. Alternatively, instead of the next lift, the next drop by the same finger can be programmed to release the latch. Lifts and drops by the same finger have no other effect while the latch is on.

Each flowchart, block diagram, and timing diagram is a processing path generally for one particular lift-click sensor/switch, actuated by one particular finger. What one finger does on one lift-click sensor usually has no effect on what another finger does on another, except for momentary lifted modes and chording. In most of the block circuit diagrams of this specification, the convention used is that: when a finger is resting on and actuating its home sensor, the sensor output is designated as being logic low; when the hand is present, a dedicated hand presence reference sensor is designated as having a logic high signal output. It is important to NOTICE THE DISTINCTION BETWEEN THE GENERATION OF A TRIGGER PULSE, AND THE TRIGGERING OF A FUNCTION. Usually a trigger pulse does not trigger a function directly. A reference signal, or an open window and/or gate is usually also required. In the case of momentary lifted functions, a second action by the user may be required to manifest the function.

FIG. 6 is an electronic block diagram illustrating the detailed characteristics and use of a finger actuated light touch home switch (70) in single window lift-drop mode (lift-drop triggering). A lift 72, which is a lifting of the finger away from the home switch 70, causes a transition T1 of the switch from actuated [A] to not-actuated [NA], which in turn produces an electronic signal transition represented by up arrow 72 for lift (but which electronically can be either a rising or a falling edge) which triggers the Retriggerable Window Pulse Generator 74, which produces window pulse 76, which typically is between 0.3 and 0.8 seconds wide. A drop causes home switch transition T2, from not-actuated [NA] to [A], which in turn produces an electronic signal transition in the opposite direction from the one produced by the lift and is represented by down arrow 78, which causes the Trigger Pulse Generator 80 to output short pulse 82. A coincidence between the pulse outputs of pulse generators 74 and 80 causes coincidence gate 84 to produce short function-trigger pulse 86, which causes the assigned function A to be triggered (88) at the instant of the finger drop. A drop has no effect on the Retriggerable Window Pulse Generator, and a lift has no effect on the Trigger Pulse Generator.

Note that in the electronic block diagram and timing diagram Figures of this specification, the circuits are designed so that the short output pulse of a Trigger Pulse Generator does not necessarily trigger a function directly, and the actual function-trigger pulse is often the output of a coincidence gate.

Reference number go represents the optional feature (same as 54 of FIG. 5) for automatically canceling the lift (and the effect of the next drop) if any non-home device is actuated or closely approached by the same finger. The cancellation method shown here is a closing of the window via input 92 to a reset input of pulse generator 74, but any other means could be used, such as the blocking of the trigger pulse, etc.). This canceling feature can be added to any other diagram or mode presented in this specification. It is optional because in some situations it is unnecessary, such as when the lift-drop window is shorter than the shortest round trip time of the finger from home to non-home device and back.

FIGS. 7A through 7E comprise a timing diagram illustrating the operation of the lift-drop mode of FIG. 5 and FIG. 6. The time of arrival of the hand at the pointing device is denoted by vertical dashed line 94, and a finger is shown dropping (down arrow 96) at the same time. A trigger pulse 98 (same as #82 of FIG. 6) is generated by the drop at this time, but it has no effect because no window is open (see FIG. 7B) and therefore trigger pulse 98 cannot get through (through the gate FIG. 6, reference # 84). The lift of the finger (up arrow 102) opens window 104 (#76 of FIG. 6). A single window pulse 104 is generated by each lift (T1, [A] to [NA] transition). The finger dropped at time 106 while the window is still open, causes a trigger pulse 108, which, in turn, because the window is open, is able to trigger function A (110). Lift at time 112 also opens a window, but since the drop at 114 occurs after the window closes, the trigger 116 it generates cannot trigger the function. If a window (120) is still open from a previous lift (118) when another lift (126) occurs, lift 126 retriggers the window (at 128), extending it for another full window duration. This provides for rapid repeats. A function trigger 124, 132 is shown being generated by each drop (T2, [NA] to [A] transition) that occurs while the window is open. Since each drop retriggers the function, and one can double-click or triple-click with less effort than with push/depression clicking. Lift-clicking is an extremely ergonomic method of repetitively clicking.

A lift is shown at time 134, followed by a non-home switch being pressed (138). This optional feature (FIG. 5, reference #54, FIG. 6, #90), immediately causes the window to close at 140, thereby preventing the subsequent drop 142 and trigger pulse 144 from triggering a function. The departure of the hand at time 146 cannot cause a trigger because although it opens window 150, there is no drop. Drops and lifts due to the arrival or departure of the hand are thereby prevented from triggering any functions.

FIG. 8 is a flowchart introducing the dual window lift-drop mode, with windows A and B (lift-drop AB mode). The first step 152 is a lift of the finger from its home resting position. The box labeled 154 provides a brief introduction to the optional momentary lifted modes of this invention, where the lifted state initiates momentary lifted mode processing in parallel to lift-drop mode processing. The lift transition opens a retriggerable window A (156), and optionally actuation of or close approach to a non-home device during window A (158) closes window A prematurely and cancels window B (160) (see discussion of 54 of FIG. 5). If the finger drops during window A (162), function A is triggered 164, either as a brief pulse 166, or latched on (168). If latched, the next lift unlatches (170) (or the next drop could be set up to unlatch). The choice between, pulse or latch and the means of unlatching could be programmed by a preferences setting.

Window B opens (172) at the close of window A, and optional feature 174 can close window B prematurely (176) if a non-home switch is actuated (or closely approached). If the finger is not dropped during window A or B (178), no function is triggered (180) from the sequence initiated by the lift at 152. A drop/return of the finger during window B (178) triggers function B (182), either as a pulse trigger (184) or latched on (186), with the next lift (or drop) unlatching function B (188). Lifts and drops by the same finger have no other effect while the latch is on.

FIG. 9 is a combined electronic block schematic and timing diagram for lift-drop AB (dual window) mode, illustrating the dual window concepts of short lift-drop and medium lift-drop, plus optional additional slow cursor and disengage clutch features via a momentary lifted mode. A lift of the finger from home switch 190 causes a transition signal to pass through gate 192 when output of inverter 194 is high, and this transition signal 72 triggers Dual Window Pulse Generator 196 (which is retriggerable, see FIG. 10B, reference # 265), which outputs window pulse A (198A), and as pulse A closes, window pulse B (198B) opens. The next drop transition signal 78 triggers Trigger Pulse Generator 204. TPG 204 generates trigger pulse 206 which if the drop occurs during the time that window A is open, is shown here as pulse 206A which is enabled by window A to pass through AND coincidence gate 202A to trigger Function A (208A). If the drop occurs during the time that window B is open, it produces trigger pulse 206B which can pass through AND gate 202B to trigger Function B (208B).

Input 200 to Dual Window Pulse Generator 196 is an optional reset input which cancels windows initiated by lift 72 if a non-home switch or scroll device is touched or closely approached (as in FIG. 6, reference #90, FIG. 7 #140 and FIG. 8, #158 and #174).

If Function B is the latching of a drag, a signal out of gate 202B can be used to SET a Set/Reset flip-flop 210, whose high output at 214 can be used to initiate a latched drag function 212. The next lift (ANY LIFT) can then RESET flip-flop 210, thereby unlatching the drag. This next lift after a drop that latched a drag has only one effect, the unlatching of the drag, because it is blocked by AND gate 192 from triggering Dual Window Generator 196. This blocking operates as follows: flip-flop 210 outputs signal line 214 to inverter 194, whose output, after being briefly delayed by 216, acts as a controlling input at gate 192. Whenever the output 214 is high, a drag is being held latched, and the high input to inverter 194 causes a low input to the upper input of gate 192. The next lift will reset 210 to unlatch the drag and will eventually open gate 192, but brief delay 216 prevents it from running around the loop fast enough to open gate 192 in time to allow itself through. (The discrete delay such as shown at 216, which can simply be an RC delay, may be unnecessary if the rise time of the signal is delayed enough by the inherent delays it experiences during its passage through the flip-flop and the inverter.) Gate 192 will allow only the subsequent lift through to Dual Window Generator 196, i.e. it will allow a lift through only if flip-flop 210 is already in the reset (low out at 214) state when the lift occurs.

The optional Momentary Lifted Mode, with preference choices shown as switch 218, can provide features 222 and 224 via interaction between the light touch home lift-switch and the XY horizontal movement encoder on the bottom of the mouse. The slow cursor feature (222) decreases the ratio of cursor distance traveled to pointing device motion. This feature is useful to provide very fine control for detailed or very accurate work such as in CAD applications, especially if the user prefers to work most of the time with the pointing device in absolute mode, or with a low acceleration setting. If the slow cursor option is chosen, it can be conveniently activated at any time merely by holding the finger slightly lifted. In the simplest momentary lifted mode, where its processing is in parallel to the processing of lift-drop mode, slow cursor may be used without generating an unwanted click by remaining in slow cursor mode (i.e., by not dropping the finger) until after the lift-drop window (usually less than a second long) has closed. Instead of slow cursor, 222 could be any other alternate tracking mode, or other functions such as pan with mouse motion. Additional momentary mode options will be introduced later in this specification.

The disengage cursor/clutch feature (224) is a data clutch or switch which interrupts the flow of XY position data from the XY position encoder to the computer. If the disengage cursor option is chosen, it can be activated at any time by holding the finger lifted. This feature can be used to reposition a relative mode mouse on the work surface or mouse pad work area without physically lifting the mouse off of the desktop as is usually done in the prior art. Furthermore, although in lift-click modes inadvertent motion of the mouse during clicking is far less likely than with the prior art push/depression clicking, providing for the encoder to automatically become disengaged from the cursor between the lift and the drop in lift-drop mode (or between the lift and the end of the delay in lift-delay and hybrid modes, see FIGS. 22 through 31) absolutely prevents the cursor from moving at all during the click. The slow cursor feature provides a similar benefit to a lesser extent. In a pointing device with two lift-switches, for example left and right sensors, the programming can be set up so that slow cursor is enabled when the index finger is lifted, and the clutch is disengaged when both index and middle finger are lifted together as a chord (see FIGS. 13, 14, 16 and 17).

FIG. 10 is a timing diagram illustrating the detailed characteristics and use of the lift-drop dual window mode described by FIGS. 8 and 9. In FIG. 10A, hand arrival 226 results in a finger dropping 228 to the home touch surface, and generating a trigger pulse 230, which does not result in a function being triggered because no enabling window (FIGS. 10B and 10C) is open (and therefore it cannot pass through gate 202A or 202B of FIG. 9). Finger lift at 234 opens window A at 236, and when drop 238 occurs, trigger 240 is generated. Because drop 238 occurred within/before the close of window A, Function A (242) is triggered. Finger lift 244 initiates window A at 246, window A closes at 248, at which time window B opens (250). Finger drop 252 generates trigger pulse 254 which because it occurs within window B, triggers Function B (255). (If the finger drop had occurred after the close of window B, no function would have been triggered; see FIGS. 7A, 7B and 7D, reference numbers 114 and 116.) If function B is a latched drag as is shown in FIG. 10G, the latch on would occur at 256 and continue until the next lift 257, at which time the drag would be unlatched (258). Note that this unlatching lift does not open a window (one way to prevent it from opening a window is gate 192 of FIG. 9), and therefore the next drop 259 does nothing. (Instead of the next lift 257 being the transition that latches, the next drop 259 could be programmed to be the transition that unlatches the drag.)

Multiple repetitive lift-drops can be made in quick succession (260 and 262, 264 and 266), and window A retriggers at each lift, (265 being a retrigger), and the result is multiple triggering of Function A (263 and 267) in quick succession. A drop within a window can either leave the window open or close it, it does not matter, since the next lift, whether it is within window A, window B, or no window, will trigger window A again. This makes it possible to double and triple click, etc. The departure of the hand (270) does not trigger any function because although it opens windows (271A, 271B), there is no drop to generate a trigger. If a non-home switch or device were actuated during a window, the window would close prematurely (as in FIGS. 7B and 7C, reference numbers 138 and 140.

FIG. 11 is flowchart illustrating an alternate lift-click mode: the reference-delay-drop mode. In this mode, not only is a hand presence reference necessary for a drop to be able to trigger a function, but the reference must have been present for some time (274) previous to a drop in order for that drop to be able to cause a trigger, that is, the initial drop when the hand arrives is blocked from causing a trigger. Hand arrival 272 causes a reference sensor to transition, and this reference transition initiates a short delay (274). A drop of the finger before the end of the short delay (276) has no effect (278), thus preventing the finger drop that accompanies hand arrival from triggering a function which it otherwise would do if it arrived slightly after the reference. A drop of the finger after the end of the delay (276) triggers a function (280) if the reference signal indicates that the hand is still present at the input device. This mode is functionally similar to lift-drop single window mode, but it uses a requirement for a separate hand presence reference instead of a window opened by the previous lift. Lifts do nothing, and the finger can be held lifted for any length of time and the next drop will still trigger a function. Overall this mode is less useful than lift-drop modes because it does not lend itself to automatic cancellation of a lift (and of the next drop) if the finger leaves to touch a non-home switch, nor to dual function triggering like lift-drop AB mode or the hybrid modes to be described further on in this specification. Since a drop that is appropriate for triggering is always preceded by a lift anyway, it is usually better to use a lift-drop mode.

FIG. 12 is an electronic block diagram of the reference-delay-drop mode. A hand arrival transition signal from hand presence sensor 282 triggers pulse generator 284 which outputs an inhibiting delay pulse 286. Hand presence reference sensor 282 outputs a logic high in response to the hand being present at the input device. Very short RC delay 288 ensures that the falling edge of inhibiting pulse 286 arrives at and inhibits three-input AND gate 290 before the logic high from 282 arrives at gate 290. A drop transition signal 78 from the light touch home switch 292 triggers TPG 294, which outputs trigger pulse 296, which passes through gate 290 to trigger function at 298 only if the other two inputs to the gate are high at the time of trigger pulse 296. The length of inhibiting delay 286 (0.x sec) is set to be slightly longer than the longest time it takes, on the particular input device being used, when the hand arrives at the input device, for the finger to come to rest on the home sensor after the reference sensor detects hand presence, i.e., longer than the time differential between reference transition and finger drop due to hand arrival. Thus the delay in registering hand arrival at the gate prevents the drop due to hand arrival from having any effect. Of course if during hand arrival the drop always occurs before the hand reference, no delay is necessary, and this mode would then be simply a drop-ref mode.

FIGS. 13A through 13F comprise a logic truth table which illustrates the operation of a momentary lifted mode on a pointing device with a light touch sensor under each of the index and middle fingers. A momentary lifted function is maintained either as long as the finger is held lifted, or for as long as the finger is held lifted and a reference is present (see FIGS. 14 through 18 and FIG. 32 and their discussion for more options and details). These sensors feed their signal into momentary lifted mode processing, and can also be feeding in parallel into lift-drop or another processing mode. Thus this mode can be used together with another lift-click mode, a depression switch, or both. When used in parallel with lift-drop mode, optionally the enabling of a mom lifted state can be made dependent on the lift-drop window being closed, i.e., an open window could be caused to block the enabling of the mom lifted state. If only one finger is lifted (FIGS. 13B and 13C), the momentary lifted function for that finger is on/enabled, and the finger that is not lifted serves as an inherent reference for hand presence at the pointing device. If both fingers are held lifted as in FIG. 13D, a chorded function is enabled. The chorded function, since it has no inherent reference, can optionally require a hand presence reference (which could be a palm sensor or a sensor under any of the other fingers) to be enabled, as shown in FIGS. 13E and 13F. Likewise, a pointing device with only a single light touch sensor could require a hand presence reference.

FIG. 14 shows the use of a momentary lifted function to affect the use of the output of a pointing device's XY encoder 310. If no lifted function is enabled (312), the XY encoder is linked to its default action 314. If a lifted function is on (312), the use of the XY encoder is modified (316) either by being ignored (cursor clutch, FIG. 9 #224) or by changing the ratio of distance moved (slow cursor, FIG. 9 #222) or by scrolling/panning with mouse motion, etc. More lifted functions for the XY encoder will be introduced later in this specification. This modification persists for as long as the finger remains lifted, and optionally only for as long as the hand presence reference is indicating hand presence. This type of function requires two simultaneous user actions to become manifest: holding the finger lifted to ENABLE the lifted function, and moving the pointing device to MANIFEST/trigger it. Requiring two actions avoids inadvertent triggering when the hand departs, even when a normal type of reference is not required.

FIG. 15 shows the use of a momentary lifted function to momentarily change the functions assigned to keyboard keys. If no lifted function is enabled (322), the keyboard key assignments 320 are in their default state (324). If a lifted function is enabled (322), new functions are assigned to the keyboard keys or to a set of keyboard keys (326) for as long as the finger remains lifted and a hand presence reference is indicating presence of the hand at the input device which carries the light touch sensor being used in momentary mode. The reference is necessary so that the keyboard is not affected when the hand is absent from the pointing device. This lifted state can be used to automatically add a modifier command, such as Control or Command, to any key pressed, thus providing for single key keyboard shortcuts. The lifted state could also be used to temporarily convert a group of keyboard alphanumeric keys, including the home keys, into a move/nudge arrow keypad or a numeric keypad.

FIG. 16 is a flowchart illustrating the operation of the lifted-direct momentary mode of FIGS. 13A through 13D. A finger is lifted (330) from its home resting position on a sensor utilizing lifted-direct momentary mode. This causes the momentary lifted state for that sensor to turn on (322). As long as there is no drop (334), the mom lifted state is held on (336, 322), and if a lifted state of another sensor is not also enabled (338), then the left or right (depending on which finger is lifted) mom lifted function is turned on (342). If a lifted state of another sensor is also enabled (338), then the chorded momentary function is activated (340), for as long as the lifted state of the other sensor is enabled (338). When the finger is dropped (334), then the mom lifted state for that sensor is turned off (344). This lifted-direct mom mode usually would only be used for enabling operations that require a second action to become manifest, such as the movement of the mouse where accidental motion would be of no great consequence, as in the case of cursor clutch or slow cursor mom functions.

FIG. 17 is an electronic block diagram illustrating the operation of and one means of implementing the lifted-reference momentary mode and FIGS. 13A through 13D. Left and right light touch home sensors 350L and 350R each feed their outputs into an AND gate on their own side, 352L or 352R, and also cross over to an inverter 354L or 354R which inhibits the gate on the other side. If only one finger is lifted, it turns on its assigned function 356L or 356R. The inverters insure that when both fingers are lifted in a chord, which produces a signal out of AND gate 358; that the left and right mom functions 356L and 356R are both inhibited and remain off. If the reference (hand presence sensor) 362 has a logic high output indicating hand presence, then the signal output from chord gate 358 is enabled to pass through reference gate 360 to enable the chorded mom function 364. Thus not only does a chord require a hand presence reference in order to be enabled, but the separate left and right functions inherently do also, since in order for one of them to be enabled, the other finger must be in dropped position. For example, if the left finger is lifted, and the right is touching its home sensor, sensor 350R has a low output and inverter 354R has a high output which enables gate 352L to pass the logic high output from left sensor 350L to enable left mom function 356L. In the case of there only being a single light touch home sensor 366, gate 360 could serve to provide the reference requirement for triggering its function, via the dashed connection 367. In this case 364 would represent its assigned mom function.

FIG. 18 is a flowchart illustrating the operation of the lifted-delay/ref-delay momentary mode. This mode provides complete protection against accidentally enabling or manifesting a mom lifted function during hand departure, absence from, and arrival at the input device. A lift (370) outputs a logic high signal towards input 1 of quad input AND gate/processor 376, via very short RC delay 378. This delay insures that the retriggerable blocking pulse initiated by the lift transition (372, 374) arrives at 376 input 2 first, thereby inhibiting the effect of input 1 to 376 before the output of 378 can enable the mom lifted state. The circuit feeding inputs 3 and 4 to gate/processor 376 functions similarly, with the arrival of hand presence reference signal (380) at input 3 forced to lag behind blocking pulse 382, 384 because of very short RC delay 386, so that the delaying/blocking pulse (384) to input 4 inhibits the effect of all the other inputs until it times out. Thus gate/processor 376 turns on (380) a momentary lifted state for this sensor only when its inputs 1, 2, 3 and 4 are all high, and maintains this state only as long as all four inputs remain high. The net effect of this circuit is that the mom lifted state is enabled whenever the finger is away and the reference is present, except that when the finger is first lifted there is a short delay before the lift registers, and when the reference arrives, there is a short delay before its presence registers. When the finger is dropped and when the reference departs, the mom lifted state is disabled immediately, without any delay. Therefore, when the hand departs, if the finger departs before the reference, the lifted state is blocked by the lifted delay long enough for the reference to leave (and disable the state). When the hand arrives, the lifted state is blocked by the reference arrival signal delay long enough for the fingers to take up a desired configuration, whether lifted or dropped. Thus in all situations and all combinations of time intervals between hand and finger departure and arrival, all unintentional lifted artifacts are prevented automatically, no matter whether due to hand departure, to accidentally bumping the input device while the hand is absent or as the hand arrives, or due to a hand reference arriving before the fingers. The logic operating in the background is somewhat complex, but the result is functionally transparent.

The optional non-home actuation lift-cancellation feature described in FIGS. 5 through 8 could be added to the delayed momentary mode, so that if the finger is lifted for the purpose of an excursion to a non-home surface, the actuation of a non-home sensor cancels the effect of the lift, usually before the end of blocking pulse 374, i.e. before the lifted state can take effect.

FIG. 19 is an electronic block diagram illustrating the lift-reference mode. (This is a simplified lift-delay-reference mode (see FIGS. 22 through 26) where the mechanics and timing of hand removal allow the delay to be set to zero. Here the reference prevents click artifacts when the hand departs from the input device, but only if the reference always leaves before the finger lifts. Hand arrival is not critical, since in this mode the drop has no effect at all. When the finger lifts from its light touch home switch/sensor 390 linked to lift-reference processing, the lift transition 72 triggers trigger pulse generator 392 which outputs trigger pulse 394. Trigger pulse 394 passes through AND gate 396 only when reference 398 is indicating that the hand is present, to trigger assigned function 400.

FIG. 20 is an electronic block diagram illustrating a latching lift-reference mode. When the finger lifts from home sensor 402, the lift transition 72 triggers trigger pulse generator 404, whose output trigger pulse 406 passes through gate 408 only when hand reference 410 output is high indicating hand presence, to drive flip-flop 412 into the SET configuration, where its output is high and latches assigned function (414) on. The function is unlatched by the next drop 78, which causes the output of inverter 416 to transition high and thus drive flip-flop 412 into RESET configuration. The low output from 412 releases/unlatches function 414. (Instead the circuit could be designed so that the next lift unlatches, i.e., alternate lifts latch and unlatch, and the drop does nothing. Or the drop, after the next lift can be used to unlatch.)

FIG. 21 is a timing diagram illustrating the detailed characteristics and operation of the lift-reference mode of FIG. 19 and the latching lift-reference mode of FIG. 20. This mode can only be used if the reference always leaves before the finger lifts. The lift triggers the assigned function immediately if a reference signal is present, and a lift due to the departure of the hand cannot trigger a function because no reference is present. Hand arrival 420 is accompanied by finger return 422, and arrival of the reference signal either before (424) or after (426) finger return 422. Hand arrival is represented by a time spread, (dashed bracket) to symbolize the range of time over which the different parts of the hand (i.e., part sensed by the reference sensor and the actuating finger) arrive. The time of arrival of reference signal with respect to finger return does not matter since in this mode functions are triggered not by a drop, but by a lift. Finger lift 428 initiates trigger pulse 430 which, because the reference signal is high (FIG. 21C) at this point, is allowed to trigger either pulse function 432 or to turn on a latched function 434 (such as a drag). Return of the finger at 436 unlatches the function (438). Multiple rapid lift-drops as shown by 440 can generate a double click type of function 442/444. When the hand leaves (446), also shown by a dashed bracket symbolizing the spread over time, the reference signal 448 disappears before the finger lifts (450), a necessary precondition for the use of this mode. Finger lift 450 generates trigger pulse 452 which cannot have any effect because the reference is no longer present.

FIG. 22 is a flowchart illustrating the operation of the lift-delay (lift-delay-ref) mode. In this mode the function is triggered at the end of a delay initiated by the lift, if the hand is still present. This prevents inadvertent triggering when the hand departs the input device. The sequence begins with a lift 460 of the finger from its home resting position. The lift transition initiates a short window/delay 462 (on the order of one-half of a second long). If there is no drop (464) before the end of the delay, and the hand presence ref is present at the end of the delay (466), then at the closing of the window/end of the delay, function C (C stands for Closing) is triggered (468), either as a pulse trigger 470, or function C is latched on (472). The latch can be unlatched by the next drop, and optionally also by any departure of the reference signal (474). Alternatively, preferences could be programmed so that the latch is unlatched by the next lift or the drop following the above next drop. In the case of a drop occurring within the time interval of the window, i.e., before the end of the delay (464), there are three options for the lift-delay-ref mode, as follows:

### Type I, where at no time does a drop have any effect (except to unlatch a latched function); or

### Type II, where a drop within the window triggers the assigned function prematurely/immediately; or

### Type III, where a drop within the window terminates the window without triggering a function.

Type I with drop before end of delay is shown as the yes (Y, I) above 464, doing nothing different than if there was no (N) drop at 464.

Type II and type III are shown with drop before end of delay as the yes below 464, with both types terminating delay prematurely 478. The difference between II and III is that in type II, the function is triggered at the premature end of the delay, and in type III the drop before end of delay also serves to inhibit (482) the function trigger at 468.

A variation of Type II lift-delay-ref mode will be used create hybrid lift-drop/lift-delay-ref modes; these will be described by FIGS. 27 through 31B of this specification.

FIG. 23 is an electronic block diagram illustrating the operation of the lift-delay-ref mode, and is one possible implementation of the flowchart of FIG. 22. A coincidence between the end of the delay and a reference signal representing hand presence allows the function to be triggered. The finger is lifted from finger actuated light touch home switch 490, the lift transition 72 triggers window/delay pulse generator 492, which outputs window/delay pulse 494, whose trailing falling edge 496 triggers TPG 498, which outputs brief trigger pulse 500, which passes through AND gate 502 only when the reference 504 output is logic high (indicating that the hand is present at the input device), to trigger function at 506. Thus the preassigned function is triggered at the end of the delay, if the ref signal is present. The above describes the circuit path for lift-delay-reference mode type I, and also for type II when the dashed line 508 is included, where a drop transition 78 during the time the window is open serves to reset the window/delay pulse generator, terminating its output prematurely and immediately causing TPG 498 to output trigger pulse 500. A drop after the close of the window has no effect. Type III is not shown in FIG. 23, but is illustrated in FIG. 25.

FIG. 24 is a timing diagram showing the detailed characteristics and operation of the lift-delay-ref mode of FIGS. 22 and 23. Roman numerals I, II and III correspond to the three types of lift-delay-ref mode listed at the bottom of FIGS. 22 and 23. A lift due to the departure of the hand does not trigger a function because although it initiates a window/delay, the reference will have departed before the end of the delay. A function is triggered only if a reference is present at the end of the delay. Therefore drops and lifts due to the arrival or departure of the hand do not trigger any functions. The hand arrives at 510, and the finger arrives at 514. In this mode it does not matter if the reference arrives before (512) or after (516) the finger, since an initial drop does nothing; a lift is necessary to begin the sequence. A lift occurs at 520, which initiates window/delay pulse (522). When this pulse ends (524), a trigger pulse 526 is generated, and because the reference signal is present (+), function C is triggered (528). The drop 529 does nothing, since it occurs after the window/delay has ended. The next three lift-drop pairs, 530/534, 540/544 and 550/554 illustrate the different effects of a drop occurring within the time window for type I, II and III lift-delay-ref modes respectively:

Type I: lift 530 initiates window (532), drop 534 does nothing, at close of window (536) trigger pulse 538 is generated which, since reference is present, triggers function (539).

Type II: lift 540 initiates window (542), drop 544 within window terminates window prematurely at 546, at termination of window, trigger pulse 548 is generated which, since reference is present, triggers function (549).

Type III: lift 550 initiates window (552), drop 554 within window terminates window prematurely at 556 and inhibits triggering, and therefore no function is triggered.

Optionally the cursor can be automatically disengaged during the whole duration of the window/delay pulse, to insure that it does not move between the lift and the function trigger in case the pointing device is inadvertently moved during this period.

The hand leaves the input device at 558. It does not matter whether the reference signal disappears before (560) or after (566) the departure of the finger 562, as long as it always disappears before the close (568) of the window. Although the departure of the finger initiates (564) an enabling window at the close of which (568) a trigger pulse 569 is generated, as long as the reference departs before close 568, trigger pulse 569 cannot trigger a function. The duration of the window is set to be slightly longer than the longest interval, that ever occurs during actual use, between departure of the finger and departure of the reference. If the reference always departs before the finger, this window can be set to zero, resulting in Lift-Reference mode.

FIG. 25 is an electronic block diagram showing one way to implement the latch/unlatch feature of lift-delay mode introduced and described by the flowchart of FIG. 22. The most common use for this mode would be to provide a drag that begins (via a latch) at the end of the delay when the function trigger occurs. The drag latch continues for as long as the finger remains lifted, and ends (unlatches) when the finger is dropped. Lift-delay mode type III is shown here, where if the finger is dropped before the end of the delay, no function is triggered.

When the finger is lifted from the finger actuated light touch home switch 570 in Lift-Delay-Ref mode (latching):

### 1. Optionally the lifted state initially disengages the cursor, and it stores XY encoder output data (572) representing any motion of the pointing device during window/delay pulse 576. This will be discussed in more detail below.

2. Lift transition 72 triggers window/delay pulse generator 574, which outputs window/delay pulse 576, whose trailing falling edge 578 triggers TPG 580, which outputs trigger pulse 582, which passes through AND gate 584 when hand presence sensor reference 586 is indicating hand presence, to drive flip-flop 588 into the latched state, thereby latching the function on (usually a Drag, 590).

Although delay pulse 576 is generally less than 0.7 second, and usually less than 0.5 second, in order to be able to begin to drag an object immediately without having to wait for even the, fraction of a second until the end of the delay, a special DISENGAGE CURSOR/JUMP-TO-CATCH-UP OPTION for latch/unlatch lift-delay mode (and also for hybrid mode when the end of delay trigger (C) is used for dragging) could consist of:

(1) a lift initially disengages the clutch (as in FIG. 9, except only initially), and
(2) the user begins to move the pointing device immediately, but the cursor remains stationary, and

a) If the finger is held lifted until the end of the delay, then at the end of the delay (if the reference signal is present) the cursor clicks at the point where it initially was (since it has not yet moved), selects the selectable object sitting at that point, and then using the stored XY encoder output data, immediately jumps, together with the selected object, to catch up with the current real-time position of the pointing device, with the cursor clutch re-engaged.

b) If the finger is dropped before the end of the delay, the cursor does not move at all, i.e., the disengage clutch works just as described in FIG. 8, and any motion data is discarded.

The circuit/programming can be designed so that the drag 590 is unlatched either by the drop/return, or by the next lift. FIG. 25 illustrates unlatching by the next drop. (If unlatched by the next lift, a loop analogous to that of FIG. 9 reference numbers 214, 194, 216 and 192 could be used to prevent this next lift from having any other effect.) Unlatching by the next drop proceeds as follows: drop 78 (which for the purposes of this particular circuit implementation is a logic high to logic low transition) drives the output of inverter 592 high, which unlatches flip-flop 588 and turns off function 590. Another action of drop transition 78, if it occurs during delay pulse 576, is to cancel the lift without triggering any function (lift-drop-ref type III). This is accomplished here as follows: drop transition 78 triggers inhibitor pulse generator 594, which outputs inhibiting pulse 596, which passes through gate 598 if window 576 is open at the time, to both inhibit TPG 580 and, via very short delay 600, reset window/delay pulse generator 574. The purpose of very short delay 600 is to ensure that the inhibit input to TPG 580 takes effect before 580 is triggered by the falling edge 578 that occurs when the window/delay pulse generator 574 is reset.

It may be desirable to have the latch automatically unlatch if the hand leaves the input device, e.g., if the reference signal changes from logic high to logic low (FIG. 22, #474). This optional feature is shown being implemented by optional gate 591.

FIG. 26 is a timing diagram that shows the detailed characteristics and operation of the latch/unlatch lift-delay-ref mode of FIG. 25. FIG. 26F illustrates the automatic disengaging of the cursor for the disengage cursor/jump-to-catch-up option described in the discussion of FIG. 25. The hand arrives at the input device at 610. It does not matter whether the reference signal goes high before (612) or after (616) the arrival of the finger (614) because in this mode the sequence is initiated by a lift, not a drop. Finger lift 618 initiates delay pulse 620 and the lifted state disengages the cursor/clutch (622). At the end 624 of delay pulse 620, since the reference (FIG. 26D) is high, trigger pulse 626 is generated, which in turn latches on the function (628) and re-engages the cursor (630). If any XY encoder motion data was stored during the time the cursor was disengaged, at time 630 this data updates the position of the cursor. The function remains latched until the next drop 632, at which time it unlatches (634). (Alternatively the unlatching could be via the next lift, or via the drop after the next lift. In such setups the next lift, or the next lift and the following drop, would have no other effect.) When the hand leaves at 636, it does not matter whether the reference departs before (638) or after (644) the departure of the finger (640), because a trigger pulse 648 is not generated until the end (646) of delay pulse 642, by which time the reference will have departed (see the last paragraph of the discussion of FIG. 24 for an explanation of how the duration of the delay pulse is chosen).

FIG. 27 is a flowchart illustrating the characteristics of a hybrid mode that combines lift-drop and lift-delay type II characteristics and functions. More specifically, the hybrid mode is a variation of type II, where the function triggered by a drop within the window/delay pulse is function A, a different function from the one that is triggered at the end of the window/delay pulse, function C, thus providing a choice of triggering one of two different functions from the same lift sensor, depending on the length of time the finger is held lifted. Only one function, A or C, is triggered, not both.

The sequence of the description of the flowchart of FIG. 27 will be: first, a detailing of a cycle that triggers lift-drop function A, then the effect of an approach to a non-home device, and lastly a cycle that triggers lift-delay-ref function C. In any one cycle, only one or the other function can be triggered, A or C, but never both.

A cycle begins with a lift 660 of a finger from its home resting position, the lift transition initiates a window 662 (approximately 0.5 second long), a finger drop during the window (664, Yes) triggers function A (666) and cancels any further trigger in this lift cycle. As in lift-drop mode, a function A trigger does not require a reference.

When function A is triggered (666), it can be triggered either briefly with a pulse trigger (672), or latched on (674). If latched on, the next lift unlatches (676). (Alternatively, the next drop could be set up to unlatch.)

If there is no drop during the window (664, No), and there is no reference present at the close of the full window (678, No), then the cycle/sequence ends, without any trigger (680). If there is no drop during the window (again 664, No) and the reference is present at the close of the full window (678, Yes), then the close of the full window triggers function C (682). (C stands for Close). Function C can either be triggered on briefly with a pulse trigger (684), or latched on (686). If latched on, function C can be unlatched (688) by the next drop, and optionally also by a reference departure. (This option of having a reference departure unlatch a latched function could be applied to any of the lift-click modes, including lift-drop mode, which does not ordinarily use a reference.) Instead of the next drop, the programming could be set up to unlatch on the next lift, or on the drop following that. (Unlatching via the drop following that, would be equivalent to the click-click method of dragging sometimes used in CAD, that is, click once to latch, and click again to unlatch).

Optionally, actuation of (or close approach to) a non-home switch or device reachable by the same finger (689) terminates the window without triggering function C; of course now function A can not be triggered either since there is no longer a window open when the finger returns home. This feature can be extended to cancel the hybrid window if there is any movement of the mouse (XY encoder). The latter can be useful when operating a momentary mode and a hybrid mode from the same sensor in non-interactive parallel fashion (and when the hybrid function is not drag), to enable the use of a momentary lifted function without the hybrid mode function C triggering at the end of a delay after the lift. Moving the mouse can be used to close the hybrid window and thus block triggering of the hybrid function C, for example when the momentary lifted function is a rerouting of the XY encoder output to panning with mouse motion. Whereas in the case of a lift-drop mode and a momentary mode operating in non-interactive parallel fashion, in order to avoid a lift-drop trigger one only has to maintain the lift until the window is closed.

The non-home cancellation feature described by 689 could also be added to lift-delay-ref mode (FIGS. 22 through 26). It is only sometimes practical to use this feature for lift-delay-ref and hybrid modes, because the non-home cancellation must occur before the end of the window triggers function C. No such problem occurs in using the non-home cancellation feature with lift-drop, because the end of the window does not trigger a function. This fact will sometimes be the deciding factor in choosing whether to assign a lift-drop mode or a hybrid mode to a particular home touch sensor.

FIG. 28 is an electronic block diagram illustrating the operation of the hybrid mode of FIG. 27. In the description of this circuit, which is only one of many possible means of implementing this mode, first the triggering of a function C at the end of a full window will be detailed, then the next drop unlatching a latched function C will be described, then a description of a drop within the window triggering function A, and lastly the canceling of a lift and an optional unlatching by approach to or actuating a non-home sensor, switch or device.

A lift from finger actuated light touch home switch 690, causes lift transition 72, which triggers window generator 692, which outputs window/delay pulse 694, whose falling trailing edge 696 triggers TPG for function C 698, which generates trigger pulse 699, which passes through AND gate 700 when hand presence sensor 702 output is high, to trigger function C with a pulse trigger 704; or, trigger pulse 699 SETS flip-flop 706, which causes the flip-flop to latch function C on (708).

A return of the finger to the home surface causes drop transition 78, which triggers TPG for function A (710), which outputs trigger pulse 712, which, via OR gate 714, resets flip-flop 706, thereby unlatching a latched function C. Whenever function C is latched, lift-initiated window 694 is no longer open, and therefore AND gate 716 will be blocked and the drop transition whose circuit was just described will have no other effect besides unlatching.

If lift-initiated window 694 is still open, then a trigger pulse 712 generated by the drop will be able to pass through AND gate 716 to accomplish three tasks: one, the pulse triggering of function A (718) (or a latched triggering of function A, to be unlatched by the next drop, etc.); and two, passing through OR gate 720 to immediately inhibit TPG for function C (698), and three, after very short delay (722), to reset window generator 692. Inhibiting TPG 698 first, before resetting 692, prevents the falling edge of the prematurely terminated window pulse from triggering function C.

If any non-home switch, sensor or device such as a scroll wheel is closely approached or actuated by the same finger that normally rests at home on the light touch home switch (724), an output signal from a non-home switch or non-home proximity sensor passes through OR gate 720 to inhibit TPG for fun C (698) and, after very short delay 722, to reset window generator 692. This can not only stop a function C trigger by prematurely terminating the window, it also prevents the return of the finger back to its home switch after actuating the non-home switch from causing an unintended trigger of function A, since the window will be closed when the finger returns home. Thus for lift-drop or hybrid function A, the implementation of non-home prevention of unwanted triggering is easy and without conditions. It is only needed at all for function A if the shortest round trip of the finger from home and back takes less time than the duration of the window. For function lift-delay-ref or hybrid function C there are limitations. To be effective at preventing unwanted triggering of function C, there is a requirement that the window/delay be of longer duration than the longest time it takes the finger to transit from the home switch to the non-home switch. The actuating of a non-home device could additionally be set up to unlatch a latched function C, via the output of 724 also passing through OR gate 714 to reset flip-flop 706, as is shown in FIG. 28.

FIG. 29 is a timing diagram showing the detailed characteristics and operation of the hybrid mode of FIGS. 27 and 28. Drops and lifts due to the arrival or departure of the hand do not trigger any functions. The most common use for hybrid mode would be to provide a click if the finger returns before the end of the delay (function A), and if it does not, to provide a drag held for as long as the finger remains lifted. The drag would ordinarily begin at the end of the full delay when the function C trigger occurs. In order to be able to begin to move the pointing device immediately without waiting for the end of the delay, the special disengage cursor/jump-to-catch-up option could be used (see discussion of FIG. 25). The next drop terminates the drag. If the function is not a drag, then a drop after the end of the full delay does nothing.

The hand arrives at 730, with the reference signal going high either before (732) or after (736) the arrival of the finger 734. The arrival of the finger 734 has no effect because a trigger sequence must be initiated by a lift as follows: the lift at 738 initiates window/delay pulse 740, which would, without a drop, have extended (dashed line) to 742, but drop 744, within the window time, closes the window prematurely at 746, and function A is triggered (748) at the premature close. The trigger of function A is not dependent on the presence of a hand reference because it is triggered by a finger drop (therefore the hand is still present). The initial drop 734 due to hand arrival does not trigger function A because the last window (generated by the finger lift of the previous hand departure) was much shorter than the time between hand departure and the next hand arrival and is therefore no longer open, and in order to trigger function A, the drop must be within the window initiated by the previous lift. Two lift-drops in quick succession are shown by 752, and they trigger function A twice in a row, 752 and 754, which could be used as a double click. The lift 756 initiates window 758, which is closed prematurely (762) without triggering any function when non-home switch is actuated at 760. Lift 764 initiates window 768, which closes at 770 after its full duration, at which time trigger pulse for function C 772 is generated, which, because the reference signal is present (FIG. 29F), triggers function C, 774 being a pulse trigger, and 776 being a latched on function C. Optionally, if a non-home switch is actuated at 778, the latched function could become unlatched at 780. If 778 does not occur, next drop 782 unlatches function C at 784. When the hand leaves at 786, it does not matter whether the reference leaves before (788) or after (794) the departure of the finger 790, because the departure of the finger initiates window/delay pulse 792, and at its close 796 a trigger pulse for function C (798) is generated which requires the presence of the hand reference in order to result in function C being triggered. By the time that pulse 798 is generated, the reference is no longer present, and therefore the departure of the hand does not trigger any function. (The full duration length of the window has been preset to be slightly longer than the longest interval between finger departure and reference departure when the hand departs.)

FIG. 30 is an electronic block diagram showing the operation of a lift-delay-ref mode and a hybrid mode where the finger held lifted directly holds function C on, without having to use a latch. This alternate to the latching means shown in FIGS. 25 through 29 is an example of another way to accomplish a similar result. When the finger is lifted from finger actuated light touch switch 810, the switch/sensor output goes high, and lift transition 72 triggers (retriggerable) monostable pulse generator 812, whose inverting output provides an inverted window/delay pulse (W/D, 814), whose falling leading edge immediately disables three-input AND gate 816 via its input 2. Simultaneously, the logic high of the lifted state undergoes very short RC delay 820, so that it does not reach AND gate 816 input 1 until after the gate is disabled by the W/D pulse to input 2. As soon as the W/D pulse ends, if the finger is still lifted, the logic high into AND gate input 1 turns on function C, provided that input 3 is also high (indicating that the hand is present at the input device). Function C continues to be held on for as long as the finger is held lifted and the reference remains present. If the finger is dropped, function C is turned off and the sequence must start over with a lift again initiating W/D pulse 814.

Up to this point in the description of FIG. 30, latching lift-delay-ref mode operation has been described. To provide the hybrid mode equivalent, the following is included: at the moment of a lift, at the same time that the inverting output of 812 outputs 814, the Q, or non-inverting output, provides identical but non-inverted W/D pulse 828, which enables AND gate 830, so that if, after a lift, the finger is dropped (78) within the duration of pulse 828, function A is triggered, and function C cannot be triggered because the finger is no longer lifted.

The optional function of canceling a lift if a non-home sensor is approached or touched is not shown in FIG. 30, but could be added by causing a non-home actuation to immediately reset monostable pulse generator 812 so that gate 830 is disabled, while at the same time pulling and holding input 2 to AND gate 816 low until the next drop.

The external operation and end result of using the circuit of FIG. 30 can be identical to that of FIGS. 27, 28 and 29. The underlying operation of the hybrid mode circuit of FIG. 30 is described by the flowchart of FIG. 27, and by the timing diagram of FIG. 29 with the exception of FIGS. 29E and 29G, since in FIG. 30 there is no pulse trigger of function C. The optional cursor clutch/catch up feature described in FIGS. 25 and 26 could be added to FIGS. 27 through 30. The circuit of FIG. 30 is in some respects similar to the circuit shown in FIG. 18: delayed momentary mode, and could in fact incorporate its reference delay feature in place of 822, so that the return of reference when the hand arrives will not re-enable a held function C until enough time has passed for the fingers to assume their desired configuration on the lift sensors.

Although the possible combinations are many and the operations in the background can be somewhat complex, once the lift-click modes, circuits and features desired are chosen from the method of the present invention for each sensor, and with proper setup or programming, in actual use this method is transparent and intuitive. It takes the user only a few minutes to become accustomed to lift-clicking.

FIGS. 31A and 31B comprise a summary table that outlines the transition-type mode timing characteristics of the present invention, and shows optional window-closing-sounds and click sounds. Sounds are helpful when a user is first becoming familiar with a lift-click input device, but are not necessary, since clicking, double clicking and dragging all produce visible actions that are obvious on the computer screen. The preferred modes of the method of the present invention are lift-drop AB (dual window) 850, and hybrid AC 880 (and also the momentary modes of FIG. 32).

The up arrows, shown in 840 as T1, are the lift or first transition, and the down arrows, shown in 840 as T2, are the drop or second transition (see the key box in FIG. 6). T1 initiates the window, and T2 within the window triggers function A (or B). In this table the letter name of the function triggered is shown to the right of NAME OF FUN, at the bottom of a vertical dashed line connecting it to the transition that triggered it. Dashed down arrows 864, 874, 884 and 894 represent drops that produce no action, but just complete the lift-drop cycle. In lift-drop modes (840, 850), the pulse serves as a window. In lift-delay-reference mode (870), the pulse serves as a delay at the end of which (the falling edge labeled Tc) function C is triggered only if the reference is present at the pulse end, here shown as the letter R overwriting the falling edge of the pulse. In hybrid AC (880) and hybrid ABC (890) modes, the pulse serves both as a window for triggering function A (and B), and also as a delay for the triggering of function C at its end. In lift-reference mode (860), there is no window, and the triggering of the function (LR) occurs immediately at the lift, if the reference (R) is present at that time.

Lift-drop mode clicking (840, 850) inherently provides its own ideal tactile feedback, which is the feeling of the finger re-touching the surface as the drop triggers a click function. The drop triggers a click only if it falls within a window, and therefore in both single and dual window lift-drop modes it may be useful, especially for new users, to add an optional audible or haptic indication of the closing of window A (and of window B) This window closing indicator is represented in FIGS. 31A and 31B by musical note 842. When a function A or B is triggered (lift-drop modes 840 and 850, hybrid modes 880 and 890), the trigger could be used to cancel the window-closing-indicator, since this indicator would now be superfluous. Additionally, if desired, a characteristic click sound could be electronically generated when function A or B triggers, with the sound being either the same or different for A and B.

The lift-reference mode 860 triggers its function LR on a lift, and therefore a click sound, represented here by exclamation point 862, would be helpful.

In the lift-delay mode (870) and hybrid modes (880, 890) the triggering of function C that occurs at the end of the delay (if hand reference is present) does not provide the same direct tactile finger dropping feedback as lift-drop modes do. Therefore the electronic production of a characteristic sound or haptic signal when function C triggers, here shown as checkmark 872, could be beneficial.

Haptic signals (internal thumps, bumps, or vibrations) could be provided either instead of or in addition to sounds. The musical note represents a sound and/or haptic event generated when a lift-drop (or hybrid ABC) window closes, and the checkmark represents a sound and/or haptic event produced by the triggering of function C in lift-delay or hybrid mode. Other distinct indicators, not illustrated here, could be a characteristic sound or haptic when a drag is latched, and another when the drag is released. A visual change in the cursor could also be used.

FIG. 32 is a table summarizing momentary-type mode timing characteristics. Momentary modes utilize the same sensor/switch as used by the lift-clicking transition modes. A momentary lifted function (usually a blocking, modification or rerouting of the pointing device's XY encoder output) is activated and maintained during the time that a finger is determined to be absent from the home surface. This activation can optionally require a hand presence reference, either at the time of the lift transition, or after a short delay following the lift transition. The lifted state is terminated by a drop. This state is called momentary because it is maintained for as long as the finger is held away from contact with the surface (or deactuating the sensor). For a “two button” mouse, three lifted states are available: index finger up with middle finger down, middle finger up with index finger down, and both fingers up. Momentary lifted states can be used to trigger a click or transient/pulse command type of function, but they are usually used for momentary type functions whose activation becomes apparent/manifest only when the pointing device is moved. They are not usually used by themselves on a pointing device, but are used together with either another lift-click mode and/or a depression switch.

In FIG. 32 finger position is drawn as logic low=dropped, and logic high=lifted. In lifted-direct momentary mode (column 900, and FIGS. 13 and 16) the enabling of the lifted state follows finger position exactly, and neither reference nor delay is used.

The direct momentary lifted function is enabled during the time that the finger is removed from the home resting location and usually is actually triggered or manifest only during the time that a second action is being carried out that requires the presence of the hand. For example, the enabled function can be panning with mouse motion, and the second action can be the hand moving the mouse to manifest/trigger the moving of the document across the computer monitor screen with mouse motion. Another example is where the enabled function can be disengage cursor clutch, and the second action can be the hand moving the mouse to manifest/trigger the cursor not moving across the computer screen with mouse motion. With the addition of a requirement for a hand presence reference or reference and delay(s), the above enable and trigger description and examples can also apply to the other momentary lifted modes described below.

In lifted-ref mode (column 910, and FIGS. 17 and most of 13) the lifted state is enabled only when both the finger is lifted and a hand reference is present. As the hand departs and arrives, this can result in brief unintended enabling periods if the finger leaves before the reference departs, and if the reference returns before the finger has settled into its desired configuration, as shown at the bottom of column 910. In some applications, with some types of functions, this is of no consequence. When unintended enabling periods are undesirable, the delayed momentary mode (lifted-delay/ref-delay) (column 920, and FIG. 18) can be used. This mode has a blocking delay LD before a lift is recognized (i.e., the rising edge of the lift transition is delayed) and a blocking delay RD before the return of a reference is recognized (the rising edge of the reference return transition is delayed), thus preventing glitches if the finger departs first or if the reference arrives first (compare the bottoms of columns 910 and 920). There is no delay in recognizing the departure of a reference, nor in recognizing a drop transition. The difference between the delayed momentary mode and hybrid AC (with function C latching) mode is that when the hand departs and returns, in hybrid mode the sequence must begin all over again, with a finger lift; whereas in delayed momentary mode when the ref returns, if the finger remains lifted, after a brief delay the lifted state is re-enabled.

Instead of the full lifted-delay/ref-delay mode being used, particular combinations of assigned function and type of input device could use a mom lifted-delay mode, or a mom lifted-delay/ref mode, or a mom lifted/ref-delay mode. The triggering of a function via momentary lifted mode processing can be identical to lift-ref latched function C (see FIG. 20) in its user operation and end result, but the logic for generating the trigger is different, and instead of utilizing transition triggering and a latch, is a direct result of the momentarily lifted finger, enabling a lifted function when the finger is lifted, and disabling it when the finger is dropped. The particular safeguards (ref, delays) used for mom lifted (i.e., which mom mode is used) depends on the application, the function triggered, the particular input device, and the users style of operation of the device.

### Single Stage Embodiments

FIGS. 33 THROUGH 42 illustrate a number of single stage embodiments of the lift-click method in mouse-type pointing devices, including function assignments and setup.

A FIRST PREFERRED EMBODIMENT is a horizontal mouse utilizing single stage lift-clicking. FIG. 33A is a top view of this embodiment (948), showing left and right home touch surfaces of light touch lift type of switches/sensor zones 950L and 950R that are home resting locations for the index and middle fingers for use in lift-drop, lift-delay, hybrid and momentary lifted modes, optional rear momentary touch switches 952L and 952R, possible hand presence reference sensor zones (dashed line ovals 954L, 954R, 954C) that can serve as home resting locations for the thumb, ring or little finger and palm, and scroll device 956. This embodiment incorporates any type of prior art XY horizontal motion encoder 949 (see side view cross-section FIG. 33C) in its underside for cursor tracking of horizontal position of the mouse on the desktop/worksurface. This embodiment could have a shape and proportions different from the illustration in FIG. 33A, and need not be bilaterally symmetrical as shown, but separate models could be optimized for right and left hand use.

Included in this embodiment is a lift-canceling proximity-to-scroll-device detector means that can detect the close approach of a finger to the scroll device. As also illustrated by FIG. 33B (front view cross-section), FIG. 33C (side view cross-section) and FIG. 33D (side view with finger), the lift-canceling detector is a generally horizontal light beam 960 passing over the top of scroll wheel 956. The light beam 960 is shown being generated by LED 962 mounted on a rear-facing projection 963 on the front of the mouse, passing over the top of the scroll wheel, entering the top of the mouse housing through an opening or window or fiber optic or lens 964, and being detected by photosensor 966.

FIG. 33C shows the uninterrupted light beam 960 passing over the top of the scroll wheel. FIG. 33D shows that when index finger 968 lifts from its home surface 950L to actuate the scroll wheel, it interrupts light beam 960. This interruption is detected by photodetector 966 and sent as a signal to the processor which cancels the lift.

The function of this lift-canceling means is to detect when a finger lifts from a home switch for the purpose of using the scroll wheel, and to generate a signal which is used by the processor to provide an automatic canceling of the lift, so that the lift does not result in an unintended click at the end of a delay or when the finger returns home (see FIG. 5 #54, FIG. 6 #90, FIG. 7C #138, FIG. 8 #158 and #174, FIG. 27 #689, FIG. 28 #724, FIG. 29C, and their detailed descriptions).

Any other type of scroll device may be used. For lift-canceling means, instead of using LED 962, beam 960 and photosensor 966, any movement of the scroll device could be used as a signal to cancel the previous lift, or, if the scroll device incorporates a touch sensor, an output signal in response to being touched could be used.

A second type of lift-cancelling means automatically prevents unintended triggers when the finger lifts from home to touch rear momentary touch switch/sensor 952L or 952R. The touch not only triggers its assigned rear switch function, but in addition it sends an automatic lift-cancelling signal to the processor for the purpose of canceling the lift that occurred when the finger left its home sensor to touch the rear switch.

A third type of lift-cancelling means can be when any motion of the mouse/XY encoder is programmed to cancel function A, B or C triggers during the time that a momentary lifted mode is being used; this is not used with drag function. Only the A, B, or C triggers would be canceled/blocked, not the momentary mode function.

FIG. 33B, a front view cross-section, illustrates right and left home touch surfaces 950R and 950L, with proximity sensors 951R and 951L shown under the touch surfaces. 951R and 951L could be any type of touch/proximity sensor integrated with the touch surfaces in any manner within, below, or on the touch surfaces. 950R and 950L could be touch surfaces associated with individual sensors, or could be individual touch zones of one larger touch or proximity sensor divided into separate zones by either software or hardware means, and which could optionally include the rear momentary switches/sensors 952L, 952R, and also reference (or additional lift-switch sensors) sensors/zones 954L, 954R, and/or 954C, and a scrolling means.

The embodiment shown in FIGS. 33A through 33D is operated as demonstrated by FIGS. 2A through 2C and FIGS. 3A through 3C, where the lift usually involves the finger breaking contact from the surface. Optionally the surface of the switches can be resilient for a cushioning effect. Any type of light touch sensor means may be used, including capacitative, charge transfer, electric field, resistive, proximity, or optical, including those illustrated by FIGS. 43A through 47B. Either lift-drop or lift-delay or hybrid modes (and optionally also a momentary lifted mode) can be used for the home switches, for example with the left home switch 950L being set to hybrid and the right home switch 950R to lift-drop. The left and right home switches 950L and 950R are normally actuated by the relaxed resting left (index) and right (middle) finger respectively, and deactuated when the finger is lifted. The left and right rear (non-home) momentary light touch switches 952L and 952R are activated by a finger departing from a home switch and touching them. This lift does not cause an unwanted triggering of the home switches because of the automatic canceling of the lift when the rear touch occurs.

Only one of the three sensors 954L, 954C, 954R is needed as a hand presence reference, and then only if lift-delay or hybrid mode or a momentary lifted mode requiring a reference is used. 954C is a palm presence sensor, and 954L and 954R can be used to sense the presence of the thumb and the ring or little finger as indicators of hand presence. If the palm sensor is used as the hand presence reference, then the left and right sensors 954L and 954R could serve as additional lift-click home switches for thumb and/or ring or little finger. Alternatively, a sensor can serve as both a lift-click switch for a finger and as a reference for a lift-delay or hybrid mode under another finger, provided that no chorded functions are assigned to the lift-click/reference finger; this concept is further detailed in the discussion of FIGS. 40A, 41 and 42. Any means of providing a reference signal indicating that the hand is present at the pointing device may be used for the reference needed by a lift-click mode, and any of these means can simultaneously also serve as a hand presence sensor at the pointing device for the purpose of automatically transforming keyboard key function assignments to another set of function assignments, as disclosed in copending patent application of Richard H. Conrad: “Method and Apparatus for Automatically Transforming Functions of Computer Keyboard Keys and Pointing Devices by Detection of Hand Location”, Ser. No. 11/303,782 filed on Dec. 16, 2005), and hereby incorporated by reference.

An alternative design could have the rear momentary touch switches 952L and 952R moved backwards, or the home switches shortened at their rear, so that the dead space/neutral zone/inactive area 966L and 966R between them could be lengthened into a neutral/inactive touch area that would offer the possibility of A SLIDING AWAY MOTION for deactuating the home touch switch: the finger, instead of being held lifted (while dragging for example), could instead be slid backwards off of the active home switch to rest on the neutral area (or lifted and replaced on the neutral area). The sliding option is illustrated in FIGS. 40A through 40D. Thus an accessible neutral surface would allow the option, during a drag that is held for as long as the finger is away from the switch surface, of THE FINGER RESTING ON THE NEUTRAL SURFACE INSTEAD OF BEING HELD LIFTED.

Although non-mechanical type switches are shown on the embodiment of FIGS. 33A through 33D, very light force depression mechanical switches (for example, the magnetic switch embodiment of FIG. 43) could be used instead for either the home switches (operated as shown in FIGS. 4A through 4C) and/or for the rear momentary switches. Cherry Switch Company manufactures five different models of subminiature micro-switches having a 9 gram actuation force, which would be suitably below the relaxed resting weight of a finger. But non-mechanical switches have a number of advantages. For pointing devices that use only single stage non-mechanical touch switches, the touch surface for each finger can be designed to be very long, since there are no mechanical constraints. The force required would not vary with the position of the touch on the switch (in a mechanical switch the force would vary in proportion to the distance from the hinge/pivot point). Thus non-mechanical switches offer a choice of actuation positions where the fingertip can sit at rest. In addition to allowing variety in the amount of curvature and extension of the finger, which can reduce potential fatigue, a long touch surface enables one mouse size to serve a wider range of hand sizes than in the prior art. Touch sensors are desirable also because they have no moving parts, are flexible, very thin and can be attached to or under surfaces, allow a wide range of pointing device shapes and designs, are inexpensive, and can be rugged and waterproof. In addition, with touch switches that are flush with the surface of the mouse and do not require depression to activate, the user has the option of using a sliding away motion instead of a lift, and/or a sliding return motion instead of a drop. That is, one would have the choice of sliding the finger along the active touch surface until it is no longer on the active home touch surface. In the prior art is not possible to use touch sensors as home-type click buttons, but for the lift click modes of the present invention they are ideal.

### Operation of the Preferred Embodiment

In lift-drop mode, the transition of lifting (or sliding) the finger from the home switch/home touch surface (causing a change of state of the light touch switch) initiates the enabled window. (The duration of the enabled window is adjustable by the user through a preference setting.) Then, if (and only if) before the end of this period (a suitable time might be, for example, 0.7 second) the finger returns to the switch (which changes back the state of the light touch switch again), an output signal is sent which activates the function. The requirement for a window not only prevents hand arrival from causing a trigger, but also enables the use of lift-cancelling means to prevent false triggering when a finger leaves a home switch to touch a non-home switch and quickly return home: the actuation of any non-home switch can be programmed to automatically close the window. Each lift from a lift-drop type of switch restarts the enabled period/time window, and only a return before the timing out/closing of this window triggers the function.

In lift-delay-ref mode, the removal of the finger from the home touch surface initiates a delay of preset duration, and the end of that delay triggers the function assigned to that switch if the hand is still sensed to be present at the pointing device. The initial setup of the shortest delay necessary could be accomplished by beginning with a zero delay, and if hand removal causes an unwanted trigger, by removing the hand from the mouse in all of the ways that will be typical in use, while lengthening the delay just until hand removal no longer causes a trigger. In pointing devices whose design is such that a reference palm or finger is always removed before a switch-actuating finger, the delay could be set to zero/dispensed with entirely. Then a lift would trigger a function immediately, as long as the reference sensor indicates hand presence at the moment of the lift. This would then be a lift-reference mode, as illustrated in FIGS. 19, 20 and 21, and which is functionally similar to lifted-reference momentary mode, FIG. 17.

Home switches 950L and 950R, instead of being single stage touch switches as shown, could instead be two-stage switches, with the second stage being of heavier threshold such as a mechanical switch, such as will be shown in FIGS. 49A through 51B. This would provide additional functions and features, as will be discussed in detail later in this specification.

FIG. 34 is a chart showing an example of assignments of modes and functions to the sensor zones of the embodiment pictured in FIG. 33. (An on-screen window similar to this chart could be used for assigning modes and functions to each sensor zone; FIGS. 38 and 39 accomplish this in part; only the function assignments need to be added). Left home sensor zone 950L is shown as assigned to hybrid AC mode. A drop within window A could is programmed to generate a left click, the signal output to the computer being a mouse button down command followed immediately by a mouse button up command (or the equivalent, depending on the computer's operating system).

This rapid automatic sequence makes it almost impossible to inadvertently drag an object while selecting it. This provides an advantage over the prior art depression click/drag button where motion between the depression and the release can inadvertently move the cursor or drag the object being selected. In some situations an automatic disengaging of the cursor clutch during a window or delay could be used to prevent cursor motion before a trigger.

A finger removal maintained beyond the close of the window/delay (provided a reference is present) triggers function C which initiates a drag. The drag is maintained as long as the finger is away, away being either held lifted or slid or dropped to rest on a neutral/inactive surface area. (If sensor zone 950L was instead assigned to lift-drop AB mode, a drop within window A could be programmed to generate a left click, and a drop within window B could be programmed to generate a latched drag unlatched by the next lift or by next drop, as shown in FIG. 10G, similar to the click-click method sometimes used in CAD programs.) There are three possible positions for the finger during dragging in the method of the present invention: the finger held lifted, the finger moved back and resting, or the finger resting in home position. Dragging can be done in any transition-type lift-click mode by using the equivalent of Set/Reset flip-flop logic similar to that illustrated in FIG. 9, 25 or 28, or by processing equivalent to FIG. 30. Dragging can also be done via a momentary lifted mode (or, in a two-stage switch, by holding down the depression stage, similar to prior art dragging).

The right home sensor zone 950R is assigned to lift-drop AB (dual window) mode: when the finger is dropped within window A, a double-click is generated, and when the finger is dropped within window B, a right click is generated.

While only the right finger is lifted, the momentary lifted mode left function, SLOW CURSOR, is enabled. While both fingers are lifted, the mom lifted mode chord function, DISENGAGE CURSOR CLUTCH, is enabled. Lifting the left finger has not been assigned a mom lifted mode function here because the left finger held lifted, after a delay, is assigned to trigger a latched hybrid function C: a DRAG. The mom lifted chord can be used without triggering hybrid function C if home sensor 950R under the right finger is assigned to be the reference (REF FOR C) necessary for function C to trigger at the end of the delay.

In FIG. 34, all text shown within each home sensor area (950L, 950R) represents potential functions that are all triggerable from within the same area/zone of that touch sensor. For example, in the case of 950R, functions A, B and M are all generated by lifts and drops of the right finger anywhere within the area labeled 950R, and (REF FOR C) signifies that the actuated state of this sensor can be used as the hand presence reference that is needed by function C of the hybrid mode of 950L.

FIG. 35 is a flowchart that describes the basic operations carried out and their location within a version of the embodiment of FIG. 33A where most of the processing for the lift-type switching is done inside the pointing device itself. Outputs of light touch home lift-switch(es) 970, outputs of momentary rear touch switch(es) 972, and outputs of touch or proximity sensor at scroll device 974 feed directly into lift-click processing electronics inside (976) the pointing device which outputs codes for functions to be triggered, via copper cable, light signal, or radio frequency emission (978), to main computer 980.

FIG. 36 is a flowchart that describes the basic operations carried out and their location within a version of the embodiment of FIG. 33A where most of the processing for the lift-type switching is done by the main computer. Outputs of light touch home lift-switch(es) 970, outputs of momentary rear touch switch(es) 972, and outputs of touch or proximity sensor at scroll device 974 feed into transfer protocol interface inside (982) of pointing device which encodes the switch/sensor states raw data and sends them, via copper cable, light signal, or radio frequency emission (978), to main computer 984, where software programmed for lift-click processing generates function triggers. Any means that is intermediate between the two extremes represented by the flowcharts of FIGS. 35 and 36 could also be used.

FIG. 37 is a view through an optional hatch opening 990 in the bottom of the mouse of FIG. 33A, showing optional internal dip switches 991 for choosing mode and reference, and optional adjustment screws 992L and 992R for setting window and delay times for left and right home touch zone sensors.

FIG. 38 shows a settings table describing the functions of the 18 dip switches of FIG. 37. This table can also serve as a list of preference settings in an on-screen window for using driver software instead of dip switches to choose mode and options. Thus the choice between lift-drop and lift-delay modes could be made with dip switches within the pointing device, or by using a software driver to make the choice on-screen via a preferences setting. In FIG. 38, in addition to slow cursor (items 5 and 15) many other momentary lifted function options could be offered, for example, pan with mouse motion.

FIG. 39 illustrates a timings setup window for driver software that provides virtual sliders (998, 1000A, 1000B) for on-screen setting of window and delay times. A miniature speaker and/or haptic device can optionally be included inside the mouse of FIG. 33 to signal window closure and/or triggering (see FIG. 31 and its discussion). Either instead or additionally, an LED mounted on the top of the mouse could be used to aid in training and in the initial setting/adjustment of the duration of the enabled window in lift-drop mode (e.g. red for window A and green for window B), and of the delay in lift-delay mode. These durations can be adjusted either by using a small screwdriver to adjust potentiometers inside hatch 990 of the pointing device, or on the computer screen via virtual sliders 1,000 if a software driver is used.

FIG. 40A is a top view of an alternate, simplified embodiment of the lift type of sensors on horizontal mouse 1002, showing left and right lift-type sensor zones 1004L and 1004R. Examples of assigned functions are listed under the sensor zones. FIGS. 40B, 40C and 40D are sequential side views of mouse 1002 (showing left hand operation in order to use left to right sequential illustration) that demonstrate that a sliding of index finger 12 backwards along the touch surface can be used to deactuate a home sensor 1004R. In FIG. 40B the asterisk 26 shows that the sensor is actuated/detecting finger presence. FIG. 40C shows the finger having lifted or slid off active surface 1004R and resting on an inactive surface on top of the mouse. If the mode is lift-drop, the function would trigger upon the return home at FIG. 40D. If the mode is lift-delay, the function would trigger at the end of a delay initiated by sliding off the active surface provided that a reference sensor signal is present. Sliding can be used in lieu of lifting or dropping in many of the embodiments of the present invention. Of course this embodiment can also be operated by lifting the finger as shown in FIGS. 2A through 2C or 3A through 3C.

FIG. 41 is an electronic block diagram illustrating how two lift-type sensors, such as those shown in the embodiment of FIG. 40A, can serve as finger presence references for each other when one sensor is using a lift-drop mode and the other is using a hybrid mode. The right sensor 1010R is shown using dual window lift-drop mode, with the output of the right sensor cross-feeding, via inverter 1012, into the reference AND gate 1014 of the processing logic of the hybrid mode of the left sensor 1010L. The purpose of the inverter is because in these particular circuits, the convention used (and used also in most of the block circuit diagrams of this specification) is that when the index or middle finger is resting on and actuating its home sensor, the sensor output is designated as being logic low, and the hand presence reference sensor, when the hand is present, is designated as producing a logic high.

FIG. 42 is an electronic block diagram showing how two lift-type switches, such as those shown in the embodiment of FIG. 40A, can serve as finger presence references for each other when both use a hybrid mode. Inverters 1016R and 1016L cross-feed sensor signals into reference AND gates 1018L and 1018R respectively, of the other sensor.

Single Stage Lift-Click Switches

FIGS. 43 THROUGH 48 present detailed single-stage light touch lift-click home switch mechanisms, shown embodied in horizontal mouse type pointing devices (replacing prior art >20 gm depression/push mouse buttons).

FIG. 43A is a top view of a mouse embodiment 1028 carrying very light touch movable lift-type switch-actuating surfaces 1030L and 1030R (as left and right mouse buttons) of a small displacement depressible type requiring less than ten grams of force to actuate. Attachment/hinge means 1032L and 1032R attach switch surfaces to the mouse body.

FIG. 43B is a side view cross-section of the mechanical lift-switch embodiment of FIG. 43A, showing an example of an internal mechanism utilizing magnets for repulsion/sensitive force setting and for sensing depression via a magnetic sensor. A first magnet 1034L is attached to the underside of the hinged surface 1030L, a repelling magnet 1036L is shown attached to the housing below the sensor, and a magnetic (e.g., Hall effect) sensor (1038) is attached to the housing below the first magnet. This mechanism could provide a switch with an accurate very light actuation force and suitable hysteresis. Alternatively, a light spring return mechanism could be used in place of magnet 1036L. Any tactile feel beyond the feeling of the fingertip touching the touch surface is unnecessary, and in fact may be undesirable. (Instead of the internal mechanism shown in FIG. 43B, a standard Cherry mechanical microswitch with 9 gram actuation force could be used.)

FIG. 44A is a top view and FIG. 44B is a front view, of a thin membrane touch switch embodiment (1048) of the lift-switch of the present invention, where thin layer membrane switches 1050R and 1050L are adhered to the top surface.

FIG. 45A is a top view, and FIG. 45B is a front view cross-section, of an internal proximity sensor/touch switch embodiment (1058) of the lift-switch of the present invention 1062R and 1062L are proximity sensors (for example, capacitative array) or touch switch charge-transfer conductive electrodes integrated into or adhered to the underside of touch surfaces 1060R and 1060L. Optical proximity sensing could be used instead, such as IR coming from a source inside the pointing device and reflected downward by the finger into a photodetector inside the pointing device, or a FTIR technique could be employed. In some respects the embodiment of FIGS. 45A and B provides a ZERO BUTTON MOUSE.

FIG. 46A is a top view, and FIG. 46B is a side view cross-section, of a longitudinal light-beam finger lift sensor embodiment (1068) of the lift-switch of the present invention. Each sensor/switch comprises a fixed concave home touch surface 1070L, 1070R for helping the finger to position itself at home (this surface could alternatively be flat or convex), light-beams 1072L, 1072R, transparent entrance and exit opening/window/lens/light-pipe 1074L, 1074R, and 1076L, 1076R. LEDs 1078L, 1078R each produce a light beam parallel to the long axis of the finger, which is detected by photosensor 1080L, 1080R. LED's and photosensors are shown mounted on circuit board 1082. The palm proximity sensor 1077 is optional, and can serve as a hand presence reference sensor and can also be used to turn on the LED and most of the other electronics only when the hand is present. An interrupted beam is interpreted as the finger being present on the home surface 1070L, 1070R, and a received beam as the finger being absent from the home surface.

FIG. 47A is a top view, and FIG. 47B is a front view cross-section, of a lateral light-beam finger lift sensor switch embodiment (1088) of the lift-switch of the present invention. Each sensor/switch comprises a fixed concave or flat home touch surface 1090L, 1090R for locating the finger, light-beam 1092L, 1092R, transparent entrance and exit opening/window/lens/light-pipe 1094L, 1094R, and 1096L, 1096R LEDs 1098R and 1098L each produce a light beam perpendicular to the long axis of the finger, which is detected by photosensor 1100L, 1100R. An interrupted beam is interpreted as the finger being present on the home surface, and a received beam as the finger being absent from the home surface.

FIG. 48A is a side view, and FIG. 48B is a front view cross-section, of pointing device 1108 with XY encoder 949, and carrying a video imaging finger sensor embodiment of the lift-switch of the present invention. Imaging means and lens 1110 having field of view 1112 are mounted on a rear-facing projection 1111 on the front of the mouse. Field of view 1112 includes the tips of fingers 1102R, 1102L in both dropped (1102R) and lifted (1102L) positions, and touch surface 1114, whereby the imaging means can determine whether or not the finger is touching surface 1114, and also optionally whether or not the hand is present at the pointing device. Alternatively, the field of view can be more restricted, with horizontal dashed line 1113 in FIG. 48B representing the upper limit of the field of view, mainly viewing touch surface 1114 to determine when a fingertip is touching the touch surface; in some situations a pointing device with this more restricted field of view may require a separate hand presence reference sensor.

The lift-click method of the present invention could be used with the mouse described by Wei in U.S. Patent Application 20030184520 A1, entitled Mouse with Optical Buttons. The lift-click method would greatly enhance the practicality and usability of the finger motion sensor on Wei's mouse.

An additional type of finger sensor mechanism that could use the lift-click method of the present invention to great benefit is the Apple Computer's “Mouse with Optical Sensing Surface (U.S. Patent Application Publication No. US 200/0152966 μl) which obtains images of the whole hand from below the hand, and processes them to obtain touch patterns.

The very best type of sensor for lift-clicking is a touch sensor that is a finger contact sensor requiring practically zero pressure for actuation, and deactuates as soon as the finger breaks contact with the surface. Examples are charge-transfer types and interruptible light-beams. Proximity sensors that deactuate if the finger lifts more than ⅛ inch away from the surface are also an option.

### Two-Stage Switches

A light touch switch surface can be piggybacked on top of a prior art standard mechanical mouse button, resulting in a two-stage switch with a lift-click sensor being the first stage and a mechanical depression switch being the second stage. The first stage is actuated by less force than the weight of the resting finger, and the second stage actuation threshold is in excess of 50 grams. This offers the new effortless lift-drop or lift-delay method of clicking and lifted modes, and still makes available the prior art method of depression clicking. It triples or quadruples the number of functions that can be activated by each finger. Each stage of a two-stage switch can trigger different functions, for a total of 3 or 4 functions from each switch (2 or 3 lift-click plus 1 depression), and in addition each two-stage switch provides a new type of sequential chording within itself (within a dwell time) between its two stages (see FIGS. 57 and 58).

The light touch first stage could be used for clicks and other very frequently used functions, with the heavier second stage being used for less frequently used functions, especially those not involving the need to hold the pointing device stationary. One could simply assign the same (e.g., the single click) function to both stages, giving choice and variety of actuation for reducing the stress of repetition, and without having to remember which is which. Alternately clicking up and clicking down potentiates a good balance of muscle usage, which reduces the likelihood of strain-related disorders. Further, software could be used to monitor the recent frequency of use of each stage of a two-stage switch, and to provide a reminder to use a lift method when the prior art depression method is being over-used. In a two-stage sensor/switch, even if lift-drop, lift-delay or hybrid modes are not assigned, momentary lifted states via the first stage can be used together with the depression second-stage to add functionality.

FIGS. 49 THROUGH 58 illustrate two-stage switch mechanisms and chording.

In FIGS. 49 through 53 the first stage is a touch sensor piggybacked on top of a standard-type of electromechanical switch. The electromechanical second stage has a heavy enough actuation force (similar to prior art click switch force, >50 grams) to eliminate inadvertent clicking. A lift followed by a normal drop will not inadvertently activate the heavier second stage because the drop is passive, gentle and light. A heavy force is satisfactory for a second stage because this second stage would be assigned to functions used less frequently than the functions assigned to the first stage. The touch surface is either a rigid surface, or optionally is slightly cushioned, soft, or flexible, with a force required to actuate the first stage being preferably less than ten grams.

FIG. 49A (top view) and FIG. 49B (front view) introduce light mechanical/heavy mechanical two-stage home switches in the form of three-position, two-stage (two-step) depression mechanical switches 1120L, 1120R on pointing device 1118. The first stage is a very low-force (5 to 20 grams), small displacement (less than a few millimeters) lift-switch, and the second stage is a standard depression switch similar to prior art depression-type electromechanical click switches. In FIG. 49B, 1120R-0 shows the position of switch 1120R when the finger is lifted or absent, 1120R-1 shows the first stage actuated, displaced downward slightly (by an invisible finger) with a force of between 5 and 20 grams, and 1120L-2 shows switch 1120L pushed (by an invisible finger) into full depression with a force of more than 50 grams, with both first and second stages actuated. There is a tactile step/stop between the first and second stages because of a non-linearity of the force/displacement properties of this two-stage switch.

FIG. 50A (top view) and FIG. 50B (front view) illustrate touch membrane/mechanical two-stage home switches on pointing device 1128, with a resistive or capacitative light touch membrane switch or electrode or electrode array as the first stage 1132L, 1132R, layered on top of a mechanical second stage switch 1130L, 1130R. In FIG. 50B, two-stage switch 1130R/1132R is shown at full height, as either not actuated at all, or with a (invisible) finger resting on it with less than 20 grams of weight and actuating the first stage but not the second. Two-stage switch 1130L/1130L-2 is shown fully depressed (as by an invisible finger), with both stages actuated.

FIG. 51A (top view) and FIG. 51B (front view) illustrate a pair of internal touch-proximity sensor/mechanical two-stage home switches on pointing device 1138, with a finger proximity sensor or touch electrode inside the pointing device as the first stage. These Figures are not a cross-sections, but they do show internal proximity sensors 1142L, 1142R, 1143L, as dashed lines, as if they were visible through a transparent body of switches 1140L and 1140R. Any type of capacitative or other sensing technology could be used, including single layer dual electrode capacitative sensing or single layer single electrode charge sensing. The sensors or electrodes 1142R and 1142L can be either attached to or integrated with the underside of the touch surface of mechanical switches 1140R and 1140L and moving with them as they are depressed, or can be fixed in position just below and/or to the outside of the mechanical switch, as illustrated by 1143L (shown in FIG. 51B for left side only, and only one or the other would be used, not both 1142 and 1143). In FIG. 51B, two-stage switch 1140R is shown as fully extended, as if either no finger is present, or an invisible finger is resting passively on its top/touch surface and being detected by the first stage sensor, 1142R. Switch 1140L-2 is shown as fully depressed by an invisible finger with a force of greater than 50 grams, thereby actuating both stages (the first stage being actuated by either sensor 1142L or 1143L).

FIGS. 52A through 52D are a sequence of side view images in time of pointing device 1118, portraying the left hand operation of a light mechanical/heavy mechanical two-stage switch of the type shown in FIGS. 49A and 49B. FIG. 52B shows the first stage of two-stage switch 1120R actuated (as indicated by asterisk 26) with a slight depression by a force of between about 5 to 20 grams by the relaxed resting finger 12. Note that in FIG. 52A, the lever arm of switch 1120R is angled upwards, and that in FIG. 52B, the slight depression by the finger has brought it to a horizontal position. FIG. 52C shows full depression and actuation of also the second stage (as indicated by double asterisk 16) by the finger actively pushing with a force exceeding about 50 grams. FIG. 52D shows a partial release of the two-stage switch, back to the resting state identical to FIG. 52B. The net effect of the sequence as shown would be to trigger only the function assigned to the second stage, the actively depressed switch. This is because in the method of the present invention, a first stage actuation (a drop) alone does nothing unless it falls within a window opened by the previous lift.

FIGS. 53A through 53D are a sequence of side view images in time of pointing device 1138, portraying the left hand operation of a light touch/heavy mechanical two-stage switch with a first stage of the proximity/touch sensor type as shown in FIGS. 51A and 51B, where the sensor 1142R is under the touch surface of the movable switch 1140R and moves with it. The finger has three positions: lifted, relaxed resting, and depressing. FIG. 53A shows the finger lifted. FIG. 53B shows the first stage 1142R of two-stage switch actuated (as indicated by asterisk 26) with a force of between zero to about 20 grams by the relaxed resting finger 12. First stage actuation does not require any motion/depression of the switch. FIG. 53C shows full depression and actuation of also the second stage (as indicated by double asterisk 16) by the finger actively pushing with a force exceeding about 50 grams. FIG. 53D shows a partial release of the two-stage switch, back to the resting state identical to FIG. 53B. The net effect of the sequence as shown would be to trigger only the function assigned to the second stage, the actively depressed switch.

Note that in FIGS. 52A through 52D, which describe the operation of the two-stage switch of FIGS. 49A and 49B, the actuation of the first stage in FIG. 52B involves a partial light force depression of the touch surface 1120R. In contrast to this, in FIGS. 53A through 53D, which describe the operation of the two-stage switch of FIGS. 51A and 51B, the actuation of the first stage in FIG. 52B does not require or involve any significant depression of the touch surface 1140R. In both cases, the feeling of the fingertip touching the surface provides all of the tactile feedback of first-stage actuation that is needed.

FIGS. 52 and 53 demonstrate that although the first stage is actuated during actuation of the second stage, the actual functions assigned to each stage of a two-stage switch are triggered completely independently of one another. For the second stage, its function trigger is direct and synomonous with actuation. For the first stage, actuations are processed by the lift-click method of the present invention which triggers assigned functions based on sequence, timing, and in some cases a hand presence reference. Thus a first stage function is not triggered when a second stage function is triggered, and a second stage function is not triggered when a first stage function is triggered. Either a first stage is triggered, or a second stage is triggered, but never both simultaneously. As demonstrated in FIGS. 1, 2 and 3, lift-clicks are triggered by lifting up and holding up or dropping (without needing to push), and prior art type depression clicks are triggered by pushing down. The lack of interaction between the triggering of first and second stage functions will become further apparent in the discussion of the chording figures, FIGS. 55 through 58.

FIG. 54A (top view) and FIG. 54B (side view cross-section) illustrate optical sensor/mechanical two-stage switches with a longitudinal light-beam sensor as the first stage and an internal microswitch as the second stage on a horizontal pointing device 1148. The pointing device is shown as carrying XY encoder 949, and optional reference sensor 1077. The operation of the two-stage home switch can be similar to the sequence shown in FIGS. 53A through 53D. Only the two-stage switch on the left side will be described in detail below, since left and right sides are identical (although they could be asymmetrical instead). Movable home touch surface 1150L is attached to the body of the pointing device 1148 by hinge means 1152L. (Alternatively 1150L can be flexible and/or continuous with a flexible body material. It can be flat, concave, or convex.) Light-beam 1156L is generated by LED 1158L, passes closely over the top of touch surface 1150L and generally parallel to it, and is detected by photodetector 1160L. When finger 968 is lifted as shown, neither stage is actuated. When the finger is allowed to rest on touch surface 1550L, with weight of less than 20 grams, the light-beam is interrupted, and only the first stage is actuated. When the finger is depressed downward by the finger with a force greater than about 50 grams, the touch surface is pushed down to the position indicated by heavy dashed line labeled 1150L-2 and depresses the plunger of microswitch 1154, thus triggering the function assigned to the second stage (while the first stage remains actuated).

### Chording

FIGS. 55A through 58E are front views of any type of two-stage switch where finger presence/contact/first stage actuation is detected by a touch sensor (rather than by a depression displacement). The two-stage switch shown is similar to either the switches in FIGS. 50A and 50B, or in FIGS. 51A and 51B. FIGS. 55A through 56C show a right-left pair of two-stage switches, and FIGS. 57A through 58E show a single two-stage switch. Each stage of a two-stage switch can be assigned to trigger a different function. In addition, each two-stage switch makes possible a choice between a depressed chord (prior art type), and three new different types of chording: a lifted chord, a simultaneous lift and depress chord, and sequential chording within the two stages of the same switch. Each type of chord can provide an extra function. The switches can be either two-stage mouse buttons or special two-stage keyboard home keys. In the present invention, when the first stage of special two-stage keyboard home keys are enabled to be used for mouse clicks (see FIGS. 84B through 89), all types of chording can be employed.

FIGS. 55A through 55C are a time sequence of front view images that show the simultaneous same direction chording (lifted or lift-drop or lift-delay or hybrid modes) of the first stages of two-stage switches 1140R and 1140L, (or of two adjacent lift-type single stage lift switches) where the first stage (or single stage) is a fixed touch surface actuated by proximity or contact. (The first or single stage could alternatively be a very low force depression type of switch.) The single asterisk shows that a switch is actuated, and the absence of an asterisk indicates that the switch is not actuated. FIG. 55B shows the simultaneous (or nearly simultaneous, using a dwell time) lifted chording by the middle finger 1102R and the index finger 1102L to trigger a chorded lifted function. The triggering of a chorded hybrid function C could occur either somewhere between FIGS. 55B and 55C, or if the drop occurs before the end of the delay, the triggering of a function A could occur at FIG. 55C. The triggering of a lift-drop mode chorded function could occur at FIG. 55C.

FIGS. 56A through 56C are a time sequence of front view images that show a new type of chording, the simultaneous opposite direction lift/depress chording of two adjacent two-stage switches to trigger two additional momentary lifted functions (or any type of function that is triggered immediately at FIG. 56B). FIG. 56B illustrates the middle finger (1102R) being lifted (̂M or momentary lifted state), as the index finger (1102L) is fully depressing switch 1140L-2 (double asterisk), forming a lift/depress chord. (Another lift/depress chord would be the mirror image, when the index finger is lifted and the middle finger is depressed.)

FIGS. 57A through 57E are a time sequence of front view images that show the sequential chording of the two stages within the same two-stage switch, and demonstrates the first stage function being triggered first and the full depression second stage function second. The letter A in FIG. 57C indicates the lift-drop mode (drop within window A) triggering of the first-stage, and the double asterisk in FIG. 57D indicates the depression triggering of the second-stage. If these triggers occur within a preset chording dwell time, (which of necessity would require a short delay before each individual function is triggered) then the function assigned to this particular chording sequence is triggered.

FIGS. 58A through 58E are a time sequence of front view images that show the reverse sequential chording of the two stages within the same two-stage switch, with the full depression second stage being triggered first (FIG. 58B) and the first stage being triggered second (FIG. 58E). If the triggers occur within the chording dwell time, the function assigned to this particular chording sequence is triggered.

FIGS. 59 THROUGH 75 show horizontal mouse apparatus embodiments with examples of function assignments.

FIG. 59 shows a top view of the simplest embodiment of the lift switch of the present invention, one large single-stage lift switch 1190 on a pointing device 1188. The switch or sensor can be either a very light force mechanical small depression type, or a fixed type. If fixed, it could be any one of the types introduced in FIGS. 44A through 47B.

FIG. 60 shows how up to six different functions may be triggered by the use of the one single-stage lift switch of FIG. 59, by using different lift times, plus sequential chording of functions triggered by same or different lift times. The dot indicates a short lift, as used to generate a lift-drop mode or hybrid mode Function A, and the dash indicates either a medium lift as used to generate a lift-drop mode Function B or a long lift as used for hybrid mode Function C. See the DEFINITIONS section of this specification for the definitions of short, medium and long lifts.

FIG. 61 shows a top view of an additional embodiment of the lift switch of the present invention, a single large two-stage lift switch on a pointing device 1192. The first stage 1190 can be the same as the sensor of FIG. 60, and the second stage 1194 a relatively heavy depression-type of mechanical switch. Alternatively, a force-sensing touchpad of any mechanism could be used, one that is capable of generating a first (first-stage) output signal for a very light touch, and a second (second-stage) different output signal for a force in excess of about 50 grams.

FIG. 62 shows how up to twelve different functions may be triggered by the use of the single two-stage lift switch of FIG. 61, including sequential chording of first-stage actuations as in FIG. 60, plus second stage actuation, second stage sequential chording (e.g. double-click), and sequential chording together of first and second stages as in FIGS. 57A through 58E. Of course no one person would make use of this many combinations, but the choices are available. Momentary lifted mode functions, not included in FIG. 60 or 62, would increase the choice of functions even further.

FIGS. 63A through 63C illustrate a second preferred apparatus embodiment: a horizontal pointing device 1208 with left and right two-stage lift-click switches and left and right rear momentary touch switches. The first stage and rear momentary switches are light-beam interrupt switches, the second stages are prior art type mechanical depression switches 1210L and 1210R, and a light-beam interrupt sensor of finger presence at the scroll wheel (proximity-to-scroll-device detector) is optionally included. The top surfaces of the depression switches (1210L, 1210R) serve as the home touch surfaces for the fingertips. The depression switches are set in slightly recessed areas 1212L and 1212R on the top surface of the pointing device. The apparatus as shown is bilaterally symmetrical (although it need not be), and so for clarity of illustration and description, some of the symmetrical elements are labeled only on one side in FIG. 63A.

LED/photodetector pairs plus a mirror comprise light-beam interrupt lift-click touch sensors which serve as the first stage of the two-stage home switches, and as rear momentary touch switches. Of the two light-beam switches on each side, only the one on the upper right side will be labeled and described; the other three are similar. A first stage home touch switch is composed of LED 1214R, first leg of light-beam 1216R, mirror 1218R, second (reflected) leg of light-beam 1220R, and photodetector 1222R. The positions of the LED and photodetector could be reversed. The LED and photodetector are drawn here with dashed lines to indicate that they are hidden under the top shell of the pointing device (on the outside of the slightly recessed areas). The mirror is on the inside edge of the recessed area. Another LED/photodetector pair 1224R/1226R and mirror similarly comprise an optical lift-click touch sensor which serves as the rear momentary touch switch on the right side. While the middle finger (during right-hand use) is resting at home on second-stage depression switch 1210R, it is not actuating the second stage, but it is actuating the first stage by interrupting light beam 1216R/1220R. When the finger is depressed, the light-beam remains interrupted, thereby still actuating the first stage, and the depressed mechanical switch 1210R actuates the second stage and triggers the function assigned to the second stage.

If the finger lifts away or slides back from the home touch surface to actuate the rear momentary touch switch behind the home touch surface by means of interrupting the rear set of light-beams (1224R/1226R), the function assigned to the rear momentary switch is triggered, and simultaneously the lift-click method sequence (window or delay period) that was initiated by the lift transition that occurred when the finger departed the home touch surface of 1210R becomes canceled without triggering any lift-click function. The surface of slightly recessed area 1212R serves as the touch surface for the rear momentary light-beam switch.

Thus each light-beam switch is composed of two light-beam sections, a first section between the light source and the mirror, and a second section being reflected from the mirror to the photodetector. Interruption of either section or of both sections causes and maintains a first stage actuation. The light beam is designed to have two sections for two reasons: 1) the spread angle between the two beam sections provides a wider, less critical sensing zone for the optical switch, to accommodate different size hands and different finger positions; 2) the mirror, being very thin, allows the beam and its associated home touch surface to extend very close to the scroll device, whereas if a photodetector with a narrow acceptance angle (narrow acceptance angle is preferred) or the preferred narrow beam LED were placed next to the scroll device, it would take up too much room. An alternative light-beam switch could be created by using a strip of thin retroreflective material in place of a mirror, and a generally coaxial wide angle LED and photodetector on the outside of the slightly recessed area. (This would be analogous to the detector beam described in the next paragraph, but would preferably be a much wider beam reflected off a wider retroreflector.)

This embodiment includes a proximity-to-scroll-device detector that fulfills the function described by FIG. 8, #158 and #174, and FIG. 27 #689, It is composed of a generally horizontal, bidirectional (as indicated by the arrow at each end) light-beam 1230 that passes closely over the top of the scroll device 956. The beam originates from a coaxial light source/photodetector assembly 1232 inside the pointing device, exits from opening/window/lens/fiber optic 1234, reflects from retroreflector element or (concave) mirror 1236 mounted on the end of a rear-facing projection 1237 on the front of the pointing device, and back through 1234 to the photodetector inside the pointing device whose optical axis generally coincides with that of the light source (for example, in assembly 1232, the light source and photodetector are superimposed on the same optical axis by using a beam splitter or other coaxial means). If 1236 is a concave mirror, the light source and photodetector could be closely adjacent to each other instead of coaxial. The position of the beam with respect to the scroll device and to the rear facing projection is similar to that depicted in FIGS. 33A through 33D, and its interruption by a finger similar to that shown in FIG. 33D except that the interrupted beam would be coming from the right (from behind the finger). Alternatively, the embodiment of FIG. 63A could have its proximity-to-scroll-device detector beam 1230 use a LED and photodetector at opposite ends, as in beam 960 of FIG. 33C. (Furthermore, the embodiment of FIGS. 33A through 33D could use the retroreflected type of beam of FIG. 63A.) Instead of the proximity-to-scroll-device detector, a touch sensor integrated into the scroll device, or normal actuation of the scroll device itself, can instead be used to cancel lift. Also, if the mode under the index finger is lift-drop A mode with a window short enough that it would be closed by the time of finger return, no lift canceling means is needed.

FIGS. 63B and 63C are front view thick transparent cross-sections (thick enough to include/show one whole light-beam section). FIG. 63B shows the fingertips resting on depression switches 1210R and 1210L without depressing them, and interrupting both light-beams (1216R and 1216L) emitting from LEDs 1226R and 1226L. In FIG. 63C the middle finger 1102R is lifted, and the index finger 1102L is depressing the second stage (as in the simultaneous lifted/depressed chord shown in FIG. 56B). The finger that is lifted allows the light-beam 1216R to reach its mirror 1218R and photodetector and thus the first stage on that side is no longer actuated, and the depressing finger is still interrupting the light-beam and actuating the first stage on the other side. By looking at FIG. 63B it is easy to see that if the index finger 1102L were to be lifted to actuate scroll wheel 956, it would interrupt the proximity-to-scroll-device detector light-beam 1230. Interruption of this beam is programmed to cause a canceling of the previous lift, i.e., the lift-click mode sequence (window or delay period) that was initiated by the lift transition that occurred when the finger departed the home touch surface of 1210L becomes canceled without triggering any lift-click function.

The operation of the two-stage embodiment of FIGS. 63A, 63B and 63C to produce clicks and other functions using the method of the present invention is described by FIGS. 2A, 2B, 2C, 3A, 3B, 3C, 31A 31B, 32, and 53A through 53D. FIGS. 69 through 74 illustrate examples of different combinations of concurrent lift-click modes and depression clicking (and, if the home surface is an XY touchpad, mini-gestures, see the paragraph below), and their function assignments.

### Touch Switches, Touchpads and Trackpads

Up to this point, the embodiments shown in FIGS. 33A, 40A, 44A, 45A and 59 are described as utilizing single-stage touch sensors whose output reports only whether or not the finger is touching/is present at the home touch surface; and the embodiments shown in FIGS. 50A, 51A, 61, and 63A are described as utilizing two-stage touch sensors, whose first stage output reports only whether or not the finger is touching/is present at the home touch surface. Each fingertip can wander around its own home touch surface area/zone without initiating a lift. It will still maintain first stage actuation as long as it does not break contact with the touch surface. Touch sensors exist that have signal outputs that report position coordinates of the touch of a fingertip. Examples are the solid-state scroll strip in the prior art that reports Y coordinates via a capacitative sensing mechanism, and the prior art trackpad pointing device, which reports both X and Y coordinates. If a coordinate-reporting type of touch sensor were used under each fingertip, not for cursor tracking but as the lift-click sensor for use with the method of the present invention, the fingertip can also be used to trace out many types of gesture controls and commands without interfering with clicking, if the following two conditions are met:

1) The particular gestures used must not involve the fingertip breaking contact either vertically or horizontally from the home touch surface, and therefore must be of a shape that allows the finger to be re-centered within the home zone by a return to the origin of the gesture as part of the gesture itself, without lifting, i.e., the gestures must be smaller than the extents of the home zone, and either have the form of a closed path or loop, or of a straight or curved line that can be traced back upon itself. These will be termed closed path/retraceable mini-gestures.
2) the gesture recognition software must be programmed to ignore finger lifts and drops and any slight location displacement they may produce.

Since these two conditions are easily met, using coordinate reporting touchpads as lift-click sensors for clicking can be a great advantage because they can at any time, without toggling into a different mode, be used concurrently for entering simple gesture commands or as motion controls. Thus the lift-click sensor can also serve as a scrolling surface, for example. The clicking and the closed path/retraceable mini-gesturing would operate completely independently of each other and in a transparent manner.

FIG. 64 is a matrix table that summarizes the possible types (not mechanisms) of touchpads that can be employed for lift-clicking. The first column (1251) lists touch reporting only, the second column (1252) lists touch plus Y axis coordinate reporting, and the third column (1253) lists touch plus X and Y axis coordinate reporting. If a touchpad is of the multipoint type, that is, capable of reporting the location of more than one point/fingertip at a time, a single touchpad can be used as the lift-clicking and gesturing surface for two fingers on a pointing device (where the pointing device carries a separate prior art type of XY encoder for causing the cursor to track pointing device motion). An alternative to a single multipoint touchpad, when it is desired to use two fingers for input, is the use of two identical single-point touchpads/touchpad sections side by side, either touching or separated by a dead zone or separated by a scrolling device (which could be a central third touchpad/touchpad section with Y axis reporting, that is not used for lift-clicks). A touchpad with at least Y axis reporting can be used to provide a rear momentary touch sensor as well as the home sensor, via separate zone programming. It could also be used for longitudinal straight line gesturing, for example a ratcheting scroll means: stroking the index finger up and down on its home zone (without breaking contact) for scrolling down, with the scrolling down either only taking place on the down stroke, or on both strokes, and stroking the middle finger up and down on its home zone for scrolling up, which occurs either only on the up stroke, or on both strokes, depending on personal user preference. Stroking both fingers in the same direction simultaneously could zoom in, and stroking both fingers simultaneously but in opposite directions could zoom out.

Touchpads with both X and Y axis coordinate reporting can of course be used for many more types of gestures than the touchpads with only Y axis reporting. The key for choosing gestures that can be used together in the same default state with lift-clicking is: they must be of a retraceable line type or closed path type (a closed loop), and also simple and small. Examples of suitable gestures are straight and curved line gestures drawn in a variety of orientations, and closed path gestures such as circles, and ellipses, the letter D, a heart shape, a circular coiled coil, etc. which may each be drawn clockwise or counterclockwise, and in any orientation. These gestures can be used for various commands or for controlling actions such as scrolling, panning, zooming, rotating, turning a virtual volume control or jog wheel, etc. To prevent inadvertent mouse motion while gesturing, usually only the index finger would he used, except both fingers could be used simultaneously for linear strokes as in the scrolling strokes as described above. In the case of circles and ellipses, to prevent small inadvertent fingertip motions from triggering an unintended gesturing action or function, there could be a dwell time plus the requirement that a gesture be traced at least slightly more than one full circuit. Any problems of unintended gesture triggers due to the fingers sliding during hand arrival or removal could be prevented by a requirement for a hand presence reference together with a slight delay before activating a gesture command.

Touchpads programmed for the lift-click modes of the present invention that also provide an output signal (Z) proportional to touch force/pressure, as in the second row of FIG. 64, can provide two-stage switches. A touchpad can either be the single-point type (capable of providing the X and Y coordinates of only a single touch point at a time, in which case separate pads would be employed for each finger), or it can be a multi-point touchpad capable of providing position and optionally also pressure information for more than one finger touching simultaneously. A multi-point touchpad would be useful for additional purposes, such as toggled states that program it into discrete zones to provide arrow key functions, etc. Any of the embodiments shown in FIG. 33A, 40A, 44A, 45A, 50A, 51A, 59 or 61 could be enabled to provide concurrent gesturing by employing touch sensors with Y or XY coordinate reporting. A Y or XY touchpad could be substituted for a single-stage finger sensor of another mechanism, and an XYZ (force reporting) touchpad could be substituted for a two-stage finger sensor.

### Horizontal Mouse with Multipurpose XY(Z) Touchpad, FIGS. 65-68:

FIGS. 65A and 65B depict a third preferred apparatus embodiment: a programmable XY(Z) (Z=optional differential pressure reporting) touchpad integrated into the top of a horizontal mouse. FIG. 65A is a top view of the horizontal multifunction mouse 1258. FIG. 65B is a side-view cross-section of the same embodiment, and shows a prior art type of mouse motion/position XY encoder 949 in the underside of the mouse. An XY(Z) multipoint touchpad (or two side-by-side single-point XY(Z) touchpads) 1260 is integrated into the top surface of the mouse in place of mouse buttons or individual touch sensors. It is a programmable-zone touch switch with readout of XY coordinates of fingertip position for implementing the lift-click method and optionally also closed path/retraceable gestures in the same default state, and also provides a multi-functional mouse with toggled states for arrow keys and page navigation functions, panning, zooming and other purposes. The XY(Z) touchpad can be of any type, including capacitative, electric field imaging, or a home touch surface that is optically imaged to determine the dropped or lifted state and position of each finger.

The embodiment of FIGS. 65A and 65B is designed to be usable by either hand. Thumb switches (1266L, 1268L, 1270L) are included on each side of the top surface for controlling the state of the touchpad. The thumb switches can be momentary touch or depression-type switches. The touchpad(s) can either be flat, or can have a curved surface. Any means of positioning the fingers with respect to their desired home resting position on the touchpad can be used, including the way the hand naturally grasps the shape or sides of the pointing device, a thumb rest, and/or ridges or texture around the perimeter of the touchpad, or any other tactile alignment means.

Reference number 1262L is a concave thumb rest, 1264L is an optional momentary thumb switch and 1266L is a momentary (or toggling) thumb switch for shifting from the default state (or toggling from default or another state) to an arrow/nudge zones state. Similar thumb switches 1268L and 1270L are for activating a page navigation zone state and a programmed non-zoned state, respectively. Hand presence reference sensor 1077 may be any type of sensor, and is only needed for single finger operation or for some chords in lift-delay-ref, hybrid, and some momentary modes, since otherwise at least one finger (of the actuating index and middle fingers) is touching and can serve as a hand presence reference (furthermore, lift-drop modes need no dedicated/separate reference).

The XY touchpad 1260 is not used for main tracking control of the cursor. In order for a trackpad to be used for clicking and dragging and at the same time for tracking as in the prior art, the trackpad clicking and dragging methods are necessarily limited in order to avoid interfering with cursor tracking, and exclude the possibility of using the lift-click modes of the present invention. The prior art trackpad used for cursor control is not very satisfactory for clicking because it sometimes lacks reliability, and requires a forceful tap. Dragging on the prior art trackpad is even more of a problem. That is why prior art trackpads offer the use of a separate dedicated click button. In the method of the present invention, touchpads are not used as trackpads for main control of cursor position. X and Y coordinate reporting are instead used to provide multiple virtual zones as touch sensors, and optionally gesturing. If an input device of the present invention provides cursor tracking, it is by using a prior art type of XY encoder that is distinctly separate from the lift-click finger sensor mechanism. The touchpad of embodiment 1258 is only used to move the cursor when using fine control of cursor position, when nudging with arrow keys, or in some uses of a motion control pad state (see FIG. 68).

FIGS. 66A through 66D illustrate four possible states and function assignments for the embodiment of FIGS. 65A and 65B (which, if a touchscreen is used, could be actual views of the screen on the pointing device). FIG. 66A shows the touchpad 1260 of FIG. 6A in its default state, with an example of the division (via firmware or software) into touch zones and the function assigned to each zone. In FIGS. 66A, 66B and 66C, the upper row (1280 in FIG. 66A) is the home lift-click row. The lower row is a left/right pair of rear momentary touch switches. The left side of the dashed line is for the left finger, and the right side is for the right finger (index and middle fingers respectively when using the right hand). When lifting from a home row lift-touch switch to touch the rear momentary switch behind it, the touch on the momentary switch cancels the lift sequence initiated by the lift from the lift-touch switch. The lift-click zones in FIG. 66A could trigger their functions by lift-drop AB mode or hybrid mode. For example, left click and double-click could be left and right lift-drop function A, and drag and right click could be left and right lift-drop function B. The page up chord would be a chord within the mode used. The page down rear momentary touch switch function has three dots after it to signify that it goes into auto-repeat mode if held longer than a preassigned time, since the rear momentary switches can provide this feature. The zoom to 100% function is a chord of the two rear momentary switches, touched simultaneously (within a dwell time). As shown here, this default state can additionally provide keyboard functions such as ENTER that are not normally available to the right-handed user when the right hand is at the mouse. Additionally, small retraceable closed-path gestures (mini-gestures) could be traced by the fingertips on the touch surface within the home zones of this default mode without interfering with lift clicking (as long as each fingertip remains within its own home zone, as drawn in FIG. 69). Although a momentary lifted function is not illustrated in FIG. 66A, it could be included here, in a manner similar to that shown in FIG. 70.

FIG. 66B illustrates an arrow key state which provides arrow/nudge key function zones on top of the pointing device while the thumb either holds down or has toggled arrow key button 1266L. Instead of illustrating a thumb in these figures, a thickened circle around a thumb switch is used to indicate actuation. Left and right arrows are actuated by lift-clicks (for example, by a drop within a window after a lift), the up arrow by a lift-click chord, and the down arrow, which is dashed to indicate its auto-repeat ability, is actuated by a rear momentary type touch. (For the rear switches, the term momentary signifies not a lift-click or a lifted momentary mode, but a standard type of momentary switching where normally open contacts or virtual contacts are held closed for as long as a touch is maintained). The x 0.1, 1 and x 10 STEPS are toggles that control the size of each nudge increment, which is very useful to be able to choose on-the-fly.

FIG. 66C shows a page navigation key touchpad state which provides navigation function zones on top of the pointing device when thumb switch 1268L is toggled or held. Previous page and next page symbols are actuated by lift-clicks, and page down via a rear momentary touch, with auto-repeat if held. X ⅓, 1, and 3 PG STEPS are toggles that affect the increment size of the page up and down controls. It is extremely valuable to have set of arrow keys and set of navigation keys available to the mouse hand while it is at the mouse. The left hand that remains at the keyboard no longer has to fumble for the set of arrow or page navigation keys, which are on the right side of most keyboards. Instead it can remain resting on its ASDF home row, ready to actuate keyboard shortcuts. The states described by FIGS. 66A, 66B and 66C provide clicks, arrow keys and navigation keys using a lift-click mode for the finger home locations, and a light touch for the rear momentary switches. These are all light touch actuations, which are particularly advantageous for repetition intensive functions.

FIG. 66D shows a non-zoned/non-sectioned state, actuated by thumb button 1270L with the square icon, that dedicates the whole XY surface of the touchpad to one of a number of XY stroking/gesturing operations preassigned during setup. (Some possible XY operations are listed in the table of FIG. 68). Keyboard macros or other means could be use to change the choice of XY operation on-the-fly.

FIG. 67 illustrates an optional on-screen floating window 1284 displaying the current zone state, zone division pattern, and zone function assignments of the XY touchpad 1260 of the embodiment of FIG. 65 on computer monitor screen 1286. The left hand 1280L is shown at keyboard 1282, the right hand 1280R on pointing device 1258 with the right thumb touching thumb switch 1266L, thereby causing touchpad 1260 to shift into the arrow key state and simultaneously causing small window 1284 on the computer monitor screen to display the arrow key zones. This would provide eye-to-hand pattern transfer for ease of use, particularly when first using this apparatus. A means of turning window 1284 on and off, such as a keyboard macro, could be provided. One option is for window 1284 to appear for a few seconds each time different state is activated, and then automatically fade.

FIG. 68 is a table showing examples of XY(Z) touchpad states for the touchpad embodiment of FIG. 65. Listed are the three different states that are sectioned by software into discrete touch zones: the DEFAULT state, ARROW/NUDGE keys, and PAGE/NAVIGATION keys. Any or all of these three states could be configured for the concurrent use of retraceable/closed-path mini-gestures. The means for shifting out of the default lift-click/retraceable gesture state and into either arrow/nudge, page/navigation, or a preassigned NON-ZONED XY operation, could be the thumb touching or pressing one of the three buttons 1266, 1268, or 1270 on top of pointing device 1258 (FIGS. 65A and 66B through 66D), or by pressing a keyboard key or macro, either as a momentary or toggling control. The NON-ZONED OPERATIONS (also see FIG. 66D) comprise finger strokes or gestures (these gestures not limited by having to be retraceable or closed-path) that can be traced over the whole XY surface, without moving the pointing device itself. They are not move-with-mouse functions; move-with-mouse functions are shown as assigned to momentary lifted modes in default state, see FIGS. 69 through 74. The last column to the right, AUTO-CLUTCH, is an optional feature where the cursor automatically becomes disengaged from the XY encoder in the bottom of the mouse when the touchpad is toggled into particular non-default states, such as arrows for example, in order to prevent inadvertent cursor motion while using touchpad 1260 for these tasks. The bottom section shows application-specific touchpad operations that could be automatically linked to particular applications. A modification of this table could be used as an on-screen window for preferences setup.

Up to this point all of the features and operations described for touchpad 1260 of embodiment 1258 assume that the touchpad is only an XY touchpad, reporting only touch and touch location. If in addition, its touch output signal is proportional to force/pressure (Z axis reporting) it can provide both the first and the second stages of a two-stage switch. For the default state, this would provide extra depression-triggered functions in the home zones in addition to the lift-click functions (see FIGS. 69 through 74), and for non-zoned states this would enable gestures that include proportional pressure information. When the second stage is actuated, it is preferable that the first stage remain actuated also (so that it is not necessary to correct for false transitions). The first stage (lift-click) is activated by a very light touch (zero to 10 grams), and remains activated at heavier touch pressure. The second stage, with its activation detected via a comparator-type of means, would have a threshold of greater than about 50 grams. The rear momentary touch switch would preferably have an actuation threshold of between about 5 and 15 grams. The touchpad 1260 zone division patterns and their functions can be adjustably programmed by the user, including being set for different hand sizes/finger lengths and right- or left-handed use. This provides an enormous degree of versatility. Optionally, audible click sounds and/or haptic vibrations could be generated when a function is triggered. A prior art type of XY position sensor/encoder on the bottom of the mouse would continue to provide cursor tracking of horizontal motion across the desktop. The touchpad can have either a flat or a curved touch surface. Technologies already exist in the prior art for touchpads that could be used for these purposes, including capacitative, electric field, optical imaging and semiconductive types. FTIR means could also be used. The touchpad can be sectioned into separate sensing areas or zones (into adjacent touch sensors) for each finger either via software, firmware, or in a more fixed manner via hardware (electromechanical construction/wiring circuitry). Optional textured areas on the touchpad surface and/or ridges at its perimeter could be used to help orient the fingers to their home locations. Any of the features described for the multipurpose touchpad embodiment 1258, could, where applicable and appropriate, also be used with the other lift-click embodiments described in this specification.

Optionally, for an XY touchpad, a controllable visual display could be layered into the touchpad itself, e.g. a miniature touchscreen could be used. This touchscreen would be different from prior art touchscreens in that it is mounted on an XY translating mouse and has home resting positions for the fingers, and therefore requires the lift-click method of the present invention to prevent unwanted triggers when the hand arrives and leaves (when the fingers arrive and leave their home locations along with the hand). This option is less ergonomic than an on-screen window, since one must look down in order to benefit from it.

FIG. 69 through 74 are diagrams of touch zones that can apply to all two-stage embodiments of this invention, including the horizontal mouse 1258 of FIGS. 65A and 65B if it carries an XYZ touchpad. Without the depression stage, they could also be used for all single-stage embodiments. FIG. 69 is a chart that explains the switch zones, mode and function designations and in particular serves as a Key to FIGS. 70 through 74. Outline 1298 represents the touchpad zones for a single finger, either the left or right side lift-click switch (or for a single lift-click switch when only one switch is used). Outline 1298 can also represent each of up to five lift-click switches, one for each finger, which can be either individual touch sensors, or zones or virtual zones of an XY(Z) touchpad or of an imaged touch surface. A home zone for a particular finger can either be a fixed definite home resting location, or it can be a floating home resting location/zone on a larger touch surface where the location of the floating zone for the particular finger is continuously redefined, via processing, by the location of that finger with respect to the location of the other fingers (on either a pointing device carrying a separate XY encoder for cursor control, or on an auxiliary clickpad or keypad that does not control cursor position).

FIG. 69 shows that by using a dual function lift-click mode, a momentary lifted mode and a prior art depression-type of switch, up to four different functions, plus mini-gestures, can be triggered from the same home location, by a single finger. Which modes are used depends on whether simplicity or versatility is more valued, the type of dragging that is desired, the type of pointing device employed, and user preference for intuitive feel while in operation.

Although the concurrent use of mini-gestures in the same home area together with lift-click sensing and depression switching is illustrated only in FIGS. 69, 74 and 75, it could also be used with the configurations of FIGS. 66A, 66B, 66C, 70, 71, 72 and 73. In FIGS. 70 through 74, the particular lifted mode used is not specified, but it would be either direct momentary, direct momentary plus ref, or delayed momentary (see FIG. 32), depending on the particular pointing device and on the particular momentary function that is to be enabled. When used in parallel with lift-drop mode, optionally the enabling of a mom lifted state can be made dependent on the lift-drop window being closed, i.e., while open, a window could be caused to block the enabling of the mom lifted state. The move-with-mouse-motion controls shown in FIGS. 71 through 74 and described below are greatly facilitated and made highly practical by the CLUTCH function. This disengage cursor feature is enabled whenever both fingers are lifted, and provides for convenient ergonomic return strokes to reposition the mouse without lifting it from the desktop. If the disengage cursor feature were to be assigned to all mom lifted states, i.e., left, right, and chorded, it would automatically prevent any cursor motion due to inadvertent moving of the pointing device between a lift and a drop in lift-drop mode, between a lift and the end of the delay in lift-delay-ref mode, and during hand departure from or arrival at the pointing device.

FIG. 70 is a diagram of one example of possible mode and function assignments for an embodiment with left and right two-stage lift-click switches (for index finger and middle finger respectively). Square outline 1300 encloses left and right two-stage touch sensors, which can either be adjacent as shown via one smooth touch surface divided into zones by software or hardware means, or can be two (or four) separate touch sensors, with left and right sides optionally separated by a scroll device. For the left (index for right-handed people) finger this configuration provides LEFT CLICK via a short (<0.5 sec) lift and drop, DRAG by holding lifted for more than 0.5 sec, the keyboard HOME function via a depression press (>50 grams), PAGE DOWN by a light touch to the rear and optionally mini-gesturing within the home zone.

For the right (middle) finger, whenever the finger is resting at home it provides the reference signal (REF FOR C) for the hybrid AC mode processing of the left first-stage sensor, and when it alone is lifted it shifts the cursor into a SLOW (or any other pre-chosen) alternate tracking mode. Lifting the left finger has not been assigned a mom lifted mode function because the left finger held lifted, after a delay, is assigned to trigger a latched hybrid function C: a DRAG. While both fingers are lifted simultaneously, a cursor CLUTCH becomes disengaged. As in the discussion of FIG. 34, the mom lifted chord can be used without triggering hybrid function C because while the right finger is lifted, hybrid AC mode no longer has a reference.

A short lift and drop triggers DOUBLE-CLICK, a drop between 0.5 and 1.5 sec after the lift triggers RIGHT CLICK, a depression push triggers keyboard function END, and a touch to the rear triggers keyboard function ENTER. When both fingers execute a short lift-drop together, the PAGE UP command is triggered, and when both fingers touch to the rear together, the PRINT command is triggered.

FIG. 71 is a diagram of another example of possible mode and function assignments for an embodiment with left and right two-stage lift-click switches, where the left depression switch functions to toggle (P/M) the momentary lifted panning function (PAN with mouse motion) of the right finger alternately between P (Position control) and M (motion control). DRAG is shown here as a momentary mode function, which could use any of the three momentary modes: direct, direct plus ref, or delayed (see FIG. 32). The right depression switch provides an ENTER, and the rear touch switches trigger zoom in and zoom out (with optional auto-repeat) and when chorded, zoom to 100%.

FIG. 72 is a diagram of another example of possible mode and function assignments for an embodiment with left and right two-stage lift-lick switches, providing functions very valuable in 3D CAD animation work. In addition to LEFT CLICK, RIGHT CLICK AND DOUBLE-CLICK lift-clicks, the assignments of FIG. 72 provide control of six degrees of freedom divided into three move-with-mouse-motion controls, and includes two rear momentary switches that toggle all three of these degree of freedom controls simultaneously between being Position controls and Motion controls, and between moving FOV (Field Of View) and moving SO (Selected Object). PITCH would be proportional to Y motion of the mouse, and ROLL to X motion. ROTATE would be proportional to linear X motion of the mouse, and TRANSLate along Z axis, proportional to Y motion of the mouse. In FOV mode, TRANSL Z becomes ZOOM. DRAG (and optionally also left-clicking) is accomplished by depressing the second stage of the two-stage switch on the left side, analogous to clicking and dragging with a prior art depression switch. The right depression stage is shown providing panning with mouse motion.

FIG. 73 is a diagram of another example of possible mode and function assignments for an embodiment with left and right two-stage lift-click switches, providing extremely versatile and powerful scrolling controls. The left and right lifted modes provide Position control panning for high accuracy over relatively short distances, and Motion control panning for high speed over long distances (both with mouse motion). The way motion control panning could work is that, once the function is actuated and the mouse is moved, panning would occur at a rate (and in the direction) proportional to the distance the mouse is displaced from where it was when the function was actuated, analogous to rate control with a joystick.

FIG. 74 is a diagram of an additional example of possible mode and function assignments for an embodiment with left and right two-stage lift-click switches, where the only home zone lift mode used is a momentary lifted mode for PAN (Position control), and ZOOM (Position control). CLICK/DRAG and RIGHT CLICK are triggered in the conventional manner by pushing depression switches (by a force of >50 grams exerted on a touch sensor). Two possible retraceable/closed-loop mini-gestures are shown. Three keyboard functions can be triggered by rear touches.

Although the variations and possible combinations of the features of the present invention are large and may appear complex, once reduced to practice by testing and by selecting and integrating the most useful configurations for each application/pointing device, the lift-click method will provide a transparent, easy to use and highly ergonomic means of triggering functions. A simple and relatively fixed version can be designed for the average user, and for the power user a more flexible and powerful version with additional features and the ability to trigger more functions can be offered.

The Lift-Click Method as Embodied into Additional Types of Pointing Devices. FIGS. 75-82

### Trackballs

For persons who use a trackball with their thumb normally resting on a click button, using it as a home switch, the lift-click method would enhance trackball operation greatly. FIG. 75 is a top view of a trackball embodiment 1500 with finger operated trackball 1501 and lift-click switches 1502L and 1502R for use by the thumb. The thumb switches can be either single-stage (lift-click touch sensor only) or two-stage (with a prior art type depression switch as the second stage). At any one time, only one of the left and right thumb switches would have a first stage that is active, the active one being determined by whether the right or left hand is operating the device. A right- or left-hand setting switch could be a hardware switch on the back of the device, or a preferences choice in software. In FIG. 75 the left home thumb button 1502L is the button with active first stage, for right-handed use. Optional hand presence reference sensor 1504 is shown in the center of optional wrist/heel-of-hand rest area 1506.

FIG. 76 shows a similar track ball embodiment (1510), but with the first, lift-click stage being an interruptible light-beam 1511L passing over the top of left thumb switch 1512L in a location such that while the right thumb is resting on the home surface of this switch, it is interrupting the beam. The thinner dashed line 1511R indicates that during right hand use, the beam on the other side would be disabled. The light-beam could be generated in any number of ways, including an LED in the slightly raised central island 1514 and a photosensor inside raised side-rail 1516L or visa versa, or a LED/photosensor pair on one side and a mirror or retroreflector on the other (similar to the options that are described in the discussion of FIG. 63A). Optional hand presence reference sensor interruptible light-beam 1518 is shown within the area of optional wrist/heel-of-hand rest region 1520.

### Operation of the Trackball Embodiments of FIGS. 75 and 76:

While the thumb is resting on, but not depressing a home click button, it actuates the lift-click first stage, which keeps the trackball in its default mode. If the switch is two-stage, depressing the thumb to click would provide normal prior art type operation, with the trackball still remaining in its default mode (the first-stage would remain actuated). When the thumb is lifted out of contact with the home touch surface, a direct momentary mode function is enabled for as long as the thumb remains lifted. This enabled function can be either:

1. an alternate cursor tracking mode, e.g., slow; or if default is a high ratio acceleration, the lifted thumb alternate could be an absolute mode, or visa versa; or
2. pan with trackball; or
3. pitch & roll with trackball; or
4. zoom & rotate field of view with trackball;

One of the switches near the upper part of the trackball could be used to toggle pitch & roll and zoom & rotate from field-of-view operations to move-selected-object actions. For the above four options, the momentary mode is direct, and no reference would be needed.

Another way to use lift-clicking on a trackball would be for DRAG to be the enabled momentary function while the thumb is lifted. This would preferably use a hand presence reference and a delayed momentary mode. The reference together with the delays of this mode would prevent inadvertent selection of an object during hand departure. In the prior art, dragging with a trackball requires the thumb to be depressing the click button while the other fingers are moving the ball (unless a click-click method is being used). Dragging with the thumb lifted provides a freer and more ergonomic motion.

Yet another way to use lift-clicking on a trackball would be to use a lift-drop, lift-delay, or hybrid mode to trigger functions via the first stage sensor. CLICK could be a lift-drop or hybrid function A, and Drag could be a latched hybrid function C (dragging with thumb lifted), or a latched lift-drop B (click-click Drag mode, dragging with finger resting). Lift-drop modes could be used together with any of the above direct momentary functions. In addition, if the embodiment of FIG. 75 were to use an XY touchpad as the lift-click or first stage sensor, mini-gestures could be used concurrently, such as a clockwise 1522 or counterclockwise rotating motion, which is a natural motion for the thumb, to act as a scroll control, a virtual volume control, etc. Thus instead of just the prior art method of depression clicking, the method of the present invention provides one or two lift-click functions, a momentary lifted function and potentially, mini-gestures. The latter two features are especially easy to implement on trackballs, since there is no chance of inadvertent motion of the XY encoder when the hand arrives and departs, or while gestures are traced.

For 3D CAD work, two such trackballs could be used, one for each hand on each side of the keyboard, to provide click functions plus two degrees of freedom for the right hand, and the remaining four degrees of freedom for the left hand.

Thumb-operated trackballs where the index finger or index and middle finger rest on home switches could also make use of the lift-click method. Examples of such trackballs that would benefit from the method of the present invention are the thumb-operated trackballs disclosed in U.S. Pat. Nos. 5,122,654 and 6,292,175 B1 assigned to Logitech, Inc. Implementation of the lift-click method on these trackballs could be similar to any of the horizontal mice embodiments shown in the present specification.

### Vertical Mice

FIGS. 77A, 77B and 77C are sequential images in time illustrating a front view of a vertical mouse type of embodiment (1528) having an XY encoder in its underside (not shown) and using the lift methods of the present invention. Multiple lift switches and/or reference finger reference sensors (1530, 1532, 1534, 1536) are shown. The thumb (1540) could both serve as a reference for hybrid mode of the index finger (1542), and could itself be in a lift-drop or hybrid mode. The middle finger (1544) could be in dual window lift-drop mode. The ring finger 1546 and its sensor 1536 could serve as an alternate reference of hand presence. These switches can be either single-stage or two-stage, and can utilize any type of touch sensor, including horizontal interruptible light-beams. FIG. 77A shows all the fingers at rest on their home light touch sensor surfaces, FIG. 77B shows the index finger lifted away from its home surface 1532, and FIG. 77C shows the index finger returned to rest on its home touch sensor surface. A click would be generated either a very short delay after the lift, or upon the return, depending on the lift-click mode and the timing. Lifted modes could also be used. Although the switches could be either single or two-stage, single-stage switches have the advantage of being immune to fingertip grasp and manipulation pressure, thus removing any possibility of causing inadvertent depression clicks.

The method of the present invention is similarly applicable to non-desktop/hand-held pointing devices such as gyroscopic types.

### Joysticks

On joysticks that are held and manipulated by the tips of the fingers, the lift-click method of the present invention allows the convenience and speed of using a home-type of click switch without any risk of the inadvertent click triggers due to finger grip or manipulation that could occur if a home click switch were of the prior art depression type. FIGS. 78A, 78B and 78C are sequential images in time showing a front view of a joystick type of embodiment (1568) of the lift-click method of the present invention, and demonstrate its use. The index finger 1542 and thumb 1540 rest on lift-click home sensor (1570) and optional reference sensor (1572) respectively. The middle finger 1544 is shown resting on joystick shaft 1574 so that the shaft remains stable when the index finger is removed. Optionally (not shown here) there could be an additional touch switch for the middle finger, below the index finger switch. FIG. 78B shows the index finger lifted away from its home sensor 1570, and FIG. 78C shows the return. A click would be generated either a very short delay after the lift, or upon the return, depending on the lift-click mode and the timing. Lifted modes could also be used. A joystick that is of the type gripped by the whole hand rather than just the fingertips could also implement the lift-click method, and its appearance and operation could be similar to the vertical mouse shown in FIGS. 77A through 77C except with the addition of a swivel joint between the base and the vertical portion.

### Fingertip Handle

FIGS. 79A and 79C are top views of a handle embodiment (1578) for fingertip use that can be used to implement the lift-click method of the present invention on a joystick or other computer input device. The paddle-shaped handle has home touch surfaces 1582 for the index finger and 1584 for the thumb, and includes either one (1586, for the index finger) or two (1586, 1588, for index finger and thumb) interruptible light-beams as home touch switches. The end of an XY encoder actuator shaft (1590) that attaches the handle to the body (not shown) of the input device is shown as the dashed circle in the center of the handle of FIG. 79A and below the handle in FIG. 79B. The shaft can be hollow and carry wires from the handle to the input device. FIG. 79B is a front view (the view from the thumb side) of this handle, illustrating light-beam 1588 for interruption by the thumb, and end compartments 1580L and 1580R which contain light source(s) on one side and photodetector(s) on the other. FIGS. 79C and 79D are a top view and front view showing fingers at the handle. Thumb 1592 is interrupting its light-beam 1588, and index finger 1594 is lifted and allowing light-beam 1586 to reach its photodetector. In dual window lift-drop mode, only the single light-beam 1586 under the index finger would be needed. By adding the second beam 1588 on the opposite side under the thumb as a reference, the index finger switch could be used in a hybrid mode.

FIG. 80A is a top view of a similar fingertip handle embodiment (1598), except that, as shown in rear view (the view from the index finger side) FIG. 80B, its touch surface 1602 is wide enough for both the index and the middle fingers, with an interruptible light-beam for each finger (1606 for the index finger and 1608 for the middle finger) and optionally also for the thumb (1592) on the opposite side as a reference (thumb light-beam not shown here). End compartments 1600R and 1600L house LEDs and photodetectors. Sequential FIGS. 80C, 80D and 80E show a lift and drop of the index finger 1594, where both beams are blocked by the fingertips touching surface 1602 except in FIG. 80D where the lifted index finger allows beam 1606 to reach its photodetector, thereby initiating a lift-click sequence for that finger. FIGS. 80F, 80G and 80H show a lift and drop by the middle finger 1596, with the lift in FIG. 80G allowing beam 1608 to reach its photodetector. Either the thumb can act as hand presence reference, or the index and middle fingers can act as references for each other.

### Stylus

FIG. 81A through 81D and 82A through 82D illustrate stylus/pen embodiments of the lift methods of the present invention and their operation. These embodiments can be either a stylus used with a tablet, or a stand-alone digital pen. Stylus/pen 1620 of FIG. 81A has a topside lift-click home touch switch 1622 and optional (dashed line) bottomside reference home touch switch 1624. Sequential images in time FIG. 81B, 81C or 81C′ and 81D demonstrate the use of stylus 1620. The topside light touch lift-click switch 1622 is a home switch in lift-drop or lift delay or hybrid mode for use by index finger 1594, while the thumb (1592) (or middle finger) serves to maintain the optional bottomside light touch switch 1624 in an actuated state as reference for lift-delay mode. The bottomside switch is optional, since it is not needed if the topside switch is in lift-drop mode. (The bottomside switch is not visible in FIGS. 81B through 81D because it is covered up by the thumb.) Beginning at FIG. 81B where home switch 1622 is actuated by the tip of index finger 1594, one can either lift the index finger from the stylus as shown in FIG. 81C, or instead slide the index finger backwards off of the active switch surface to rest on an inactive area as shown in FIG. 81C′ (in analogy to the sliding sequence shown in FIGS. 40B through 40D), to initiate a lift-click sequence. FIG. 81D shows the return to home, either by dropping from FIG. 81C, or by sliding back down (or lifting off and dropping down) from FIG. 81C′.

FIG. 82A illustrates stylus/pen 1630 that has two touch switches on its topside, the lower one being the lift-type home switch 1622, and the upper one being a momentary light touch switch 1632. Optional bottomside switch 1624 (for thumb or middle finger) can supply a hand presence reference. In FIGS. 82B and 82D the home switch 1622 is actuated and the rear momentary switch 1632 is not being touched. FIG. 82C shows the index finger 1594 lifted from 1622, thereby actuating the lift-click sequence for that sensor. FIG. 82C′ shows the index finger sliding up from home switch 1622 to actuate rear momentary switch 1632 (this actuation of the rear switch can be used to cancel the effect of the removal of the finger from the home switch). FIG. 82D shows the index finger returned home, reactuating switch 1622.

In the embodiments of FIGS. 81A and 82A, triggering a function requires only lift or slide, and return. The lift-click method of the present invention provides the most ergonomic way of clicking a pen/stylus type of pointing device, and can provide both click and drag functions from one single-stage lift-drop switch, for example: a short lift and drop within window A can be used to trigger a click, and a medium lift with drop within window B could be used to trigger a latched click, i.e., a drag, with the next lift releasing the drag and having no other effect. Picking up the pen and putting it down will not cause any triggers because of the requirement for a window. As illustrated and described so far, all the switches on the stylus embodiments are single stage, and do not require more weight than the force that the resting finger would exert in the normal relaxed holding of the stylus/pen. A two-stage switch could be used for either of the topside switches 1622 or 1632, in which case many additional functions would be provided (see FIG. 62). An advantage of using only a single stage sensor for the home switch is that then the user does not have to be careful to avoid inadvertent triggering due to too much holding pressure. With a depression-type home button, gripping a bit too tightly could cause an unwanted click. The stylus need not have a circular cross-section, but can include shape features that provide ergonomic contours as tactile clues for automatic/intuitive longitudinal and rotational orientation of the stylus between the fingers.

### Lift Switches on Clickpad and Keyboard Home Keys

FIGS. 83 through 96 illustrate the lift-click method embodied into auxiliary keypads and keyboards. Lift-drop light touch stages could be added to keypad or keyboard home key switches and used as mouse click buttons. They could be incorporated into the body of the switch, or incorporated into a keycap carrying a touch sensitive surface.

Using the non-mouse hand to click by actuating keyboard home keys can be more ergonomic than prior art clicking on the pointing device, especially if a lift-click first stage of a two-stage keyswitch is used. Two-stage keyswitches providing a light touch lift type click via their first stage can be incorporated into keyboards at the first two home key positions, for example in place of where the letter F, D, J and K keys are in QWERTY. These “piggybacked” light touch functions are preferably enabled only when one hand is at the mouse (as sensed via either a hand absence sensor on the mouse side of the keyboard, or a hand presence sensor at the mouse). During the time that the light touch first stage functions are enabled by the position of the mouse hand, the full keypress second stage functions could either: 1) remain active and native; (2) could be active and offer clicks or other non-native functions; or (3) could become inactive. This is in reference to the patent application of Richard H. Conrad: “Method and Apparatus for Automatically Transforming Functions of Computer Keyboard Keys and Pointing Devices by Detection of Hand Location”, Ser. No. 11/303,782 filed on Dec. 16, 2005, and hereby incorporated by reference.

While the mouse hand is at the pointing device, a first stage finger lift or lift-drop would be processed into a click or function via any of the modes of the present invention assigned to that stage. The two-stage keys could have the same feel as the other keys during ordinary typing. Alternatively, a small difference in feel would be acceptable and even beneficial to help the fingers find the home keys (as is commonly done in prior art by adding a raised dot or line to the top of the keycaps of the first or second home keys, F or D, etc.)

### Auxiliary Clickpads

FIGS. 83A and 83B are top views of an auxiliary clickpad 1650, a keyboard 1282, a mouse 1652 and/or a trackpad or trackball 1653 showing an example of the use of lift-type light touch home switches on an auxiliary clickpad. The clickpad is able to provide from one to five home switch mouse buttons/keys/sensors 1654 for operation by the non-mouse hand while the mouse hand is at the pointing device. These can be either single stage or two-stage switches, and of any mechanism. They could be discrete keyswitches, discrete touchpads, or a zoned multi-point XY or XYZ (Z=pressure proportional) touchpad. Any switch can serve as hand presence reference for the other switches, although the preferred mode in this application would be lift-drop, which does not need a separate reference. The keyboard 1282 and trackpad or trackball 1653 can either be individual devices, or, as indicated by dashed line 1655, can be built into a laptop computer or can be incorporated together as an external keyboard. FIG. 83B shows the left hand 1280L at the clickpad, and the right hand 1280R at the mouse or the right hand 1280R′ at the trackpad or trackball. The clickpad can be used to provide ergonomic lift-clicking in any of the modes of the present invention for mouse clicks and other functions, either instead of or in addition to clicking at the pointing device.

### Auxiliary/Numeric Keypads

FIGS. 84A and 84B are top views of an auxiliary/numeric keypad 1660 and a keyboard 1282, being used together with either a pointing device 1662 having a hand presence sensor 1664, and/or with a trackpad 1653 (which inherently acts as a hand presence sensor while being touched). This is an example of the use of two-stage (with lift-type light touch first stage) home row switches (1666) on a keypad external to the pointing device and keyboard. The purpose of hand presence sensor 1664 is to automatically enable and disable the first stages of the keyboard home keys. The keyboard and trackpad can either be individual devices, or, as indicated by dashed line 1655, can be built into a laptop computer or can be incorporated together as an external keyboard with trackpad (or as an external keyboard with 1653 representing a trackball, in which case the trackball would include a hand presence sensor analogous to 1664). These laptop/external keyboard/trackball options also apply to FIGS. 84B through 88B. The first stages provide four home lift-click switch mouse buttons for operation by the non-mouse hand while the mouse hand is at the mouse. (Some possible mechanisms for the two-stage keyswitches are shown in FIGS. 92A through 96.) FIG. 85 is a truth table showing the effect of hand location, via the output of hand presence sensor 1664 or trackpad touch as shown in FIGS. 84A and 84B, on the enabling and disabling of the keypad's home key first stages (of the two-stage switches). This table shows that when a hand is not sensed at a pointing device, the lift-click first stage is automatically disabled, allowing the numeric keypad to be used normally, and when a hand is sensed at a pointing device, the first stage of the keypad home keys becomes enabled, providing lift-click functions. Thus in FIG. 84B, when the right hand is at either pointing device, the hand is sensed to be present at the pointing device by either hand presence sensor 1664 or by the touchpad output, and the left hand is able to actuate click functions via the first stage of two-stage home keys on the keypad. If the pointing device utilizes lift-click type home touch sensors, the actuation of any one of these lift-click sensors can be used as the hand presence sensor that enables/disables the keyswitch first stages.

### Keyboards

FIGS. 86A and 86B are top views illustrating the operation of a keyboard 1670 with two-stage light touch lift switches 1672 in the D, F, J and K home key positions, used with either a pointing device 1662 having a hand presence sensor 1664, and/or with a trackpad 1653 (which inherently acts as a hand presence sensor while being touched). The keyboard and trackpad can either be individual devices, or, as indicated by dashed line 1671, can be built into a laptop computer or can be incorporated together as an external keyboard with trackpad (or as an external keyboard with 1653 representing a trackball, in which case the trackball would include a hand presence sensor analogous to 1664). FIG. 87 is a truth table showing the effect of the hand locations shown in FIGS. 86A and 86B on the enabling and disabling of the first stage of the keyboard home key two-stage lift switches: while the hand is sensed at the pointing device, the first stage of lift switches 1672 are enabled.

In FIGS. 84A through 87, the hand presence sensing means on the pointing device that is used to enable/disable can be any first stage lift-click switch on the pointing device or a hand presence sensor used as a reference for a lift-click mode on the pointing device. In other words, on pointing device 1652 any sensor can serve to sense hand presence to enable/disable the keyswitch first stages. This sensing of the mouse hand at the pointing device for the purpose of enabling or disabling all of the first stages of the two-stage home keys simultaneously is distinct from and in addition to any hand presence reference sensing of the presence of the non-pointing device hand at the keyboard that may be required for a lift-click mode assigned to the first stage of a two-stage key. (The latter is not be needed if the mode is lift-drop A or AB.)

FIGS. 88A and 88B are top views illustrating the operation of a keyboard 1680 with two-stage light touch lift switches 1672 in the D, F, J and K home key positions, and with the keyboard having left and right hand-location sensors (1684L and 1684R) of any type (instead of the hand presence sensor 1664 at a pointing device of FIGS. 86A and 86B). The keyboard and trackpad (or trackball) 1653 can either be individual devices, or, as indicated by dashed line 1681, can be built into a laptop computer or can be incorporated together as an external keyboard with trackpad or trackball. FIG. 89 is a truth table showing the effect of hand location, as detected by the keyboard hand location sensors in FIGS. 88A and 88B, on the enabling and disabling of the first stages of the two-stage keyboard home lift switches. An advantage of employing the hand presence sensor 1664 at the pointing device instead of hand-location sensors 1684L and 1684R at the keyboard, is that during use, one only has to back the hand away slightly from the pointing device to disable the first stages and return the keyboard to its native state (for use by the non-mouse hand remaining at the keyboard).

FIG. 90 is an example of an electronic schematic showing one possible implementation of the truth table of FIG. 89, using outputs 1700L and 1700R of left and right keyboard ambient-light photodetector hand location sensors to enable the first stages of two-stage keyboard switches only when one hand is absent from the keyboard, and including a manual or automatic means 1704 of balancing the sensors. Ratioing operation 1706 provides automatic correction for changes in ambient light intensity, and comparators and OR gate 1708 provide logic to produce an output 1710 that is high (enabling the first stages) only when one input is dark and the other is light, as illustrated further by the table of FIG. 91. The ratios in FIG. 91 are the outputs of 1706.

DISCUSSION OF TWO-STAGE SWITCHES ON KEYBOARDS: Piggybacking light touch switches onto keyboard home keys, particularly the F, D, J, and K keys, provides the ability to lift-click or to actuate extra functions from the keyboard. A relaxed finger resting on a two-stage home key would be actuating its first stage. Lifting and dropping the finger within a lift-drop window could be used to trigger a click function, without actually pressing to trigger the second stage function. Operation is transparent, the touch can be very light, and not fatiguing when used repetitively. While the mouse hand is at the mouse, actuating the clicks via the non-mouse hand at the keyboard not only provides variety, it also removes the strain of double tasking from the mouse hand, and for precise work, ensures that the mouse is not moved by the act of clicking. The lift-drop method would be the best one to use for keyboard light touch home keys because if the finger were to depart its home key to touch a non-home key, when the non-home key is actuated the window could be caused to close instantly, thus preventing inadvertent triggering of the home key light touch function. Thus the finger could leave the home key, actuate a different key, and return either very quickly or after a long time without causing triggering of the light touch function.

For the purpose of the claims associated with this specification, an auxiliary or numeric keypad is a keyboard.

FIGS. 92A, 92B and 92C are front view sequential images in time that show the operation of one embodiment of a two-stage keyboard keyswitch 1720 having two mechanical stages. Included are keycap 1722, actuating shaft 1724, and body 1726 with three outputs 1728: a first stage output, a common output, and a second stage output. This dual position switch has a light-touch first stage switch mechanism incorporated into the keyswitch. The first stage is actuated by a slight depression (via an invisible finger, with an actuation threshold of about 5 to 10 grams) as shown by FIG. 92B, and the second stage is actuated in a manner similar to a standard depression keyswitch (by further depression, with a force of over 30 grams) as shown in FIG. 92C. This is preferably an OFF(ON1)(ON1 & 2) type of switch, where when the first stage is actuated, switch outputs 1st and com (common) are connected internally (1730), and when the second stage is actuated, 1st, corn and 2nd are all connected internally (1730, 1732). Thus whenever the second stage is actuated, the first stage remains actuated.

In all two-stage switch embodiments of the present invention, with the first stage being processed via any of the modes of this invention (lift-drop, lift-delay, hybrid, momentary lifted), lift, drop and full depression can be done in quick succession and in any sequence without interfering with each other and without interaction between the triggering of their assigned functions, because a lift does not occur on the way to full depression. They occur in opposite directions: the first stage triggering of a lift-click sequence begins with a lift, and the second stage is actuated by a push/depression. Thus the function of each stage is triggered independently.

FIGS. 93 and 94 are front views showing the incorporation of a touch sensor into a keycap as an alternate means of providing the first stage of a two-stage keyswitch. FIG. 93 shows keycap 1740 with a resistive membrane 1742 layered on top as a first-stage touch switch. FIG. 94 shows keycap 1750 (transparent view) with a proximity sensor or electrode 1752 underneath its top surface as a first-stage touch switch. From the keycaps of FIGS. 93 and 94 electrical conductors could run along the shaft and contact wiper commutators within the keyswitch body. Another possible means (not illustrated in this specification) of adding a light touch first stage to a keyboard switch could be a tiny magnet attached to the key cap and a magnetic sensor placed on or within the body of the keyswitch. This dual action switch could have the property of a slight depression to a tactile resistance in response to a force of less than 10 grams, actuating the first stage magnetic sensor, beyond which a force in excess of 30 grams would be required to depress the keycap further to actuate the second stage. (It is not intended here to claim a particular design of two-stage keyboard switch, but to disclose, describe and claim the concept, and to provide a number of examples of possible implementation.)

FIG. 95 is a table showing allowable combinations of first and second stage actuations, not only for the switch shown in FIGS. 92A, 92B and 92C, but also for all two-stage embodiments of this invention. If a type of two-stage switch is used where the first-stage deactivates before or after the second stage becomes actuated, electronic means, such as the circuit of FIG. 96, can be provided so that such deactivation does not register as a lift.

FIG. 96 is an example of schematic that effectively accomplishes the electronic conversion of an OFF(ON1)(ON2) two-stage momentary switch (the type that would generate the preferably disallowed state shown in the table of FIG. 95) into a OFF(ON1)(ON1 & 2) type, analogous to the switch shown in FIGS. 92A, 92B and 92C. In FIG. 96 the output of a non-actuated (open normally open switch) is logic high. Closing a switch pulls the output to ground. Diode 1764 insures that whenever second stage switch 1762 is closed, the first stage output is pulled low (along with the second stage output), thereby mimicking continuous first stage switch 1760 actuation. In two-stage switch of the type that when a finger actuating the first stage depresses and actuates the second stage, the first stage switch opens before the second stage closes (break before make), then capacitor to ground 1768 can supply an off-delay to simulate make before break, thereby providing continuity of actuation of the first stage when the second stage is actuated.

An alternative means of compensating for a first-stage deactuation when the second stage is actuated would be to have the second stage actuation automatically cancel a potential lift-triggered click; by canceling the delay of lift-delay mode, or by closing the window initiated by a lift-drop mode deactuation.

Accordingly, the invention may be characterized as a method for triggering at least one computer function on an input device for a computer, the input device having a touch surface including a home resting location for at least one finger of a hand (a/each finger having its own home resting location), the method comprising: providing a finger sensor for detecting the presence or absence of at least one finger at the home resting location, the finger sensor being actuable by the finger exerting a force less than the resting weight of the finger, the finger sensor having a signal output; resting the finger on the touch surface at the home resting location; removing the finger in a direction away from the home resting location and returning the finger to the home resting location; and providing electronic processing to trigger a computer function when the signal output from the finger sensor is due to a change in finger position relative to the finger sensor made with the intent to trigger a computer function (i.e., a change that is not a result of the hand departing from or arriving at the input device) and to not trigger a computer function when the signal output from the finger sensor is due to a change in finger position relative to the finger sensor that is a result of the hand departing from or arriving at the input device, whereby the signal output from the finger sensor serves as an input to the electronic processing, and the electronic processing includes a distinguishing means for distinguishing between a signal output from the finger sensor that is due to a change in finger position made with the intent to trigger a function (i.e., a change that is not a result of the hand departing from or arriving at the input device), and a signal output from the finger sensor that is due to a change in finger position that is a result of the hand departing from or arriving at the input device.

The inventive means for distinguishing between a signal output from the finger sensor that is due to a change in finger position made with the intent to trigger a function, and a signal output from the finger sensor that is due to a change in finger position that is a result of the hand departing from or arriving at the input device may be in the form of:

triggering a computer function when the finger is returned to the (i.e., its) home resting location only if the finger has been returned to the home resting location within a designated time period after the previous finger removal (i.e., the previous removal of the same finger) from the home resting location,
triggering a first computer function only when the finger is returned to the home resting location within a first portion of a designated time period after the previous finger removal from the home resting location, and triggering a second computer function only when the finger is returned to the home resting location within a second portion of the designated time period after the previous finger removal from the home resting location,
triggering a computer function when the finger is returned to the home resting location only if hand detection determines that the hand is present at the input device at the time of return of the finger to the home resting location and the hand has been detected to be present at the input device for at least a designated time period before the return of the finger to the home resting location,
triggering a computer function when the finger is removed from the home resting location only if at the time of finger removal from the home resting location hand detection determines that the hand is present at the input device,
triggering a computer function at the end of a designated time period after the finger is removed from the home resting location only if at the end of the designated time period hand detection determines that the hand is present at the input device,
triggering a first computer function only when the finger is returned to the home resting location within a designated time period after the previous finger removal from the home resting location, and triggering a second computer function at the end of the designated time period after the finger is removed from the home resting location only if at the end of the designated time period the finger is still removed from the home resting location and hand detection determines that the hand is present at the input device,
triggering a first computer function only when the finger is returned to the home resting location within a first portion of a designated time period after the previous finger removal from the home resting location, and triggering a second computer function only when the finger is returned to the home resting location within a second portion of the designated time period after the previous finger removal from the home resting location, and
triggering a third computer function at the end of the designated time period after the finger is removed from the home resting location only if at the end of the designated time period the finger is still removed from the home resting location and hand detection determines that the hand is present at the input device, or
enabling a computer function during the time that the finger is removed from the home resting location and triggering the enabled function only during the time that a second action is being carried out that requires the presence of the hand (for example, the enabled function can be panning with mouse motion, and the second action can be the hand moving the mouse to manifest/trigger the moving of the document across the computer monitor screen with mouse motion; another example is where the enabled function can be disengage cursor clutch, and the second action can be the hand moving the mouse to manifest/trigger the cursor not moving across the computer monitor screen with mouse motion).

The inventive method may also be characterized as a method for triggering at least one computer function on an input device for a computer, the input device having a touch surface including a home resting location for at least one finger of a hand, the method comprising: providing a finger sensor for detecting the presence or absence of at least one finger at the (i.e., its) home resting location, the finger sensor being actuable by the finger exerting a force less than the resting weight of the finger, the finger sensor having a signal output; resting the at least one finger on the touch surface at the home resting location; removing the at least one finger in a direction away from the home resting location; and providing electronic processing that triggers and holds a disengage cursor clutch momentary function in a disengaged state for as long as a signal output from the finger sensor indicates that the at least one finger is removed from the home resting location.

The inventive apparatus may be characterized as a triggering apparatus for triggering at least one function on an input device for a computer, the input device having a touch surface including a home resting location for at least one finger of a hand, the triggering apparatus comprising: a finger sensor for at least one finger at the (i.e., its) home resting location, the finger sensor being actuable by a force less than the resting weight of the finger; and electronic processing means to trigger a computer function in response to a change in the finger position relative to the finger sensor but to avoid triggering a computer function when the finger departs from or arrives at the input device as a result of the departure or arrival of the hand at the input device, whereby a signal output from the finger sensor serves as an input to said electronic processing means.

### RAMIFICATION AND SCOPE

The main focus and unique features of this patent application and its claims is not the protection of any one particular electronic implementation of this method, but instead to claim the general principle of this lift-click/lift-type of method comprising the concepts and logic of the lift-drop, lift-delay and lifted momentary modes and their combinations and their associated logic, including the prevention of inadvertent clicks in a variety of situations, for the implementation into and ergonomic operation of home-type switch(es) on any type or design of computer input device. The flowcharts, electronic block schematics and timing diagrams shown in the Figures are meant as descriptive examples and are not intended to represent all of the possible ways that the present invention can be implemented.

Apparatus with unique features designed expressly to facilitate this method, such as the light beam over the scroll wheel, and versatile pointing devices made possible by this method such as those having an XY touchpad as a clicking surface, are also claimed herein. Some of the embodiments illustrated in the Figures as or on horizontal mice could be adapted to other angles of operation, for example to 30, 45, or 60 degree angled mice, or to vertical mice (=90 degrees, referring to the approximate angle of the plane of the palm of the mouse-actuating hand with respect to the desktop). Any interruptible light-beam type of lift-click sensor/switch could either have 1) light source and photodetector at opposite ends of the beam, or 2) light source and photodetector generally coaxial at one end and a retroreflector at the other end; or 3) light source and photodetector adjacent or coaxial at one end and a mirror (preferably concave) at the other end. The electronic implementation can be via hardware and/or firmware and/or software in any combination. The method claims for the method of the present invention are not intended to be limited to the particular implementing apparatus claimed herein, but are intended to apply to any computer input device.

The method of the present invention may be used with a home-type of sensor or switch on any type of computer input device, and the apparatus of the present invention includes any devices that implement the lift-clicking methods described and claimed herein, and in any combination. It can use a lift or a slide, and in any orientation, from horizontal touch surfaces where a lift is upwards, to vertical touch surfaces where a “lift” is a movement generally perpendicularly away from the touch surface. Computer input devices that could utilize this invention are all those that have home-type switches, including horizontal and vertical mice, trackballs, joysticks, pens, keyboards, auxiliary keypads, and auxiliary click switches or switch pads. Most of the embodiments of the present invention shown the Figures could serve, by removing (or by not using) the XY encoder, as auxiliary mouse button clickpad devices. Any type of light touch switch mechanism may be used, including mechanical, touch, proximity, resistive, capacitative, pressure, light-beam interruption, optical imaging, electric field, etc. Two-stage switches can be any combination of mechanisms with light and relatively heavy actuation thresholds. An XY touchpad could be substituted for any single-stage finger sensor of another mechanism, and an XYZ (force reporting) touchpad could be substituted for any two-stage finger sensor. In the method of the present invention, touchpads are not used as trackpads for main control of cursor position. If an input device of the present invention provides cursor tracking, it is by using a prior art type of XY encoder that is distinctly separate from the lift-click finger sensor mechanism.

The finger sensor would usually detect presence or absence of the finger at the touch surface directly, but it could alternatively be a type of sensor where it detects the presence of the finger only when it is lifted away from the touch surface, and thereby reversing the use of the terms presence and absence. The use of the terms actuated and non-actuated, logic high and logic low, rising edge and falling edge, can also be reversed. Features shown in different embodiments can be combined or interchanged in any manner within the spirit and intent of this invention.

What is claimed is:

1. A method for triggering at least one computer function on an input device for a computer, the input device having a touch surface including a home resting location for at least one finger of a hand, said method comprising:
a) providing a finger sensor for detecting the presence or absence of at least one finger at the home resting location, the finger sensor being actuable by the finger exerting a force less than the resting weight of the finger, the finger sensor having a signal output;
b) resting the finger on the touch surface at the home resting location;
c) removing the finger in a direction away from the home resting location and returning the finger to the home resting location; and
d) providing electronic processing to trigger a computer function when the signal output from the finger sensor is due to a change in finger position relative to the finger sensor that is not a result of the hand departing from or arriving at the input device, and to not trigger a computer function when the signal output from the finger sensor is due to a change in finger position relative to the finger sensor that is a result of the hand departing from or arriving at the input device, whereby the signal output from the finger sensor serves as an input to said electronic processing, and said electronic processing includes a distinguishing means for distinguishing between a signal output from the finger sensor that is due to a change in finger position that is not a result of the hand departing from or arriving at the input device, and a signal output from the finger sensor that is due to a change in finger position that is a result of the hand departing from or arriving at the input device.

2. The method for triggering at least one computer function on an input device for a computer of claim 1 wherein said distinguishing means is selected from the group consisting of
triggering a computer function when the finger is returned to the home resting location only if the finger has been returned to the home resting location within a designated time period after the previous finger removal from the home resting location,
triggering a first computer function only when the finger is returned to the home resting location within a first portion of a designated time period after the previous finger removal from the home resting location, and triggering a second computer function only when the finger is returned to the home resting location within a second portion of the designated time period after the previous finger removal from the home resting location,
triggering a computer function when the finger is returned to the home resting location only if hand detection determines that the hand is present at the input device at the time of return of the finger to the home resting location and the hand has been detected to be present at the input device for at least a designated time period before the return of the finger to the home resting location,
triggering a computer function when the finger is removed from the home resting location only if at the time of finger removal from the home resting location hand detection determines that the hand is present at the input device,
triggering a computer function at the end of a designated time period after the finger is removed from the home resting location only if at the end of the designated time period hand detection determines that the hand is present at the input device,
triggering a first computer function only when the finger is returned to the home resting location within a designated time period after the previous finger removal from the home resting location, and triggering a second computer function at the end of the designated time period after the finger is removed from the home resting location only if at the end of the designated time period the finger is still removed from the home resting location and hand detection determines that the hand is present at the input device,
triggering a first computer function only when the finger is returned to the home resting location within a first portion of a designated time period after the previous finger removal from the home resting location, and triggering a second computer function only when the finger is returned to the home resting location within a second portion of the designated time period after the previous finger removal from the home resting location, and
triggering a third computer function at the end of the designated time period after the finger is removed from the home resting location only if at the end of the designated time period the finger is still removed from the home resting location and hand detection determines that the hand is present at the input device, and
enabling a computer function during the time that the finger is removed from the home resting location and triggering the enabled function only during the time that a second action is being carried out that requires the presence of the hand.

3. The method for triggering at least one computer function on an input device for a computer of claim 1 wherein the trigger of a computer function is selected from the group consisting of a brief pulse trigger, a latched trigger, and a momentary trigger.

4. The method for triggering at least one computer function on an input device for a computer of claim 1 wherein said electronic processing cancels the effect of a finger removal made with the intention of triggering a non-home device, whereby an input to said electronic processing is selected from the group consisting of actuation of the non-home device, touching the non-home device, and closely approaching the non-home device.

5. The method for triggering at least one computer function on an input device for a computer of claim 2 wherein hand detection comprises the detection of the presence of any part of the hand by a sensor on the input device.

6. The method for triggering at least one computer function on an input device for a computer of claim 2 wherein said second action being carried out that requires the presence of the hand is the moving of an XY position encoder carried by the input device.

7. The method for triggering at least one computer function on an input device for a computer of claim 1 wherein the finger sensor is the first stage of a two-stage switch, and the second stage of the two-stage switch is a mechanical depression switch requiring more force than the weight of the resting finger.

8. The method for triggering at least one computer function on an input device for a computer of claim 1 wherein the finger sensor is selected from the group consisting of a non-coordinate reporting touchpad, Y coordinate reporting touchpad, XY coordinate reporting touchpad, XY coordinate and pressure reporting touchpad, very light touch mechanical switch, touch sensor, proximity sensor, charge transfer electrode, electric field electrodes, capacitative electrodes, interruptible light beam, reflected light beam, and optical imaging.

9. A method for triggering at least one computer function on an input device for a computer, the input device having a touch surface including a home resting location for at least one finger of a hand, said method comprising:
a) providing a finger sensor for detecting the presence or absence of at least one finger at the home resting location, the finger sensor being actuable by the finger exerting a force less than the resting weight of the finger, the finger sensor having a signal output;
b) resting the at least one finger on the touch surface at the home resting location;
c) removing the at least one finger in a direction away from the home resting location;
d) providing electronic processing that triggers and holds a disengage cursor clutch momentary function in a disengaged state for as long as a signal output from the finger sensor indicates that the at least one finger is removed from the home resting location.

10. A triggering apparatus for triggering at least one function on an input device for a computer, the input device having a touch surface including a home resting location for at least one finger of a hand, said triggering apparatus comprising:
a) a finger sensor for at least one finger at the home resting location, said finger sensor being actuable by a force less than the resting weight of the finger; and
b) electronic processing means to trigger a computer function in response to a change in the finger position relative to said finger sensor but to avoid triggering a computer function when the finger departs from or arrives at the input device as a result of the departure or arrival of the hand at the input device, whereby a signal output from said finger sensor serves as an input to said electronic processing means.

11. The triggering apparatus of claim 10 wherein said finger sensor is selected from the group consisting of a very light touch mechanical switch, touch sensor, touchpad, proximity sensor, charge transfer electrode, electric field electrodes, capacitative electrodes, interruptible light beam, reflected light beam, and optical imaging.

12. The triggering apparatus of claim 10 wherein the input device for a computer is selected from the group consisting of a horizontal mouse, angled mouse, vertical mouse, finger trackball, thumb trackball, joystick, electronic stylus, electronic pen, auxiliary clickpad, auxiliary keypad, and keyboard.

13. The triggering apparatus of claim 10 wherein said electronic processing means cancels the effect of a finger removal made with the intention of triggering a non-home device by utilizing an input selected from the group consisting of actuation of said non-home device, touching said non-home device, and closely approaching said non-home device.

14. The triggering apparatus of claim 13 wherein said closely approaching said non-home device input means comprises the interruption of a light-beam sensor in close proximity to said non-home device.

15. The triggering apparatus of claim 10 wherein said finger sensor is the first stage of a two-stage switch, and the second stage of the two-stage switch is a mechanical depression switch whose actuation requires more force than the weight of the resting finger.

16. The triggering apparatus of claim 15 wherein said two-stage switch is a home key on a keyboard and said first stage is enabled and disabled by a hand presence sensor.

17. The triggering apparatus of claim 10 wherein said finger sensor comprises a coordinate reporting touchpad selected from the group consisting of a Y coordinate reporting touchpad, an XY coordinate reporting touchpad, and an XY coordinate and force reporting touchpad.

18. The triggering apparatus of claim 17 wherein said XY coordinate and force reporting touchpad comprises a two-stage switch wherein a finger touch exerting less force than the weight of the resting finger acts as a first stage actuation of said two-stage switch, and a finger touch exerting more force than the weight of the resting finger acts as a second stage actuation of said two-stage switch.

19. The triggering apparatus of claim 17 wherein said coordinate reporting touchpad senses closed-path gestures traced by the finger on the home resting location of the touch surface used concurrently by at least one lift-click mode triggerable function.

20. The triggering apparatus of claim 17 wherein said coordinate reporting touchpad has a default state that includes at least one lift-click mode zone, an arrow key zoned state that includes arrow key functions, and a non-zoned gesturing state that senses the tracing of gestures by at least one finger.
